(19) United States
(12) Patent Application Publication
(10) Pub. No.: US 2014/0096200 A1
(43) Pub. Date: Apr. 3, 2014

(54) Shared Level Networking

(71) Applicant: ThymeVine LLC, McLean, VA (US)

(72) Inventors: Ian Brown, Fairfax, VA (US); Robert Newgen, McLean, VA (US)

(21) Appl. No.: 13/907,375

(22) Filed: May 31, 2013

Related U.S. Application Data
(60) Provisional application No. 61/653,663, filed on May 31, 2012.
(60) Provisional application No. 61/669,857, filed on Jul. 10, 2012.
(60) Provisional application No. 61/715,975, filed on Oct. 19, 2012.
(60) Provisional application No. 61/777,161, filed on Mar. 12, 2013.

(51) Int. Cl. G06F 21/62

(52) U.S. Cl. CPC G06F 21/62
USPC 726/4

(57) ABSTRACT

A social network server system including a qualitative Social network share level for a post, photo, etc. submitted by a given social network user device. The social network share level is based on actual content sensitivity, permitting each shared post, photo, or other information viewable by other social network user devices based on its own individual social network share level, or “closeness rating.” The closeness rating is inclusive and based on a social network share level set by the poster when making the post, adding the photo or other information. The social network share level establishes individually which connected social network user device(s) to which the poster has an established relationship may have access to the shared post, photo, information, etc. A privacy level is defined for each post, photo, etc. vis-a-vis each other social network user to which a poster has a defined relationship.

The present application claims priority from U.S. Provisional 61/653,663 filed May 31, 2012, entitled “Shared Level Networking”; from U.S. Provisional 61/669,857 filed Jul. 10, 2012, entitled “Shared Level Networking”; from U.S. Provisional 61/715,975 filed Oct. 19, 2012, entitled “Shared Level Networking”; from U.S. Provisional 61/730,189 filed Nov. 27, 2012, entitled “Scrapbooking”; and from U.S. Provisional 61/777,161 filed Mar. 12, 2013, entitled “Scrapbooking”; the entirety of all of which are expressly incorporated herein by reference.

### BACKGROUND OF THE INVENTION

1. Field of the Invention

This invention relates generally to communications. More particularly, it relates to communication systems in general and messaging systems in particular, with respect to the managed sharing of data between member devices on a social network.

2. Background of Related Art

A social network is a web based platform based on a social network server(s) that is typically accessible by a web browser on a desktop computer, laptop computer, or mobile device (e.g., smartphone). Conventional social networks include, e.g., www.ancestry.com, www.facebook.com, and www.myheritage.com.

Some social networking servers allow for a user device to share a post for access by connected members by requiring the user device to categorize other connected user accounts into predefined groups. Then screen content such as a post, photo, information, etc., is filtered for access by those other connected member devices based on an access designation given to those specific predefined groups.

Thus when sharing content from a post on a conventional social networking server to connected member devices and non-connected members, conventional sharing of information on the social network server is based on a quantitative measure of the categorization of the labeled group or groups in which the other connected user is placed. The quantitative approach to the sharing of a post, photo or other information is dependent on the defined access level for a given user-to-group relationship. With conventional social network servers, altering the group designation for any given connected user device to which the posting user might wish to include or exclude from a given post, photo or other information also affects the active status of prior accessible shared content for that other connected user device.

### SUMMARY OF THE INVENTION

In accordance with the principles of the present invention, a method of implementing a share level network comprises accepting a closeness rating assigned via the posting device for each of a plurality of social network user devices to which the posting device has a respective pre-defined relationship. A post is accepted from the posting device, and an assigned share level is accepted with the post. The post from the posting device is shared with only those of the plurality of social network user devices that have a closeness rating at or above the assigned share level.

### BRIEF DESCRIPTION OF THE DRAWINGS

Features and advantages of the present invention will become apparent to those skilled in the art from the following description with reference to the drawings, in which:

FIG. 1 shows an entity relationship diagram for the architectural structure of an exemplary embodiment of a social network share level network system, in accordance with the principles of the present invention.

FIG. 2 shows exemplary levels of social network share level in a social network share level network in accordance with the principles of the present invention.

FIG. 3 shows an exemplary user device interface for establishing a social network share level via a closeness-in-relationship rating, in accordance with the principles of the present invention.

FIG. 4 shows an exemplary user device interface to set a social network share level when connecting, in accordance with the principles of the present invention.

FIG. 5 shows an exemplary user device interface to establish a social network share level for an established relationship between two networked entities, in accordance with the principles of the present invention.

FIG. 6 shows an exemplary user device interface to display and permit management of a social network share level for networked entities with which a user has a relationship, in accordance with the principles of the present invention.

FIG. 7 shows an exemplary user device interface for displaying an exemplary updated layout of setting social network share level, in accordance with the principles of the present invention.

FIG. 8 shows an exemplary user device interface for establishing a social network share level in an application for posting on a given shared server, in accordance with the principles of the present invention.

FIG. 9 shows an exemplary user device interface for establishing a social network share level of a posting to a common group of shared networked entities, in accordance with the principles of the present invention.

FIGS. 10A to 10E show a grab images, or grab it, feature of shared networking, in accordance with the principles of the present invention.

FIGS. 11A and 11B show the architectural structure of an exemplary embodiment of a scrapbook networking feature, in accordance with the principles of the present invention.

FIG. 11C shows the architectural structure of another exemplary embodiment of a scrapbook networking feature, in accordance with the principles of the present invention.

FIG. 12 shows an exemplary graphical user interface for a scrapbooking cover title, in accordance with the principles of the present invention.

FIG. 13 shows an exemplary graphical user interface for customizing background of scrapbooking, in accordance with the principles of the present invention.

FIG. 14 shows an exemplary graphical user interface for edit menu options of scrapbooking, in accordance with the principles of the present invention.

FIG. 15 shows an exemplary graphical user interface for an edit toolbar for scrapbooking, in accordance with the principles of the present invention.

FIG. 16A shows an exemplary graphical user interface for adding a page feature of an edit toolbar of scrapbooking, in accordance with the principles of the present invention.

FIG. 16B shows an exemplary graphical user interface for a re-title feature of an edit toolbar of scrapbooking, in accordance with the principles of the present invention.

FIG. 16C shows an exemplary graphical user interface for an add note feature of an edit toolbar of scrapbooking, in accordance with the principles of the present invention.

FIG. 16D shows an exemplary graphical user interface for an add text feature of an edit toolbar of scrapbooking, in accordance with the principles of the present invention.

FIG. 16E shows an exemplary graphical user interface for a change theme feature of an edit toolbar of scrapbooking, in accordance with the principles of the present invention.

FIG. 16F shows an exemplary graphical user interface for a delete page feature of an edit toolbar of scrapbooking, in accordance with the principles of the present invention.

FIG. 17 shows an exemplary graphical user interface for tools for scrapbooking, in accordance with the principles of the present invention.

FIG. 18A shows an exemplary graphical user interface for a gallery feature of tools for scrapbooking, in accordance with the principles of the present invention.

FIG. 18B shows an exemplary graphical user interface for a story thyme feature of tools for scrapbooking, in accordance with the principles of the present invention.

FIGS. 18C-1 and 18C-2 show an exemplary graphical user interface for a calendar feature of tools for scrapbooking, in accordance with the principles of the present invention.

FIG. 18D shows an exemplary graphical user interface for a vault feature of tools for scrapbooking, in accordance with the principles of the present invention.

FIG. 18E shows an exemplary graphical user interface for a clip art feature of tools for scrapbooking, in accordance with the principles of the present invention.

FIG. 19 shows an exemplary graphical user interface for arranging a page in scrapbooking, in accordance with the principles of the present invention.

FIG. 20 shows an exemplary graphical user interface for auto saving a scrapbook, in accordance with the principles of the present invention.

FIG. 21 shows an exemplary graphical user interface for share level settings of a scrapbook, in accordance with the principles of the present invention.

FIG. 22 shows an exemplary graphical user interface for viewing full post in scrapbooking, in accordance with the principles of the present invention.

### DETAILED DESCRIPTION OF ILLUSTRATIVE EMBODIMENTS

The present inventors have realized that conventional social network servers do not qualitatively address the value of the privacy and sensitivity of the content of each shared post, photo, or other information. A conventional social network user device is able to share a post to multiple groups, and other users may be associated with multiple groups simultaneously. Also, the conventional social network user device may change the access designation of a given group to which a post is shared, but that would then affect how the post is viewed by connected social network user devices based on that changed group access designation. Conventional social network servers do not have the capability to permit a social network user device to alter the group designation for a given post while still maintaining an active status of prior viewable content by other social network user devices within that group. There is no conventional social network server that enables sharing of any given post, photo, or other information based on a qualitative measure of the content of each post itself. Rather, conventional social network servers share user content based on categorization of an audience group that is permitted to view or otherwise access the post, photo, etc. of any given social network user device.

In accordance with the principles of the present invention, a qualitative measure of the privacy is defined for each post, photo, etc. vis-a-vis each other social network user to which a poster has a defined relationship, enabling connected social network user devices to view shared content regardless of any change in the quantitative measure used to categorize a connected social network user device's status (such as being designated as a member of a given group that might not otherwise conventionally have access to that post, photo, etc.). In accordance with the present invention, the qualitative measure is independent of any quantitative measure.

The present invention provides a qualitative “Social network share level” for each post, photo, etc. by a given social network user device. The social network share level is based on actual content sensitivity, permitting each shared post, photo, or other information viewable by other social network user devices based on its own individual social network share level, or “closeness rating.” The closeness rating is inclusive and based on a social network share level set by the poster when making the post, adding the photo or other information. The social network share level establishes individually which connected social network user device(s) to which the poster has an established relationship may have access to the shared post, photo, information, etc.

The disclosed embodiments of social network sharing are based on a social network server built with a LAMP infrastructure (Linux, Apache, Mysql, and PHP) utilizing YII framework. The communication and sharing level in accordance with the present invention is an interactive electronic solution to emulate real life social communication via digital devices (e.g., laptop computers, smartphones, etc.) enabling sharing of data, photos, links, or other information between established and pre-defined social network user devices grouped as a family, work group, or other social unit. The disclosed social network server, referred to herein as ThymeVine™, infuses the sharing of data, photos, links, or other information with a fully flexible—and individual—social network share level that provides the sharing social network user device with the ability to fully customize access to their content, thus providing full sensitivity to the privacy of each and every post, photo, etc.

Social network share level is a measure applied to each and every post, photo or other information posted by a social network user device, used to determine what other social network user devices can view that content on the social network server. Social network share level is a qualitative measure to rate the sensitivity and privacy of the content of a post (as opposed to the conventional quantitative measure based on the designated access level of a group to which other social network user devices belongs.)

Social network share level is applied over two areas to achieve the proper qualitative versus quantitative effect. Social network share level is first applied as a designation of a closeness rating between two connected (i.e., associated) social network users. The closeness ratings set between two associated social network users preferably can be changed at any time.

It is important to note that the designation of social network share level between two associated social network users, vis-a-vis one another, not be disclosed to one another social network user devices. The Social network share level designation determines if an associated social network member will be able to view or not view a post (or photo, etc.) that is shared to other members of the social network if a given social network user decides to use Social network share level as a method to post and share their content over the relevant social network server.

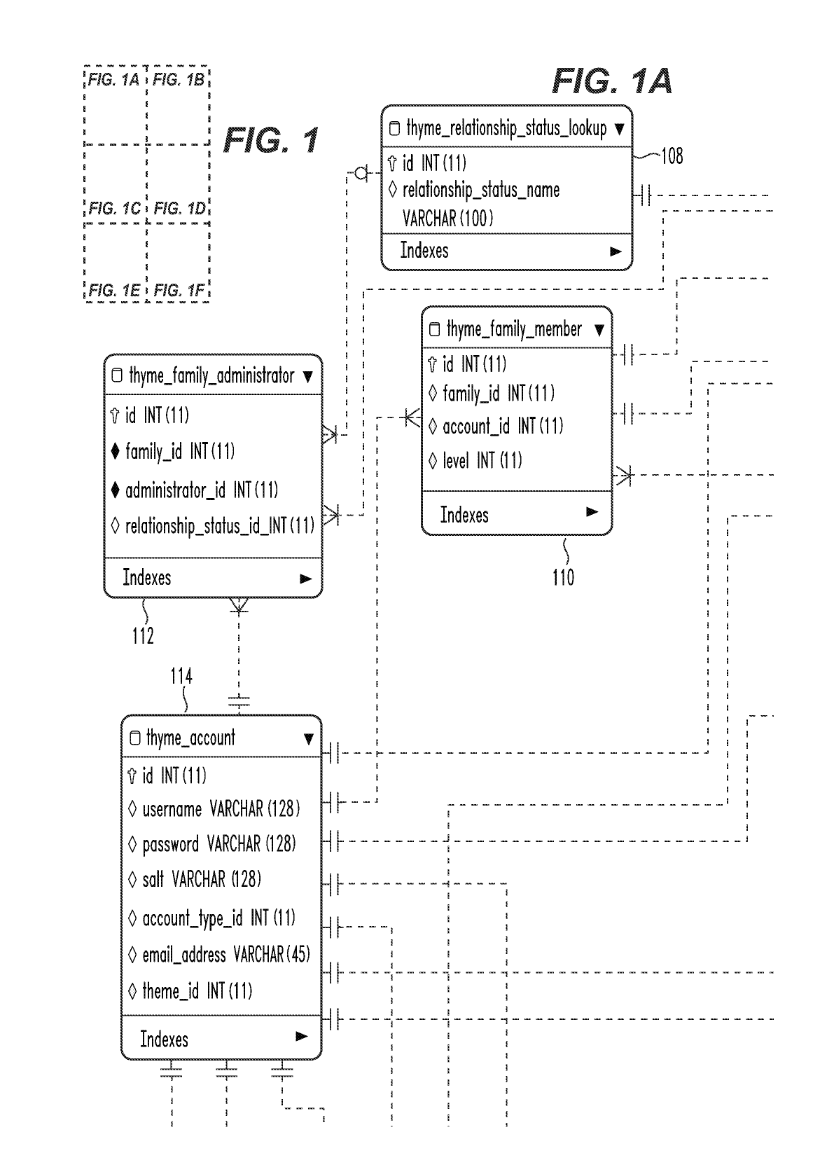

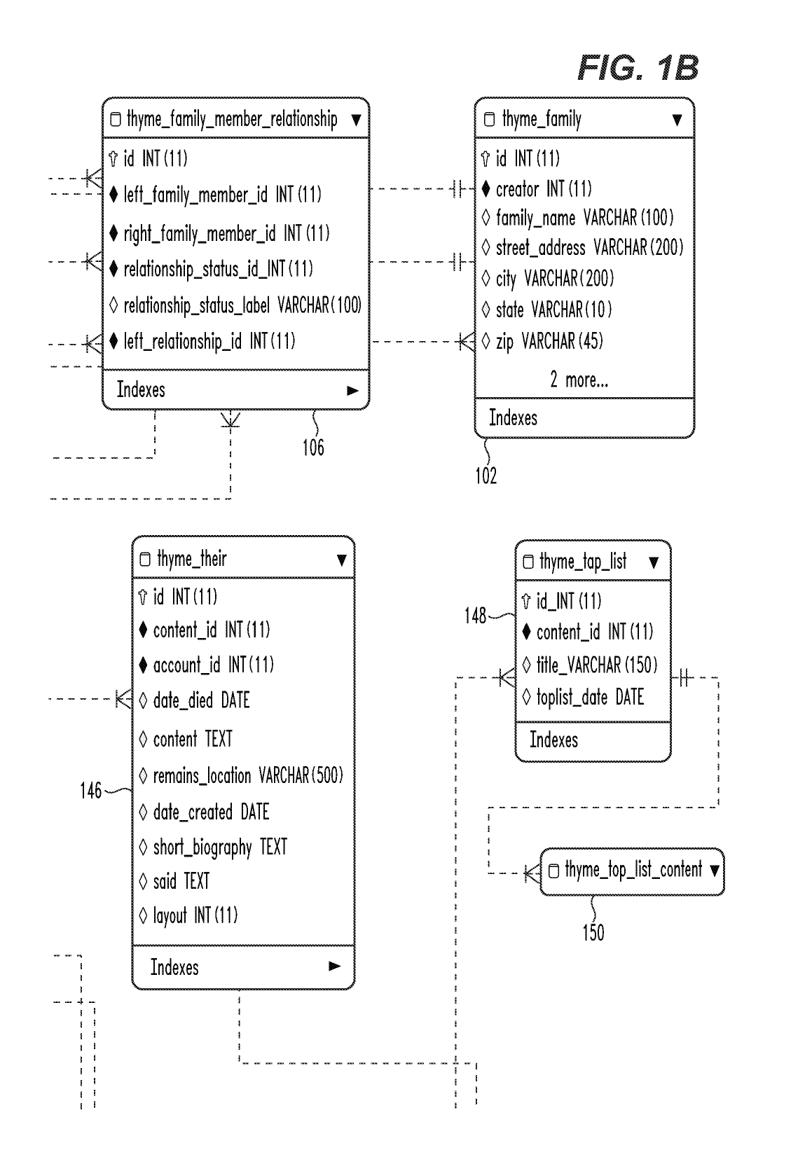

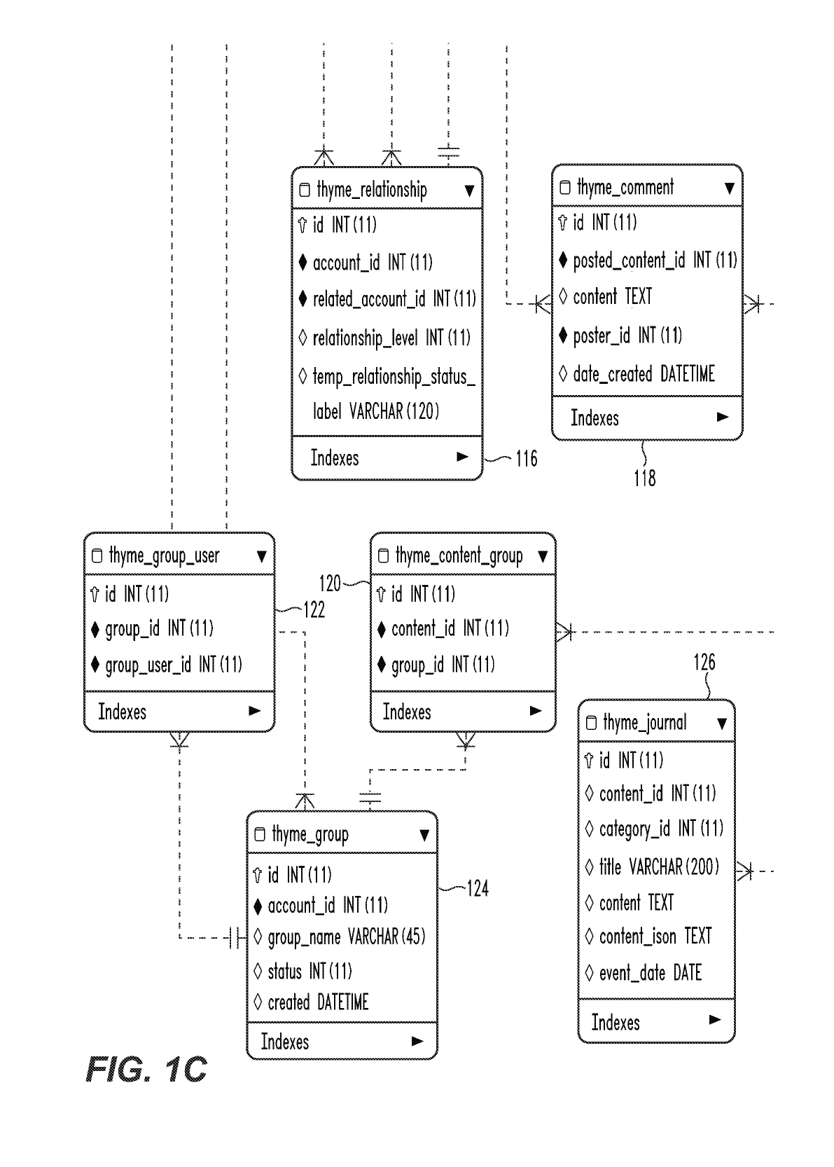

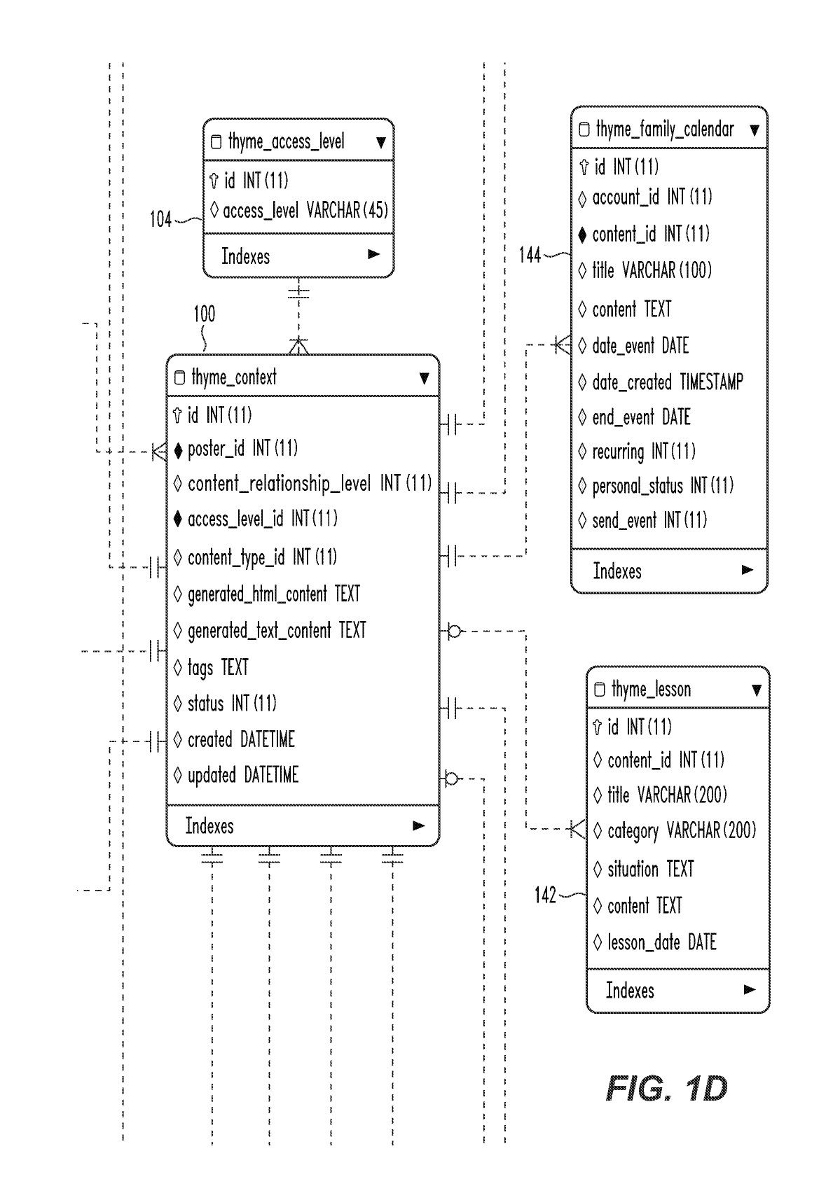

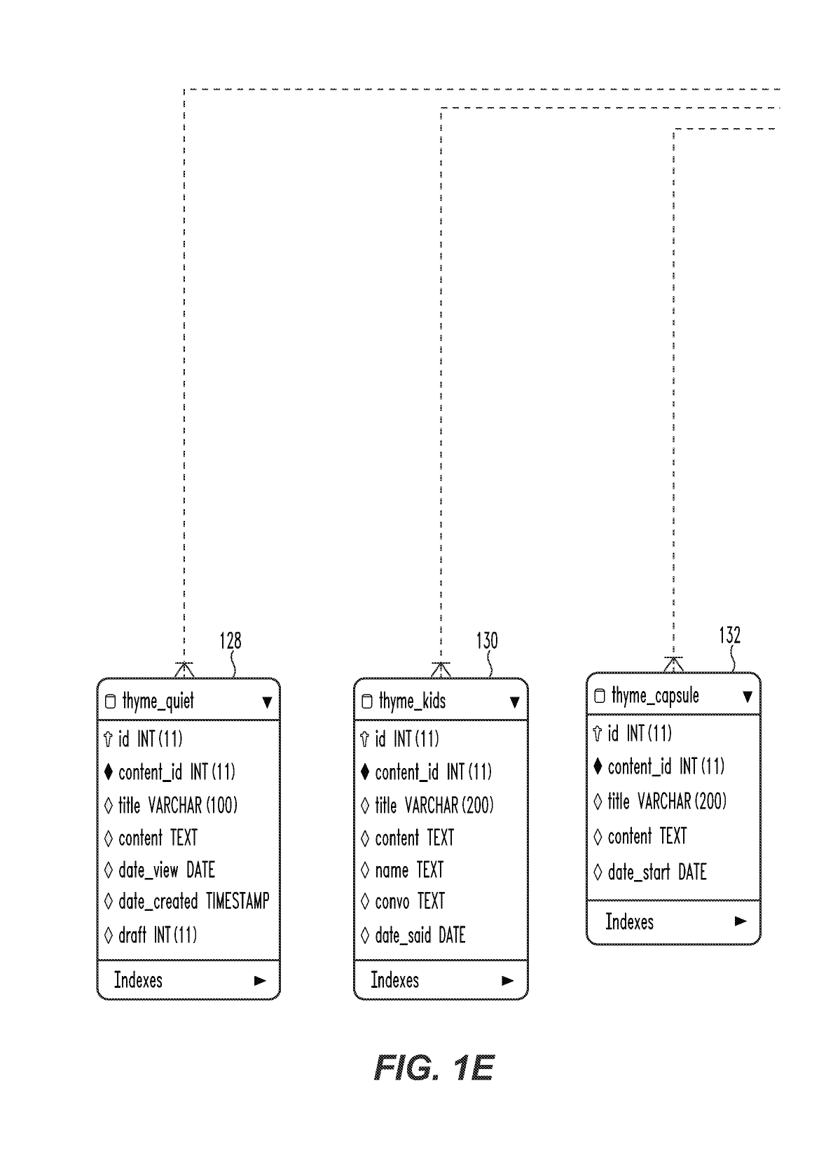

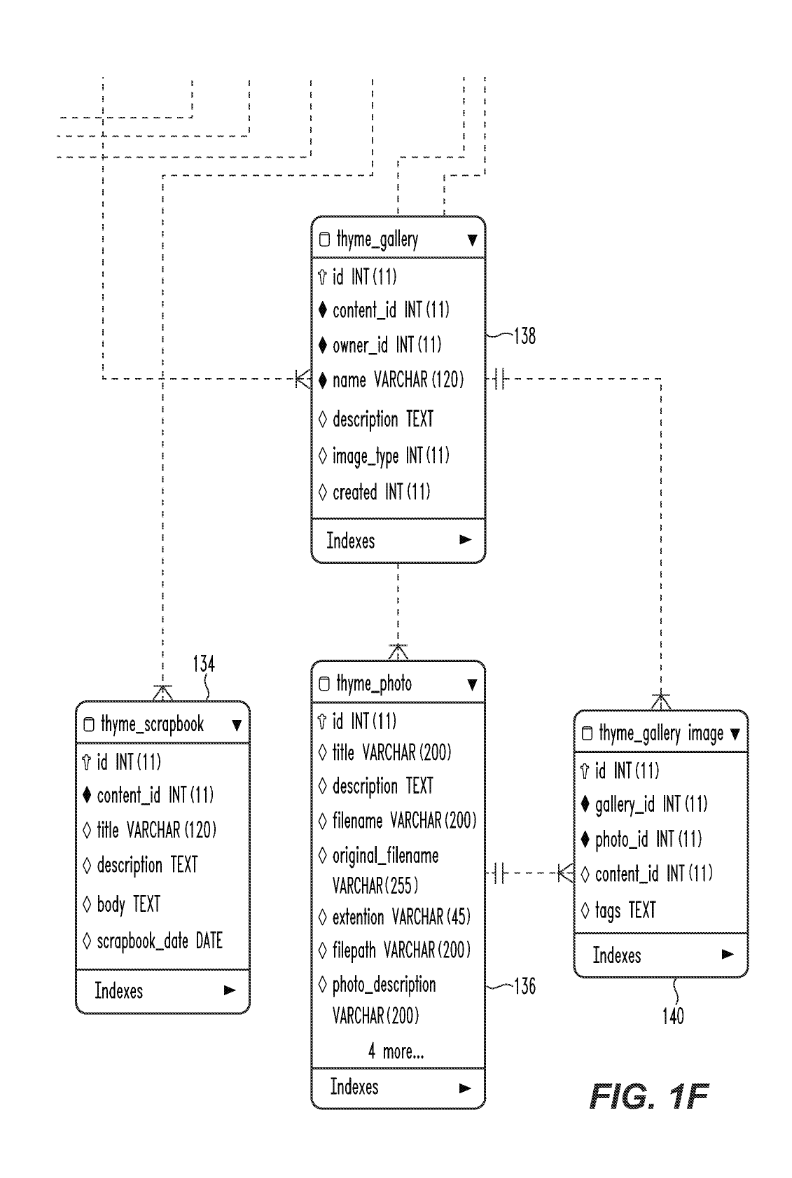

FIG. 1 shows an entity relationship diagram for the architectural structure of an exemplary embodiment of a social network share level network system, in accordance with the principles of the present invention.

In particular, as shown in FIGS. 1A and 1B, a social network share level is established in a network of devices such as in a social network with various architectural modules. FIGS. 1A and 1B show the aspects of the invention that are affected within each module. The exemplary modules shown in FIG. 1A include the tyme_content 100, tyme_access_level 104, tyme_family 102, thyme_family_member_relationship 106, thyme_comment 118, thyme_group 124, thyme_group_user 122, thyme_content_group 120, thyme_relationship 116, thyme_account 114, thyme_family_member 110, thyme_family_administrator 112, and thyme_relationship_status_lookup 108 modules. Additional exemplary modules shown in FIG. 1B include thyme_journal 126, thyme_fallery 138, thyme_top_list, thyme_top_list_content 150, thyme_their 146, thyme_family_calendar 144, thyme_lesson 142, thyme_gallery_image 140, thyme_gallery 138, thyme_photo 136, thyme_scrapbook 134, thyme_capsule 132, thyme_kids 130, and thyme_quiet 128.

Thyme_account 114 is the table that holds all of the accounts either active or inactive in ThymeVine™. Almost all of the other tables are related with this table—all of the transaction in the ThymeVine™ will proceed with this table. Account in ThymeVine™ system can be create through the following scenarios: account registered, account added from family tree, account created through invitation. In a given scenario in which an account is created through family tree or invitation, it will be considered an inactive account. A user would need to activate it via the email notification that will be sent to them.

Thyme_family_administrator 112 is the table that holds all family administrators account by family—thyme_family 102.

Thyme_family 102 is the table that holds all the family created under ThymeVine™. It also holds other information of a family such as the street address, city, state, zip and country. As showed in the diagram, family creator is linked to the account that shows that they have the full control under this family, and also it is possible that family creator is not the family administrator.

Thyme_family_member 110 is the table responsible in gathering family members' accounts. It will be shown in this table how are they related with each other, the link to thyme_family_member_relationship 106 will also vary. Family members are link to different level of relationship which describe the social network share level to the posts.

Thyme_relationship 116 specifies the level of relationship between two accounts. If you add from account to the family tree, connect a vine or invited to join the family; relationship will be added to this table.

Thyme_family_member_relationship 106 specifies the relationship of accounts under the family. Left family member and right family member describe which side of your family you are related to, and also for creating a family tree.

Thyme_group 124 is the table that holds groups created by an account. These groups are useful for post sharing and group messaging.

Thyme_group_user 122 is the table that holds the list of accounts that is part of the group.

Thyme_content 100 is basically the table that holds post from the different modules of ThymeVine™. It contains general information of the post, such as tags, poster, and most important is the level of access or the Social network share level. Sharing of post depends from the relationship of accounts declared at thyme_relationship 116. If a post is shared to a group, the group will be listed to thyme_content_group 120 with the content ID (post ID). Preferably any contents are not fully deleted from this table, but rather are simply flagged as deleted or archived on the content's status. Generally, everything under wall activities are in this table.

Thyme_comment 118 is the table that holds comments of a post and also the poster. Simply put, a user device can comment on a post if they have access on its content or are part of the social network share level of the post.

Modules under the system linked to thyme_content 100 include: Thyme_journal 126, Thyme_top_list 148, Thyme_kids (they said it) 130, Thyme_quiet 128, Thyme_capsule 132, Thyme_gallery 138, Thyme_lesson 142, Thyme_family_calendar 144, Thyme_their 146, and Thyme_scrapbook 134. other posted to content.

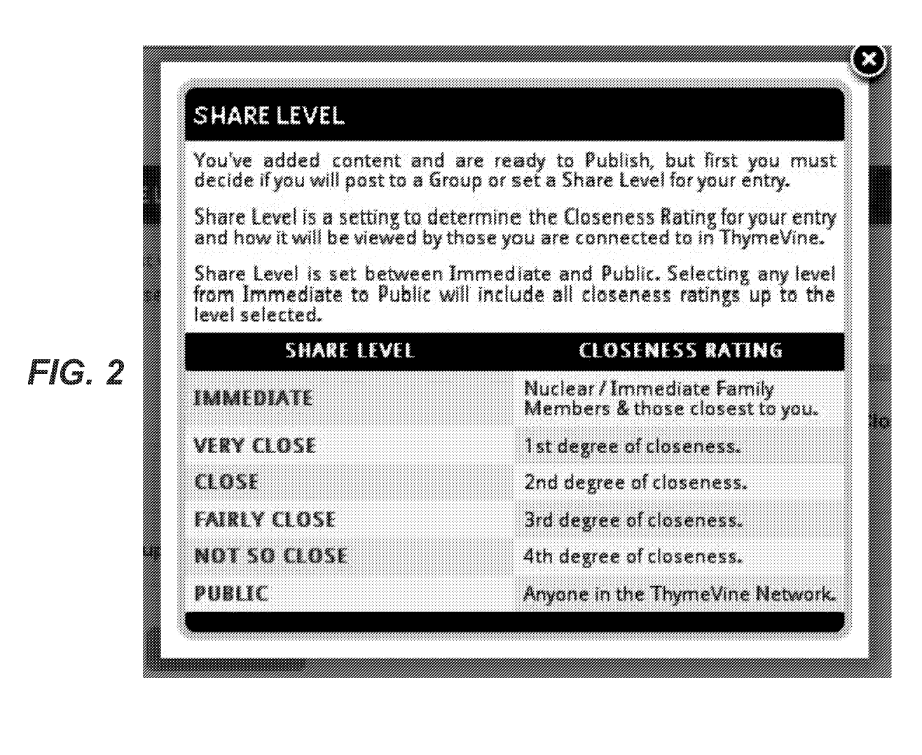

FIG. 2 shows exemplary levels of social network share level in a social network share level network in accordance with the principles of the present invention.

In particular, as shown in FIG. 2, social network share level designates a qualitative level of closeness for any given post, photo, etc., e.g., in a range from “Immediate” all the way to “Public.” Exemplary social network share levels between Immediate to Public are, but not limited to, “Immediate”, “Very Close”, “Close”, “Fairly Close”, “Not So Close”, and “Public”. These exemplary social network share levels represent a total of six (6) degrees or closeness levels that are applied subjectively by a social network user device to its posts, photos, etc., and those social network member devices (or even non-member devices) they are connected to or otherwise associated with.

The range for social network share levels between social network user devices in the disclosed embodiments of the ThymeVine™ social network server is limited from “Immediate” to “Not So Close”, though certainly additional social network share levels may be implemented within the principles of the present invention.

A social network share level in a social network share level network in accordance with the principles of the present invention includes a significant number of levels of closeness to define within a given relationship between the given social network user device and another social network user device (i.e., between two user devices in a social network.) Alternatively, or additionally, the levels of closeness may be used to define a relationship between the given social network user and a pre-established group of social network users as identified on their respective user devices.

The social network share level is a setting to establish a closeness rating for a given social network user device's entry or posting onto their ThymeVine™ presence, and how it will be enabled to be viewed by other social network user devices to which it is connected (i.e., associated with) in the ThymeVine™ social network server.

The social network share level of closeness may be established for social network user devices within the ThymeVine™ social network—particularly for those that the given social network user has an established relationship. Once content is added to a given social network user's ThymeVine™ presence, they are ready to publish. A post may be made to a group, or a social network share level for their entry may be set. The social network share level of a posting, photo, link, or other content, may be set between “Immediate” (being the most private setting) and “Public” (being the least private setting.) In accordance with the principles of the present invention, a plurality of closeness levels are defined between the most private setting and the least private setting. In the given embodiments four levels of closeness are defined between the most private setting and the least private setting (for a total of six settings.) It is within the principles of the invention to include more levels of setting between the most private and the least private. Even a virtually infinite number of social network share levels or settings may be implemented (e.g., visually presented to the user as if the closeness setting may be anywhere along an analog sliding bar) for selection of a closeness rating as a fractional value anywhere between the most private setting (e.g., “Immediate”) and the least private setting (e.g., “Public”).

The “Immediate” social network share level may be defined as including the social network user's nuclear members, members of the given social network user's immediate family, and social network members that are closest to the given social network user.

The “Very Close” social network share level may be defined as a 1^{st} degree of closeness.

The “Close” social network share level may be defined as a 2^{nd} degree of closeness.

The “Fairly Close” social network share level may be defined as a 3^{rd} degree of closeness.

The “Not So Close” social network share level may be defined as a 4^{th} degree of closeness.

The “Public” social network share level may be defined as anyone within the network, e.g., anyone within the ThymeVine™ social network.

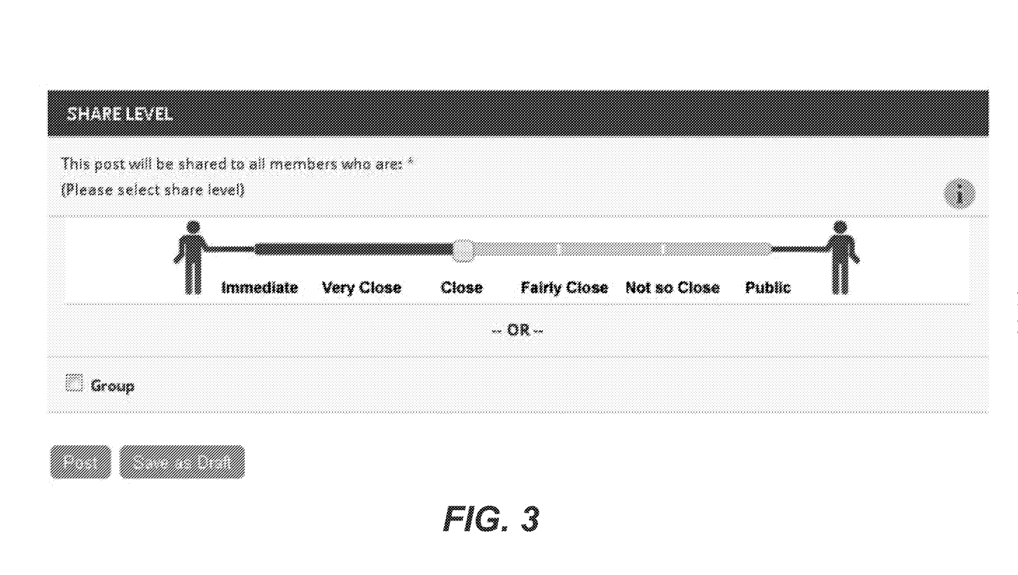

FIG. 3 shows an exemplary social network user device interface for establishing a social network share level via a closeness-in-relationship rating, in accordance with the principles of the present invention.

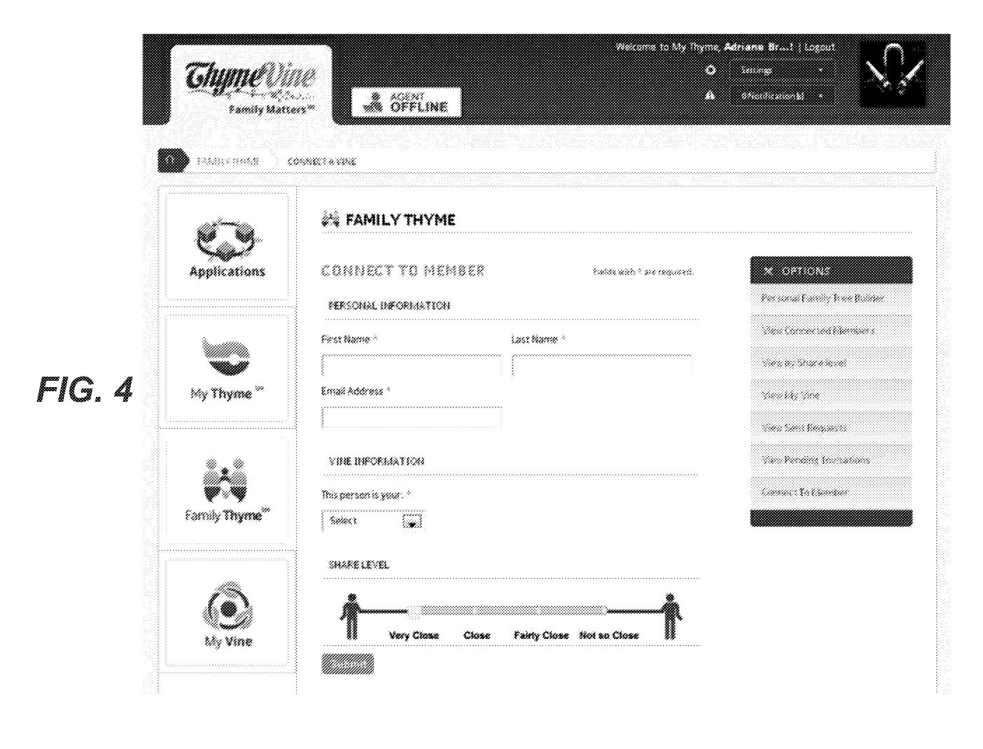

FIG. 4 shows an exemplary social network user device interface to set a social network share level when connecting, in accordance with the principles of the present invention.

In particular, as shown in FIG. 4, the social network share level may be set when connecting (associating) or accepting a connection (association) to another social network member device in the ThymeVine™ social network server. Preferably rules and conditions are used to maintain integrity and communication between social network member devices.

A given user on a social network user device may connect to another member of the ThymeVine™ social network by inputting personal information about the other social network user with which they want to establish a relationship. For example, entry of a first and last name and/or email address may be sufficient to seed a successful search for the social network identity of the desired social network user. Also input may be a definition of the relationship (e.g., family, parent, friend, relative, colleague, schoolmate, etc.) Then, importantly, the social network user sets a closeness rating, e.g., a social network share level, for posts, photos, etc. to be permitted to be accessed by that social network user device—anywhere from the most private setting (e.g., “Immediate”) to the least private setting (e.g., “Public”).

In the disclosed embodiment the social network share level is chosen using a visual sliding bar that may be set to any of a predetermined number of closeness levels (e.g., six in the given embodiments, though a virtually infinite number of positions corresponding to fractional closeness settings may be established between the most private and least private settings.)

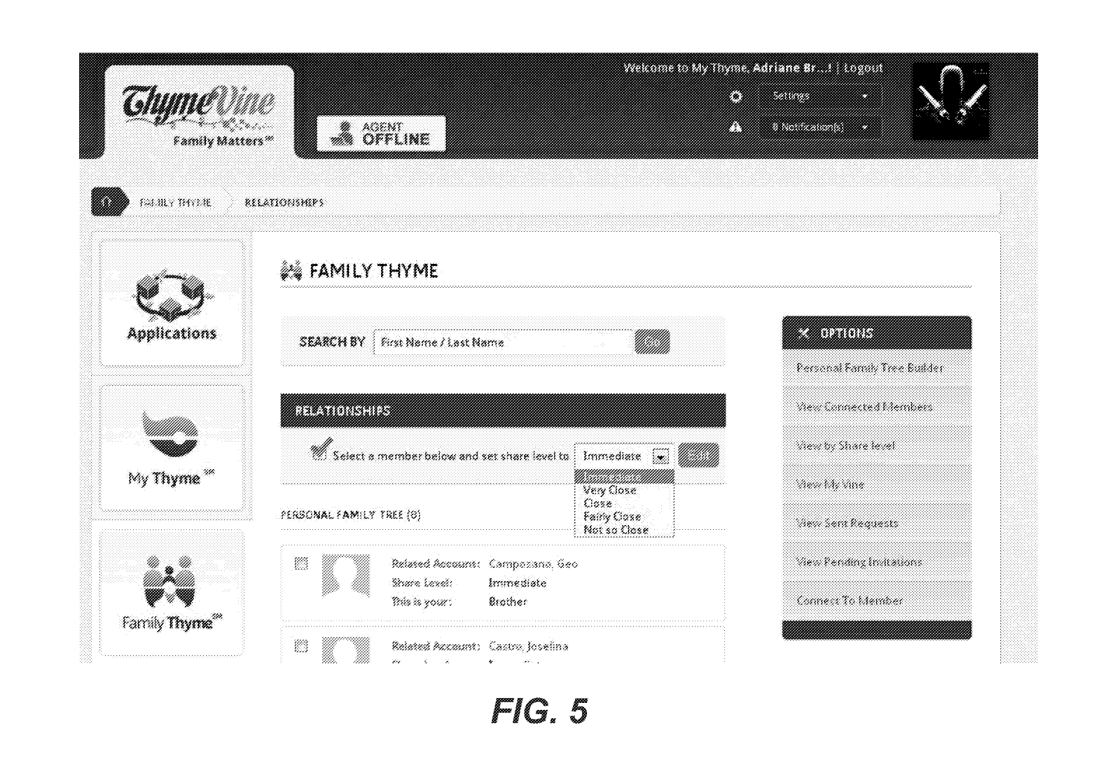

FIG. 5 shows an exemplary social network user device interface to establish a social network share level for an established relationship between two networked entities, in accordance with the principles of the present invention.

The range for social network share level to be set between social network members of ThymeVine™ where neither member is the Family Administrator of the other is Very Close to Not So Close. The “Immediate” social network share level is under the control of a Family Administrator. When a Family Administrator adds a social network member to a group defined as “Family”, a default social network share level of Immediate is set between the Family Group social network member and all those social network members designated as being in the “Family” group.

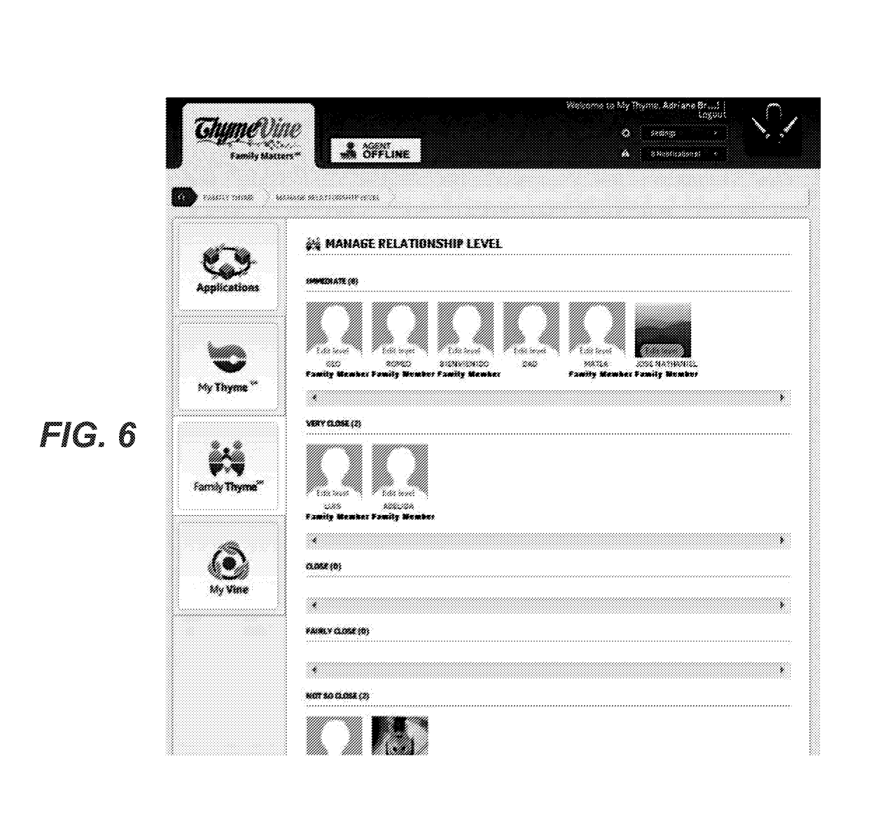

FIG. 6 shows an exemplary social network user device interface to display and permit management of a social network share level for networked entities with which a social network user has a relationship, in accordance with the principles of the present invention.

In given embodiments, social network members connecting to each other outside of the Family Administrator to Family group and wishing to establish a social network share level of “Immediate” must first connect with a lower social network share level and after successful connection, change the social network share level to that social network member from the lower social network share level to “Immediate”. The Family Administrator social network user device is provided the authority to override any social network share level connections set to Immediate by a social network user in the Family group.

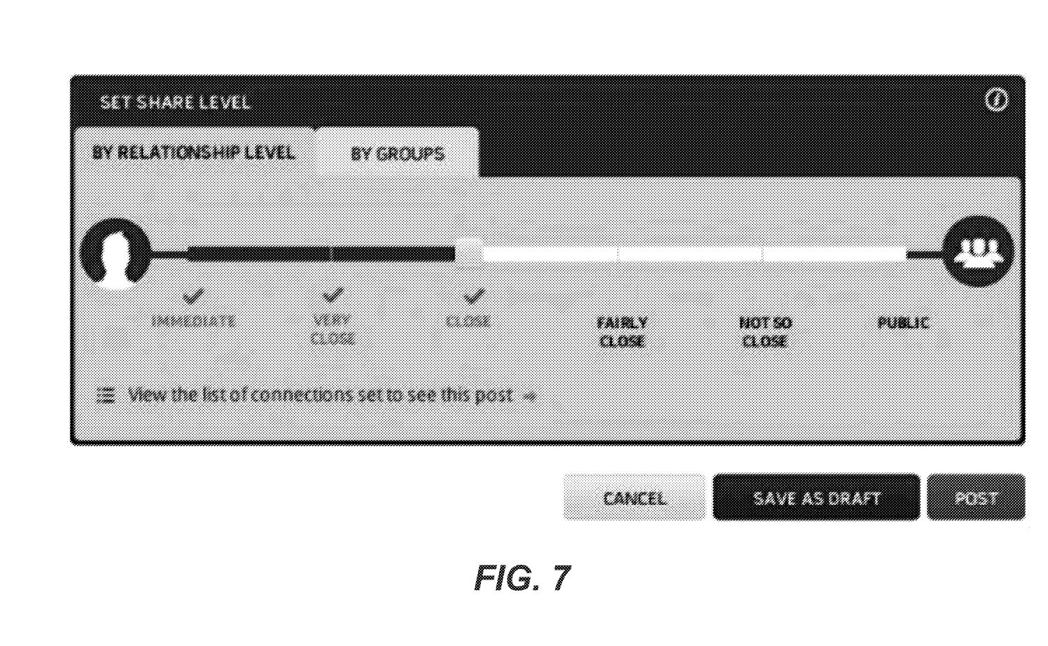

FIG. 7 shows an exemplary social network user device interface for displaying an exemplary updated layout of setting social network share level, in accordance with the principles of the present invention.

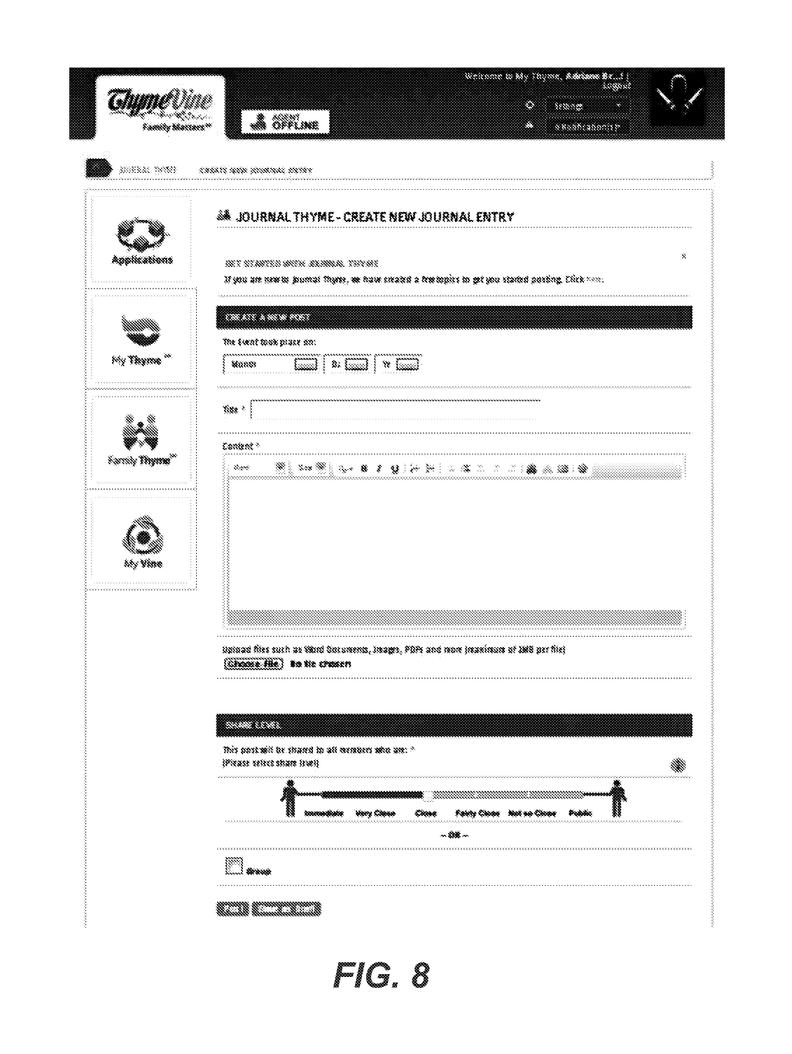

FIG. 8 shows an exemplary social network user device interface for establishing a social network share level in an application for posting on a given shared server, in accordance with the principles of the present invention.

Social network share level set as a Posting rule for the content in an Entry is an inclusive measure to include all higher levels of closeness from the selected level. Example: If a social network user device sets a social network share level of “Close” for an entry, then all connected (e.g., associated) social network user devices having higher social network share level(s) (e.g., “Very Close” and “Immediate”) will also be enabled to view or otherwise access the posting (or photo or other information by the posting social network user device.)

The inclusive use of the social network share level maintains the qualitative nature of the social network share level—versus the quantitative nature of the use of a group setting as in conventional social networks. A group can include connected members of different social network share level settings. As an example: a group called “Group Reunion” can include all connected social network members having a Relationship Status of Cousin (with respect to the posting social network user), where each cousin in the group has different or similar social network share level settings.

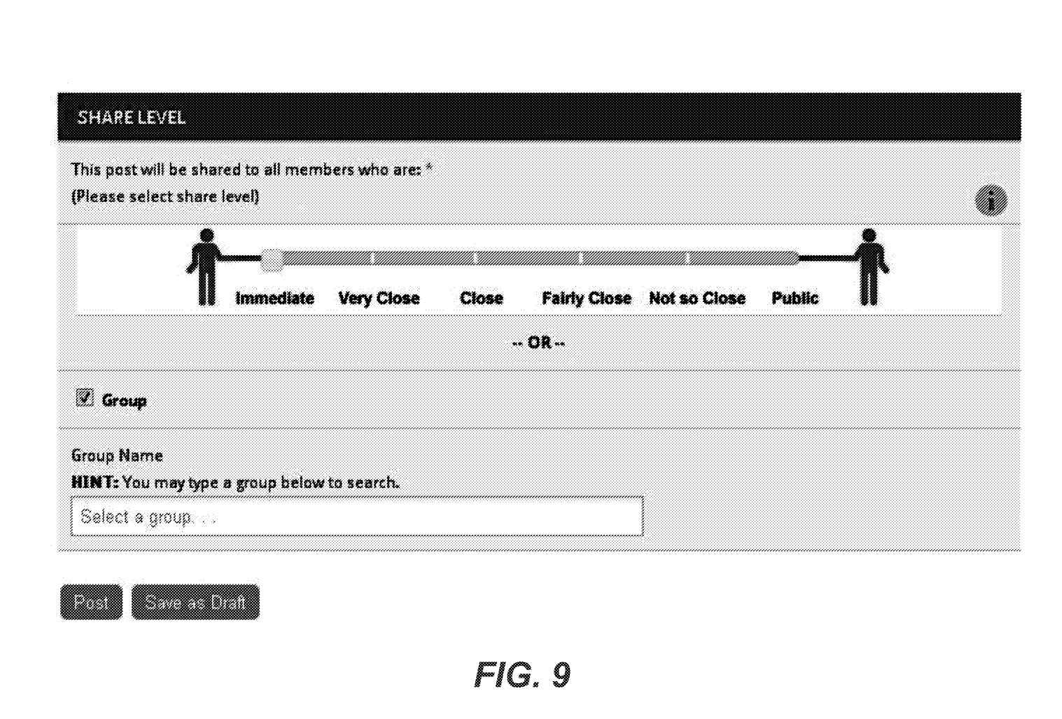

FIG. 9 shows an exemplary user device interface for establishing a social network share level of a posting to a common group of shared networked entities, in accordance with the principles of the present invention.

The social network share level between connected social network members of the ThymeVine™ social network cannot see each other's social network share level setting that a connected social network member has set them at. The Family Administrator can see the relationship status setting, and connection requests, and acceptance that “Family” group members have to those members outside the “Family” group, but cannot see the social network share level setting between “Family” group members and anyone they are connected to on the ThymeVine™ social network, including the Family Administrator.

Below is an exemplary network implementation of share level networking, in accordance with the principles of the present invention.

### REGISTRATION (Create a Family Account)

Step1. Account Information (PLANT A VINE). Fill out all the required fields indicated with an asterisk “*”. Enter Username (*). Username should be unique and not registered by another user. Special characters are not allowed (e.g. “!”, “@”, “,”, “ ”, “:”) Enter Password (*). Minimum is 8 characters. Special characters are not allowed (e.g. “!”, “@”, “,”, “ ”, “:”). Re-Type Password (*). Password must match with the first one. Minimum is 8 characters. Special characters are not allowed (e.g. “!”, “@”, “,”, “ ”, “:”). Enter Email-address (*). Email Address that was already used to register in this website is not allowed. Re-Type Confirm E-mail Address. Email Address must match the first one. The “Clear” button clears all the fields. When the form is completed, select the “Next” button to proceed on to Step 2.

Step2. Misc Information (PLANT A VINE). Fill out all the required fields indicated with an asterisk “*”. Enter First Name (*), Middle name is optional, Enter Last Name (*), Nickname is optional. Select Gender (*) should be chosen from the two options. The option “Please select” would be selected by default so that it would force the user to select one. Date of Birth field should be entered in the following order: (Format: Month/Day/Year e.g.: March/16/1992) (*). Month (January to December), 2 Digits for the Day, 4 Digits for the Year. Select Country (*). If you live in the United States the default country will be “STATE”. Street Address optional, City optional, State optional, Zip Code optional, Phone Number optional, Mobile Number optional. The “Clear” button will clear all the fields; The “Back” button will redirect to the previous page/Step 1.

Step3. Billing Information (PLANT A VINE). Check: Start your 30 day trial. Invite up to five verified Thyme Vine users to be part of your Personal Family Tree. Preferably a user can create and update posts both for the user and other members of your Personal Family Tree. Valid credit card is required to start the free 30 day trial. Uncheck: to skip Start 30 day trial.

### LOGIN

Click and Type Username; Click and Type Password. Click “Login” button to redirect on the Thyme Vine main page. Forgot Username/Password functionality is preferably included. To do so enter the Email Used To Create The Account, and click “Retrieve Username/Password” button to recover the username and password. Thereafter check the Thyme Vine Password Recovery on the user's email.

### SETTINGS

Modify your account, Update subscription info, Hide or Show markers, Logout. Exemplary user-accessible account settings:

| BUTTONS/HYPERLINKS | FUNCTION |
|---|---|
| Save | Save and apply changes on your account |
| | information. |

### Steps to Update Account Settings

On home, at top right of the page hover the pointer on Settings. A list of settings options will appear. Click Account Settings. Page will redirect to your account information. Start filling out fields you desired to change. Required fields must be filled out. After filling out, Click Save. A prompt message will be displayed “Account Successfully Updated”.

### PROFILE PICTURE

| BUTTONS/HYPERLINKS | FUNCTION |
|---|---|
| Save | Save and apply changes. |
| Choose file | Let's you browse your file on your |
| | desktop for uploading. |
| Gallery | Let's you browse a picture from your |
| | ThymeVine Gallery. |

Steps to Change Profile Picture (from my Computer):

On Account settings, click Profile Picture tab. From the drop down list choose From my computer if you wish to choose a picture from your computer. Click Choose file. Select your desired profile picture. The file name of the selected image will be displayed beside the button. Click Save. A prompt message will display “Profile Picture Successfully Updated”.

### To Change Profile Picture (My Gallery)

On Account settings, click Profile Picture tab. Current profile picture. From the drop down list choose My Gallery if you wish to choose a picture from your ThymeVine Gallery. Click Gallery. A window will appear to let you browse your picture. Select your desired profile picture. The link of the selected image will display on the field. Click Save. A prompt message will display “Profile Picture Successfully Updated”.

### Profile Info

| BUTTONS/HYPERLINKS | FUNCTION |
|---|---|
| Save | Save and apply changes on your account |
| | information. |
| Choose file | Let's you browse your file on your desktop for |
| | uploading. |

### Steps to Update Profile Info:

On account settings, click profile info tab. The page will redirect to your profile information. Start filling out fields you desired to change. Required fields must be filled out. If you wish to upload documents or files, click choose file. A window will appear to let you browse your files. If you wish to delete uploaded files, mark the box beside the filename. Click save. A prompt message will display “Your Profile was Successfully Updated”.

### Education and Work

| BUTTONS/HYPERLINKS | FUNCTION |
|---|---|
| Save | Save and apply changes on your account |
| | information. |
| +Add Entry | Adds an entry on your information. |
| −Cancel | Remove entry. |
| Edit | Let's you edit your entered information. |
| Update | Apply the changes made. |
| Delete | Delete entry. |
| Cancel | Cancel editing. |

### Steps to Add Education and Work:

On account settings, click education & work tab. The page will redirect to your profile information. If you wish to add an additional information, Click +Add Entry. Start filling out fields. Required fields must be filled out. Click Save. A prompt message will display “Your Profile was Successfully Updated”.

### Updating Education and Work:

Click edit on the entry you wish to update. Start filling out fields you desired to change. Required fields must be filled out. Click Update. A prompt message will display “Your Profile was Successfully Updated”.

### Updating Education and Work (Delete):

Click edit on the entry you wish to update. A prompt message will appear. Click OK. A prompt message will display “Your Profile was Successfully Updated”.

### Philosophy

| BUTTONS/HYPERLINKS | FUNCTION |
|---|---|
| Update | Save and apply changes on your account |
| | information. |

### STEPS:

### Philosophy

On account settings, click philosophy tab. The page will redirect to your profile information. Start filling out fields. Required fields must be filled out. Click update. A prompt message will display “Your Profile was Successfully Updated”.

### Favorites

| BUTTONS/HYPERLINKS | FUNCTION |
|---|---|
| +Add Entry | Adds an entry on your information. |
| Update | Apply the changes made. |
| Delete Marked | Delete entry. |

### STEPS:

### Favorites

On account settings, click favorites tab. The page will redirect to your profile information. If you wish to add an additional information, Click +Add Entry. Start filling out fields. Required fields must be filled out. Click Update. A prompt message will display “Your Profile was Successfully Updated”.

### Favorites (Delete Marked)

Mark the box of an entry that you want to delete. Click delete marked. Click OK. A prompt message will display “Your Profile was Successfully Updated”.

### Sports

| BUTTONS/HYPERLINKS | FUNCTION |
|---|---|
| +Add Entry | Adds an entry on your information. |
| Update | Apply the changes made. |
| Delete Marked | Delete entry. |

### STEPS:

### Sports

On account settings, click sports tab. The page will redirect to your profile information. If you wish to add an additional information, Click +Add Entry. Start filling out fields. Required fields must be filled out. Click update. A prompt message will display “Your Profile was Successfully Updated”.

### Sports (Delete Marked)

Mark the box of an entry that you want to delete, Click delete marked. Click OK. A prompt message will display “Your Profile was Successfully Updated”.

### SUBSCRIPTION INFO

| BUTTONS/HYPERLINKS | FUNCTION |
|---|---|
| Start 30 day trial | This button will enable the features of |
| | ThymeVine for 30 days. |
| Increase limit | Purchase more slots to increase the number of |
| | verified family members. |
| Add a new Credit Card | Register a new credit card. |
| View Subscription | Details of your subscription |
| Cancel Subscription | End subcription |

### STEPS:

### Register Subscription (Plant a Vine)

Billing Information is on the 3^{rd} step of planting a vine. Check Start 30 day trial. Fields will appear for registration of your Credit card. Preferably if the user does not sign up for 30 day trial while planting a vine, they can still sign up on Family Admin Options after logging in. Start filling out fields. Required fields must be filled out. Then click submit. A prompt message will display “You have successfully created your account”.

### Purchase Plan

On home, at top right of the page hover the pointer on Settings. A list of settings options will appear. Click Subscription Info. The page will redirect to ThymeVine Subscription Info. Select a Credit card to use, on the drop down list. Click Purchase Plan. A prompt message will display for the new ThymeVine Plan.

### Increase Limit (Slots)

On your Subscription Info, Click Increase limit. Choose the number of slots that you want to add. Select a Credit card to use, on the drop down list. Click Purchase Family Member Slot.

### HIDE/SHOW MARKERS

### STEPS:

On home, at top right of the page hover the pointer on Settings. A list of settings options will appear. Click Hide Markers, and markers will be hidden. Or click Show Markers, and markers will be shown.

### PROFILE

| BUTTONS/HYPERLINKS | FUNCTION |
|---|---|
| Go back to MyThyme | Back to My Thyme. |
| Modify Profile | Redirects to Profile Info. |
| Update Status | Update the posted status or shoutout on your |
| | profile. |
| Profile Completion | Redirects to designated page depends on |
| | what you select from the list. Percentage will |
| | increase once you add an information on |
| | your profile. |
| Edit | Redirects you to the page where you can |
| | edit your information. |
| Expand | Enlarge the list. |
| Update Personal Family | Redirects you to Manage Personal Family |
| Tree | Tree. |
| Connect a vine | Allows you to connect to a member. |
| +Add | Let's you add a member on a group. |
| Edit Groups | Let's you edit your family groups. |
| Change Profile Picture | Let's you change your Profile Picture. |
| Photos | Redirects you to My Gallery. |

### STEPS:

### Modify Profile

On profile, click Modify Profile. The page will redirect to profile info. Fill out the fields to complete or update. Required fields must be filled out. If you wish to upload documents or files, click Choose file. A window will appear to let you browse your files. If you wish to delete uploaded files, mark the box beside the filename. Click Save. A prompt message will display “Your Profile was Successfully Updated”. Note that the procedure is the same on Basic Info (Edit) and +Complete your personal. Note also that changes made may apply on your Profile Page.

### UPDATING STATUS

On profile, click Update Status. Enter your status. Click Share.

### WORK & EDUCATION (EDIT)

On profile, click Edit on Work and Education. The page will redirect to profile info. If you wish to add an additional information, Click +Add Entry. Start filling out fields. Required fields must be filled out. Click Save. A prompt message will display “Your Profile was Successfully Updated”. Note that changes made may apply on your Profile Page. Note also that the procedure is the same on +Add College and +Add Highschool.

### Updating Education and Work

Click Edit on the entry you wish to update. Start filling out fields you desired to change. Required fields must be filled out. Click Update. A prompt message will display “Your Profile was Successfully Updated”. Note that changes made may apply on your Profile Page.

### Updating Education and Work (Delete)

Click Edit on the entry you wish to update. A prompt message will appear. Click OK. A prompt message will display “Your Profile was Successfully Updated”.

### Favorites

On profile, click Edit on Favorites. Page will redirect to your Profile information. If you wish to add an additional information, Click +Add Entry. Start filling out fields. Required fields must be filled out. Click Update. A prompt message will display “Your Profile was Successfully Updated”. Note that changes made may apply on your Profile Page.

### Favorites (Delete Marked)

Mark the box of an entry that you want to delete. Click Delete Marked. Click OK. A prompt message will display “Your Profile was Successfully Updated”.

### Sports

On profile, click Edit on Sports. The page will redirect to your Profile information. If you wish to add an additional information, Click +Add Entry. Start filling out fields. Required fields must be filled out. Click Update. A prompt message will display “Your Profile was Successfully Updated”. Note that changes made may apply on your Profile Page. Note also that the procedure is the same on +Add Sports.

### Sports (Delete Marked)

Mark the box of an entry that you want to delete. Click Delete Marked. Click OK. A prompt message will display “Your Profile was Successfully Updated”.

### My Thyme Options (FAMILY ADMIN OPTIONS)

### PERSONAL FAMILY TREE BUILDER

The personal family tree builder is where a family administrator can manage personal family tree details, view their personal family tree, add a member, delete a member, edit a member, view a family member, or link an account.

For instance, to add a PARENT, under ADD A . . . , Click “Add a Parent”, all the required fields must be filled out, e.g., (First Name, Last Name, Nick Name, Gender, Birthday). Email-Address and Middle Name are optional. A “Save” button saves the filled out information; a “Reset” button clears the fields; and a “Cancel” button returns to the personal family tree builder.

To “Add a Sibling”, all the required fields must be filled out. (First Name, Last Name, Nick Name, Gender, Birthday). Email-Address and middle name are optional. A “Save” button saves the filled out information; a “Reset” button clears the fields; and a “Cancel” button returns to the personal family tree builder.

To “Add a Partner”, all the required fields must be filled out. (First Name, Last Name, Nick Name, Gender, Birthday). Email-Address and middle name are optional. A “Save” button saves the filled out information; a “Reset” button clears the fields; and a “Cancel” button returns to the personal family tree builder.

To “Add a child”, all the required fields must be filled out. (First Name, Last Name, Nick Name, Gender, Birthday). Email-Address and middle name are optional. A “Save” button saves the filled out information; a “Reset” button to clear the fields; and a “Cancel” button returns to the personal family tree builder.

### EDIT FAMILY NEWS

To create a Family News Ticker, fFill out all the required fields indicated with an asterisk “*”. Enter Title and Content, select who can view, and select status: e.g., “Show” is publicly viewable, and “Hide” permits only the user to view. Select Expiration Date: (Month (January to December); 2 Digits for the Day; 4 Digits for the Year) A “Create” button creates the news, a “Cancel” button redirects to manage the family news ticker.

To manage the newsticker: “View” to view the news ticker; “Update” to update the news ticker; and “Delete” to delete the news ticker.

### APPLICATIONS

### Journal Thyme

There are few topics that the user can choose to start posting journal entries. There are several exemplary categories that user can choose from: Personal, Family, Travel, Medical, Documents, or Customize. The categories are arranged in forms of tabs, and turns white when clicked. Beneath the categories are the topics of each category.

### Choosing a Topic

There are various topics found in Journal Thyme, and all are categorized accordingly. To choose a topic: click the desired category tab, then click the desired topic title or the ‘write about this’ link.

### Creating a Journal Entry

An exemplary journal entry may comprise: Title, Questions and Answers, Documents, Images, or pdf files (with a maximum size, e.g., a maximum size of 2 MB per file). If size limit is desired in uploaded images or documents, a filter may be implemented wherein a photo or other file is compressed to a desirable size, and even converted to a desirable format for use with the ThymeVine network.

Journal entries can be shared depending to its share level or group. A journal entry may only be shared to people or group within the share level. Share level varies as disclosed earlier, e.g., from exemplary articulated points such as Immediate, Very Close, Close, Fairly Close, Not So Close, and Public. The entry may also be shared to a Group if desired by the user.

### Saving a Journal Draft

Journal entries may also be saved as draft, so that a user can be able to continue, or update the entry on the next login. Drafts will be displayed on the Pending Projects, once the user logs in again.

| | |
|---|---|
| Title | Each journal entry should have a title |
| Questions | These questions may vary depending on the chose |
| | topic and category. |
| Answers | User may or may not input answers to questions. |
| Upload files | Documents, images, pdfs, and etc. may be included to |
| | an entry, with a maximum of 2 MB per file. |
| Browse button | This button enables to choose and upload a file from |
| | the computer. |
| Share level | Varies from immediate, very close, close, fairly close, |
| | not so close, and public. |
| Group | An entry may also be shared to the affiliated group. |
| Publish button | Click this button to publish the journal entry. |
| Save as draft button | Click this button to save the journal entry as a draft, |
| | which can be updated on the next log in. |

### Journal Thyme Options Menu

Journal entries can be created, viewed, and managed using this menu. Options menu includes the following tabs: View Your Journal Entry; Manage Your Journal Entry; Create New Journal Entry; and Browse Posts by Others. This menu may be placed on the right-side of the page.

### View Your Journal Entry

A user may view all journal entries and drafts by clicking the ‘View Your Journal Entry’ button under options menu. All entries and drafts are posted accordingly along with its Publish Date, Author, Topic Category, and Comments. The users may also leave a comment on a Journal entry and Draft.

| | |
|---|---|
| Add a Journal entry | This button enables the user to post a new journal |
| button | entry. |
| Leave a comment | Users may leave a comment to a journal entry and |
| | post. |

### Manage Journal Entries

User can Create, View, Edit, and Update journal entries and drafts using the ‘Manage Journal Entries’ button under options menu. Journal entries and drafts may also be Deleted, Published, or Updated into a draft.

| | |
|---|---|
| Create a New Journal | Create a new journal entry |
| entry button | |
| Publish | Allows user to publish a certain draft. |
| Draft | Allows user to turn an entry into a draft. |
| Delete | Allows user user to delete a journal entry, or a |
| | draft. |
| Update button | Click this button to commit the selected option. |
| View link | To view the entire journal entry or draft. |
| Edit | To edit the entire journal entry or draft. |

### Browse Posts by Others

The user may also browse other people's posts that are affiliated, and view and leave comments.

| | |
|---|---|
| View Full Posts button | To view the entire post |
| Leave a comment | User may leave comments on posted journal |
| | entries. |
| Submit button | To submit the comment inputted. |

### Top Lists

The user can make top lists. Top lists may be, e.g., a Top Wish List; Top Favorites; Top Priorities, etc. A user can also add an image or link to the Top List entry. This allows a user to customize and detail a user's favorites, quotes, songs, memories, or people. Top lists are viewed accordingly along with its Title, Top Lists, Publish Date and Time, and Author.

| | |
|---|---|
| Edit button | Allows user to edit a top list |
| View the Complete List | Allows user to view the entire top list |
| button | |
| Comment/Leave a | Allows user to add and view the comments to the |
| comment button | top list |
| Add a Top List entry | To add a new Top List button |
| button | |
| Gallery link | Allows user to add an image from the gallery to an |
| | item or entry. |

### Creating a New Top List

A Top List should have a title such as: ‘My Top favorite’, ‘My Top Priorities’, ‘My Top Recipe’, or a Custom Title. A Top list comprises items (can be songs, recipes, memories, an etc.) that may also inculde image or link. A Top List can only be shared to people or group within the share level.

As discloses, the share level varies, e.g., from: Immediate; Very close; Close; Fairly Close; Not so Close; and Public. The top list may also be shared to a group if desired by the user.

| | |
|---|---|
| Title | Each top list should have a title, which can be |
| | ‘My Top favorite’, ‘My Top Priorities’, ‘My |
| | Top Recipe’, or a custom title. |
| Top List Date | Date for the Top List |
| Add New Top List Entry | Allows user to add items or |
| button | entries to the Top List |
| Link | A link to an item or entry can be added |
| Gallery link | Allows user to add an image from the gallery |
| | to an item or entry. |
| Remove link | To remove an item or entry from the top list |

### Saving a Top List Draft

A top list can be saved as a draft, so that a user can be able to continue or modify the top list in the next time they log back in.

### Top List Options Menu

Top Lists can be created, viewed, and managed using this menu. Options menu includes, e.g., the following tabs: Manage Top Lists; Create New List; and View Only Your List. This menu can be found on the right-side of the page.

### Manage Top List

In the disclosed embodiments a user can Create, View, Edit, and update top list and drafts using the ‘Manage Top List’ button under options menu. Top lists and drafts may also be deleted, published, or updated into a draft.

| | |
|---|---|
| Create a New List button | To create a new List |
| Publish | Allows user to publish a certain draft. |
| Draft | Allows user to turn an entry into a draft. |
| Delete | Allows user user to delete a top list, or a draft. |
| Update button | Click this button to commit the selected option. |
| View link | To view the entire top list or draft. |
| Edit | To edit the entire top list or draft. |

### View Only Your List

When this option menu is clicked, only the user's personal top lists and drafts will appear in the page. All other people's top lists will be excluded from the page.

### View All List

When this option menu is clicked, all the posts, including other people's top lists, will appear in the page.

### Thyme Calendar

Events such as: Birthdays, Memorials, Anniversaries, and etc., can be recorded and managed using a calendar function within the share level network. For instance, events on Thyme Calendar may be posted either in Vine or in the user's Personal Calendar.

A Family Calendar allows a user to browse the previous events or to browse the upcoming events. It is also easier to browse since the calendar can be viewed by year or month.

Searching through the Calendar

The Family Calendar can jump to and back to a certain year or month using this function, displaying the events in that specific period.

### Viewing the Full Calendar

Besides the Search feature in Thyme Calendar, a user can also manually browse the calendar by months, by clicking the previous and next button found atop the calendar. All events, death anniversaries, or birthdays within that month will be displayed (e.g., represented by violet, black, and red bars).

| | |
|---|---|
| View Full Calendar link | To view the full calendar |
| Go Back to Main Page | To Go back on Vine |
| link | |
| Year drop down list | To select a year you want to view |
| Violet bars | Dates with violet bars signifies an event |
| Red bars | Dates with red bars signifies a birthday |
| Black bars | Dates with black bars signifies a death anniversary |
| Highlighted Day | The highlighted date is the current date |

### Yearly View Calendar

All twelve months of a year can be viewed using Yearly View calendar, displaying twelve mini calendars (from January to December). This feature enables the user to have an overview of the events within a year.

### Adding an Event

An event is composed of a title, event details, start date, and end date. A User can freely customize the event details by changing the font style, alignment, adding an image, or adding a link. An event may also last for a period of time varying on the start and end date set by the user, and reoccur every year. An event message can also be sent to family members to notify them of the event. An event entry can only be shared to people or group within the share level. As disclosed, share level varies in the disclosed embodiments from Immediate; Very Close; Close; Fairly Close; Not so Close; all the way to Public. The entry may also be shared to a group if desired by the user. Events can be posted either on vine or personal calendar.

| | |
|---|---|
| Event title | An event must have a title |
| Event Details textbox | To input and customize the details of the event |
| Start Date | It is the starting date of the event |
| End Date | Its is the ending date of the event |
| ‘Recur every year’ | To make the event repeat yearly |
| ‘Send Event Message’ | To send Event message to family members to |
| | notify them of upcoming events |
| Post to Vine button | To post the event on Vine |
| ‘Post to Your Personal | To post the event only to your Personal Calendar |
| Calendar’ button | |

### Posting an Event to Vine

Calendar entries posted to vine will be displayed in Vine, wherein other people can also view it.

### Posting an Event to Your Personal Calendar

Calendar entries posted to personal will be displayed in personal calendar wherein other people cannot view it.

### Edit an Event

A user is enabled to update or delete their events either on vine or on personal calendar.

| | |
|---|---|
| Public Events | These are the user's personal events |
| Event Details | Datails of an event |
| Delete button | To delete an event |
| Update button | To Edit an event |

### Thyme Calendar Options Menu

Calendar events can be created, and viewed in the calendar using this menu. Options menu includes the ‘Create a Calendar Event’ and ‘View Full Calendar’. This options menu can be found on the right side of the page.

### Contact Thyme

In the Contact Thyme module a user is enabled to see contact information listings of all their family members in ThymeVine. They just click the name and then the page will automatically redirect to the family member's profile.

### VIEW PROFILE & EDIT INFO

A user can view and edit their information by clicking appropriate buttons (e.g., View Profile & Edit Info) and then it automatically redirects to a page where the user can edit their information or view their profile.

### YOUR CONTACT LIST

The user will see their family members' contact information/profile through this module by clicking an appropriate button (Your Contact List) and if they wish to see full details of a certain family member they just click the name, and then it automatically redirects to the page of that certain family member.

The user can choose a certain type of view defining how the names will appear on their page. (Full details & List—both are almost the same the only difference is on Full details picture is displayed).

### SEND A MESSAGE TO A FAMILY MEMBER

The user is enabled to send a message to a certain family member by clicking an appropriate button (Send Message), and then the user is automatically redirected to a page where they can type and send their message.

### SEARCHING FEATURE

There is a feature in this module when searching for a certain family member, you will not need to go over the list, you can search it by typing the name on the search bar and the system will automatically filter the list and show the result.

### Name Thyme

In this module, you can view your family member via personal family tree and other connections. Just click the name and then the page will automatically redirect to the family member's profile.

### ADD A NAME

You have an option if you like to add a name on the personal family tree, you would just click appropriate button (Add a name), it will automatically redirect to a page were you can update your personal family tree. You can sort name by choosing option on the dropdown list (First name, last name & Year of birth) and the system will automatically filter the list and show the result. You can choose a certain type of view on how will the names appear on your page (Full details & List—both are almost the same the only difference is on Full details picture is displayed).

### SEARCHING FEATURE

This module has also a searching feature which is the same as with CONTACT THYME, in searching for a certain family member, you will not need to go over the list, you can search it by typing the name on the search bar and the system will automatically filter the list and show the result.

### Thyme Capsule

In this module, you can create your own thyme capsule. As for the name thyme capsule is concern, it is like an online time capsule—Time capsule is a historic cache of goods or information, usually intended as a method of communication with future people. Time capsules are sometimes created and buried. Like in Thymevine, it allows user to do the same via thyme capsule.

### CREATE THYME CAPSULE

In creating thyme Capsule you will have to click appropriate button (Add a capsule entry), then it will automatically redirect to the page were you can input entry information regarding the thyme capsule you want to add. For instance, the following information may be entered into a thyme capsule:

This capsule is for (you or family members)

Delivery Date (Month, day & year)

Title

What memory would you like to share or message you like to save on your Thyme Capsule

You can also upload pictures or documents with the thyme capsule

UPDATE THYME CAPSULE

Thyme capsule entry can be updated, you will just have to click the thyme capsule name and click appropriate button (Update capsule post), then it will automatically redirect to the page were you can update the entry information regarding the thyme capsule you want to update.

### MANAGE THYME CAPSULE

Thyme capsules can be managed, you will just have to click appropriate button (Manage Thyme Capsules), then it will automatically redirect to the page were you can manage all your thyme capsule entries. You can update entries/change status according to the following: Publish; Draft; Delete; or Browse posts by others.

The user can also can also browse thyme capsule posts by others, you will just have to click appropriate button (Browse posts by others), then it will automatically redirect to the page were you can see thyme capsule posts by others.

### LEAVE A COMMENT ON A THYME CAPSULE POST

Users that have access to view your thyme capsule can leave a comment on it. You would just have to click appropriate button (Leave a comment), type a comment and then click the Submit button.

### They Said It

A “They Said It” feature of the disclosed share level networking in accordance with the principles of the present invention is enabled to capture those priceless statements made by children or adults.

| BUTTONS/ | |
|---|---|
| HYPERLINKS | FUNCTION |
| Create new they said | This button let's you create your new post. |
| it! Entry | |
| Add a scenario/ | Let's you enter the situation or description about |
| statement | your post. |
| Add a conversation | Enter the said conversation or discussion with the |
| | name of the person who said it. |
| Continue conversation | To add field. |
| (X)or close | To remove the added field on the conversation. |
| Choose file | Let's you browse your file on your desktop for |
| | uploading. |
| Share level | Let's you choose the publication of your post. |
| (i)or information | This will show the description of each level on |
| | Share level. |
| Group (checkbox) | User can also choose from his/her group to view |
| | the post. |
| Post | This button will publish your post according on |
| | chosen publication. |
| Save as draft | This button will save your post on pending |
| | projects and accessible if user wants to publish |
| | or update it. |
| View your they said it! | This will display all your created post on this |
| Entries | module. |
| Leave a comment | Let's you enter your comment on a specific post. |
| Submit | Post your comment. |
| (X) number of | View posted comments. |
| comment/s | |
| Browse post by others | This will show all entries in this module including |
| | yours. |
| View full post | Let's you view the entire post. |
| Manage they said it! | This button helps you to organize your posts by |
| Entries | updating, deleting and viewing. |
| Update (publish, draft, | Publish - it will post the entry. |
| delete) | Draft - saved on pending projects. |
| | Delete - remove your post. |
| View | LET'S YOU VIEW THE ENTIRE POST. |
| Edit | Let's you edit or update the information |
| | entered on the post. |
| Update they said it! | Let's you edit or update the information |
| Post | entered on the post. |

Creating They Said it! Entry

On home page click Application>They said it! The page will be redirected on the module page. Click Create they said entry! Or Add a new entry. It will redirect you to the page where you can create the post. Start filling out the fields. Required fields must be filled out. After filling out, click Post. The entry will now be posted on recent activity. Or click Save as draft, and the entry will be saved on pending projects.

Manage They Said it! Entries

To Publish a “They Said It!” entry, select an entry by marking the box (can be multiple). Select Publish on drop down list. Click Update, and the post will be changed to Publish status and visible on recent activity.

To leave as a Draft, select an entry by marking the box (can be multiple). Select Draft on drop down list. Click Update, and the post will be changed to Draft status and made accessible on pending projects.

To delete the “They Said It!” entry, select an entry by marking the box (you can mark multiple boxes/entries.) Select “Delete” on the drop down list. Click update. The post will be deleted.

To view the “They Said It!” entries, click “View” on an entry desired to view. The page will be redirected on the entire post.

To edit a “They Said It!” entry, click edit on the entry that is desired to be edited. The page will be redirected to an updated post.

### Scrapbooking

Create a unique scrapbook that captures your family's history.

| BUTTONS/ | |
|---|---|
| HYPERLINKS | FUNCTION |
| Create New Scrapbook | Let's you create your new entry. |
| Entry | |
| Next | Proceed on the next step on creating entry. |
| Cancel | Close procedure. |
| Back | Back from the previous step. |
| Start Scrapbook | Let's you start designing your entry. |
| Application Icons (On | Let's you choose an entry or pictures to place on |
| Top) | your Scrapbook page. |
| Modify Scrapbook | Update Scrapbook Information. |
| Information | |
| < > or Navigation | Let's you navigate on next and previous page. |
| page | |
| (+)or Add | Let's you add a page on your Scrapbook. |
| Page Break | Default(Theme Page) - Adds a page according on |
| | your current theme. |
| | Blank - Adds a blank page. |
| Other | Note - Adds a Stick note on your Scrapbook. |
| | Custom Text - Adds a Text on your Scrapbook. |
| Done | Finished procedure. |
| Change my current | Let's you choose to change your current theme. |
| theme | |
| Apply | Apply the changes made. |
| (x)or Delete Page | Remove page. |
| Share level | Let's you choose the publication of your entry. |
| (i)or information | This will show the description of each level on |
| | Share level. |
| View the list of | Display the family member which belongs on the |
| connections set to this | selected level. |
| post | |
| Group (checkbox) | User can also choose from his/her group to view |
| | the post. |
| Save | This button will publish your entry according on |
| | chosen publication. |
| View Scrapbooks | This will display all your created entries on this |
| | module. |
| Leave a comment | Let's you enter your comment on a specific entry. |
| Submit | Post your comment. |
| Manage Scrapbooks | This button helps you to organize your entries by |
| | updating, deleting and viewing. |
| Update (publish, draft, | Publish - it will post the entry. |
| delete) | Draft - saved on pending projects. |
| | Delete - remove your post. |
| View | Let's you view the entire entry. |
| Update Scrapbook | Let's you edit or update the information |
| Entry | entered on the entry. |

### Create New Scrapbook Entry

On home page click Application>Scrapbooking, and the page will be redirected on the module page. Click New Scrapbook Entry or Create New Scrapbook Entry. A pop up window will appear for scrapbook information. Fill out the fields then click Next. Required fields must be filled out. Choose a theme then click Next. A summary of your scrapbook will be displayed.

To start, click Start Scrapbook. Drag, drop, rotate and enlarge your entries on the page. Click Save. The entry will be posted on recent activity.

### Manage Scrapbooks

To PUBLISH a scrapbook, select an entry by marking the box (can be multiple). Select Publish on drop down list. Click Update. The entry will change to Publish status and be visible on recent activity.

To leave a scrapbook in DRAFT form, select an entry by marking the box (can be multiple). Select Draft on drop down list. Click Update. The entry will change to Draft status and become accessible on pending projects.

To DELETE a scrapbook, select an entry by marking the box (can be multiple). Select Delete on the drop down list. Click Update, and the entry will be deleted.

To VIEW a scrapbook, click View on an entry that is desired for viewing. The page will be redirected on the entire entry.

To EDIT a scrapbook, click Edit on an entry desired for editing. The page will be redirected on update entry. Note that EDIT is the same as Update Lesson Post under Options.

### View Scrapbooks

On the right side of the page under Options click Lesson Entries. The page will display all the posted entries by the user. Note: You can leave a comment on entries by clicking Leave a comment.

### Lesson Thyme

To pass on life's lessons, or to simply help a child do their homework remotely—or anything in between, the share level network includes a lesson Thyme feature.

| BUTTONS/ | |
|---|---|
| HYPERLINKS | FUNCTION |
| Start with this | Let's you create your entry according on the |
| | category you choose. |
| Add a lesson (radio | Let's you enter the lesson on your entry. |
| button) | |
| Ask for an answer | Let's you enter your question on your entry. |
| (radio button) | |
| Choose file | Let's you browse your file on your desktop for |
| | uploading. |
| Share level | Let's you choose the publication of your entry. |
| (i)or information | This will show the description of each level on |
| | Share level. |
| Group (checkbox) | User can also choose from his/her group to view |
| | the post. |
| Post | This button will publish your post according on |
| | chosen publication. |
| Save as draft | This button will save your entry on pending |
| | projects and accessible if user wants to publish or |
| | update it. |
| View your lesson entry | This will display all your created entries on this |
| | module. |
| Leave a comment | Let's you enter your comment on a specific entry. |
| Submit | Post your comment. |
| (X) number of | View posted comments on an entry. |
| comment/s | |
| Browse posts by others | This will show all entries on this module |
| | including yours. |
| Manage Lesson | This button helps you to organize your entries by |
| Entries | updating, deleting and viewing. |
| Update (publish, draft, | Publish - it will post the entry. |
| delete) | Draft - saved on pending projects. |
| | Delete - remove your post. |
| View | Let's you view the entire entry. |
| Edit | Let's you edit or update the information entered |
| | on the entry. |
| Update Lesson Post | Let's you edit or update the information |
| | entered on the entry. |
| Search | User can search for a specific entry. |

### CREATE NEW LESSON ENTRY

To create a new lesson entry, on home page click Application>Lesson Thyme. The page will be redirected on the module page. Choose a category then click start with this. It will redirect you to the page where you can start creating your entry. Start filling out the fields; Required fields must be filled out. After filling out, click Post. The entry will be posted on recent activity. Or click Save as draft. The entry will be saved on pending projects.

### Manage Lesson Entries

To PUBLISH a lesson entry, select an entry by marking the box (can be multiple). Select Publish on drop down list. Click Update. The entry will change to Publish status and visible on recent activity.

To leave a lesson entry as a DRAFT, select an entry by marking the box (can be multiple). Select Draft on drop down list. Click Update. The entry will change to Draft status and accessible on pending projects.

To DELETE a lesson entry, select an entry by marking the box (can be multiple). Select Delete on drop down list. Click Update. The entry will be deleted.

To VIEW a lesson entry, click View on a entry you desired to. The page will be redirected on the entire entry.

To EDIT a lesson entry, click Edit on a entry to be edited. The page will be redirected on update entry. Note: Edit is the same as Update Lesson Post under Options.

### View Lesson Entries

On the right side of the page under Options click Lesson Entries. The page will display all the posted entries by the user. Note: You can leave a comment on entries by clicking Leave a comment.

### Browse Post by Others

On the right side of the page under Options click Browse Post by Others. The page will display all entries that was posted by other family member. Note: Clicking View Full Post will take you to the entire entry.

### Search Lesson

On the right side of the page type the Title or Content of the entry that are you looking for. Then Click Search. The result will be displayed.

### Wish List

| BUTTONS/ | |
|---|---|
| HYPERLINKS | FUNCTION |
| Create new Wish List | This button lets you create your own wish list |
| Entry | that can be share to family member or to |
| | a group. |
| View Wish List (Under | Lets you viewall the wish list added. |
| “Options” pane) | |
| Manage Wish List(Under | Lets you manage your wish list wherein you |
| “Options” pane) | can create, view and update wish list. |
| Update Wish List(Under | Lets you update your wish list or make some |
| “Options” pane) | changes to it. |
| View only your wish | Lets you view only your own wish list. |
| list(Under “Options” | |
| pane) | |
| Edit (Button below the | Lets you make some changes to the list. |
| list) | |
| View the Complete List | Lets you view all list. |
| (Button below the list) | |
| Comment( )I Leave a | Lets you see number of comments and leave a |
| Comment (Button below | comment. |
| the list) | |
| Title | A wish list should have a title. It is a |
| | required field in creating a new list. |
| Wishlist Date | A wish list should have a wishlist date. It is a |
| | required field in creating a new list. |
| Add New List Entry | Lets you enter name of your list for your wish |
| | list, wherein you can add a link to a list. |
| Gallery | Lets you add an image from your gallery. |
| Remove | Lets you remove name of the list that you've |
| | added. |
| Share Level | Lets you select level of member, who can view |
| | your post |
| Post | Lets you publich your wish list. |
| Save as Draft | Lets you save the list as draft. |
| Publish (Update Option) | Lets you publish your selected wish list. |
| Draft (Update Option) | Lets you save as draft your selected wish list. |
| Delete(Update Option) | Lets you delete your selected wish list. |

### Creating a New Wish List

When creating a new Wish List click the Application icon>Wish List. Then click the “Create a new list entry” button. If there are existing wish lists you can click the “Add a wish list entry” button or “Create New List” under the Option pane to create a new wish list. Fill out the required field, then click “Post” button. Note: When creating a wish list, required fields like Title, Wish list date, List and level of family member should be filled out.

### Viewing Wish List

There are two options in viewing a wish list, you can view your own wish list or you can view all the wish lists added. When viewing a wish list, click the Application icon, Wish List. Then under the Option pane on the right side click “View Only Your List” or “View All List”.

### Managing a Wish List

To manage a Wish List, click the Application icon>Wish List. Under the Option pane on the right side click “Manage Wish List”. Tick the checkbox of the wish list you want to make some changes and select an option from the dropdown list if you want to Publish, Draft and Delete the selected list. Click “Update” button. NOTE: You can also view or edit you wish list by clicking the “View” or “Edit” on the right side of the title of your list.

### Updating a Wish List

“Update wish List” option was shown on the Option pane after a new added list. Click “Update wish List” under the Option pane on the right side. After the changes has been made click “Post” button.

### Quiet Thyme

| BUTTONS/ | |
|---|---|
| HYPERLINKS | FUNCTION |
| Letters | Lets you view list of letters you've created. |
| Funeral Plans | Lets you viewall the wish list added. |
| Obituary | Lets you manage your wish list wherein you |
| | can create, view and update wish list. |
| Last Will and Testament | Lets you update your wish list or make some |
| | changes to it. |
| Religious Verse | Lets you view the list of bible/Koran/Torah, |
| | etc. verse you've created |
| Post Bible/Koran/Torah, | Lets you post a religious verse and send it to |
| etc. verse/s | family member/s |
| Manage Posted | Lets you manage a religious verse that you've |
| Bible/Koran/Torah, etc. | posted wherein you can edit or delete the verse. |
| verse/s | |
| Create Letter for Loved | Lets you create a new letter and send it to |
| ones | family member/s. |
| View full post | Lets you view the whole content of the letter. |
| Manage Letter for Loved | Lets you manage your letter wherein you |
| ones | can view or delete the letter. |
| View | Lets you view the letter you've created. |
| Delete | Lets you delete the letter you've created. |
| Create a new Funeral | Lets you create a funeral plan and send it to |
| Plan | family member/s. |
| Edit Funeral Plan | Lets you edit your funeral plan and make some |
| | changes. |
| Create a new Obituary | Lets you create obituary and send it to family |
| | member/s. |
| Edit Obituary | Lets you edit obituary and make some changes. |
| Create Last Will and | Lets you create your Last Will and Testament. |
| Testament | |
| Download | Lets you download the file or image attached. |

### Posting a New Religious Verse

To post a new religious verse: click the Application icon>Quiet Thyme. Hover the mouse to “Religious Verses” (or similar). On the upper right side of the page, then click “Post Religious Verse/s” (or similar). Fill out the following required field, e.g.: To (Family member that you want to see your post); Verse; Content. Then click “Send Now” button. A message will display that the verse has been successfully updated. NOTE: You can click the “Save as Draft” button to save the verse. A message will display that the verse has been successfully saved.

### Managing Posted Religious Verses

To manage a posted religious verse, click the Application icon>Quiet Thyme. Hover the mouse to “Religious Verses” on the upper right side of the page. Click “Manage Posted Religious Verse/s”. A list of suggested verses will be displayed with two options, which are the Edit and Delete button.

### Editing a Posted Religious Verse

To edit a posted religious verse, click the Application icon>Quiet Thyme. Hover the mouse to “Religious Verses” on the upper right side of the page. Click “Manage Posted Religious Verse/s”. A list of suggested verses will be displayed with two options, which are the Edit and Delete button. Click the Edit button; you can able to make some changes to its headline, content and change the list of member whom you want to send the verse. Click “Send Now” button to send the verse or click “Save as draft” button to save the changes you've made to the verse. A message will display that the verse has been successfully updated.

### Deleting a Posted Verse

To DELETE a posted religious (or otherwise) verse, click the Application icon>Quiet Thyme. Hover the mouse to “Religious Verses” on the upper right side of the page. Click “Manage Posted Religious Verse/s”. A list of verses will be displayed with two options, Edit and Delete button. Click the Delete button. A dialog box will appear. Click “OK” button to delete the verse. A message will display that the verse has been successfully deleted.

### Creating Letters for Loved Ones

To create a new letter, click the Application icon>Quiet Thyme. Hover the mouse to “Letters to Loved Ones” on the upper right side of the page. Click “Create Letters for Loved Ones”. Fill up the following required fields: To (Family member that you want to receive your letter); Subject; Message; Choose file (optional). Then click the “Send” button. A message will display that the letter has been sent successfully. NOTE: You can click the “Save as Draft” button to save the letter.

### Managing Letters for Loved Ones

To MANAGE letters for loved ones, click the Application icon>Quiet Thyme. “Letters to Loved Ones” on the upper right side of the page. Click “Create Letters for Loved Ones”. A list of letters will be displayed with two options, View and Delete button.

### Viewing a Letter

To VIEW a letter, click the Application icon>Quiet Thyme. “Letters to Loved Ones” on the upper right side of the page. Click “Create Letters for Loved Ones”. List of letter will be displayed with two options View and Delete button. Click View button, all messages you've sent to the receiver of the message will be displayed.

### Deleting a Letter

To DELETE a letter, click the Application icon>Quiet Thyme. “Letters to Loved Ones” on the upper right side of the page. Click “Create Letters for Loved Ones”. List of letter will be displayed with two options, View and Delete button. Click View button, all messages you've sent to the receiver of the message will be displayed. Click the Delete button. A dialog box will appear, click “OK” button to delete the verse. A message will display that the letter has been successfully deleted.

### Creating Funeral Plan

To create a funeral plan, click the Application icon>Quiet Thyme. Hover the mouse to “Plan your Funeral” on the upper right side of the page. Click “Create Funeral Plan”. Fill out the required field: To (Family member that you want to receive your letter). Then click the “Send” button. A message will display that the letter has been sent successfully. NOTE: You can click the “Save as Draft” button to save the funeral plan.

### Editing Funeral Plan

To EDIT a funeral plan, click the Application icon>Quiet Thyme. Hover the mouse to “Plan Your Funeral” on the upper right side of the page. Click “Edit Funeral Plan”. The user is enabled to make changes to their funeral plan, change the list of member(s) who they want to send the plan to, etc. Click “Send Now” button to send the funeral plan or click “Save as draft” button to save the changes you've made to the funeral plan. A message will then display that the funeral entry has been successfully updated.

### Creating Obituary

To create an obituary, click the Application icon>Quiet Thyme. Hover the mouse to “Obituary” on the upper right side of the page. Click “Create Obituary”. Fill out the required fields: To (Family member that you want to receive your letter); Headline; News; and Choose file (optional). Then click the “Send” button. A message will display that the obituary entry has been successfully updated. NOTE: You can click the “Save as Draft” button to save the Obituary.

### Editing Obituary

To edit an obituary, click the Application icon>Quiet Thyme. Hover the mouse to “Obituary” on the upper right side of the page. Click “Edit Obituary”. The user is enabled to make changes to their obituary, change the list of member(s) who they want to send the obituary to, etc. Click “Send Now” button to send the obituary, or click “Save as draft” button to save the changes you've made to the obituary. A message will display that the obituary entry has been successfully updated.

### Creating Last Will & Testament

To create a Last Will & Testament, click the Application icon>Quiet Thyme. Hover the mouse to “Last Will & Testament” on the upper right side of the page. Click “Create Last Will & Testament”. Fill out the required fields: To (Family member that you want to receive your letter); Content; Choose file(s) (optional). Then click the “Send” button. A message will display that the Will entry has been successfully updated. NOTE: You can click the “Save as Draft” button to save the Last Will & Testament.

### Editing Last Will & Testament

To EDIT their Last Will & Testament, click the Application icon>Quiet Thyme. Hover the mouse to “Last Will & Testament” on the upper right side of the page. Click “Create Last Will & Testament”. A user is enabled to make some changes to their last will & testament, e.g., changing the list of member(s) who they want to send the Will to, etc. Click “Send Now” button to send the obituary or click “Save as draft” button to save the changes you've made to the obituary. A message will display that the Will entry has been successfully updated.

### Their Thyme

| BUTTONS/ | |
|---|---|
| HYPERLINKS | FUNCTION |
| View Memorials you | Lets you view the memorials added |
| added | |
| Add New Memorial | Lets you add a new memorial |
| Post | Lets you publish the memorial you've created |
| Save as Draft | Lets you save as draft the memorial you've |
| | created |
| Choose File | Lets you choose a file when creating a memorial |
| Dedicate e-Flowers | Lets you dedicate a flower for the deceased |
| | person. |
| Light a Candle | Lets you light a candle for the deceased person. |
| View Gallery | Lets you view the images of the deceased person |
| Update Memorial | Lets you make some changes on the memorial |
| Post | you've posted. |
| Manage Memorial | Lets you manage the images from the memorial |
| Album | post wherein you can delete multiple images. |
| Memorial Theme | Lets you select a memorial theme. |
| Statistics | It gives an update on how many flowers and |
| | candles that had been offered to the deceased |
| | person. |
| Recent page activity | Lets you view the recent activities. |
| Share this Memorial | Lets you share the link of the posted memorial to |
| Link | the member of the family. |
| Write a Tribute | Lets you write a tribute for the deceased person. |
| Submit a photo | Lets you submit a photo for the deceased person. |
| View full page | Lets you download the file or image attached. |
| Edit Information | Lets you make some changes on the memorail |
| | you've posted. |
| Leave a Testimonial | Lets you post a testimonial for a deceased person. |
| Manage Memorials | Lets you manage memorial you've posted where |
| | in you can view and edit the memorial posted and |
| | manage the images. |
| Publish (Update | Lets you publish your selected memorial. |
| Option) | |
| Draft (Update Option) | Lets you save as draft your selected memorial. |
| Delete(Update Option) | Lets you delete your selected memorial. |

### Adding a New Memorial

To create a new memorial, click the Application icon>Their Thyme. Click “Add New Memorial” from the Option pane. Fill out the following field: Name (Select Relative who's already deceased). Note: the user can populate the list above by adding the deceased person on Name Thyme. Possible information includes date of passing, resting place location, theme, something about the person, something they once said, a short biography of the person, choose file (optional), etc. Then click “Post” to publish the memorial added, or click “Save as draft” to save the memorial created.

### Adding a Deceased Person on Name Thyme

To add a deceased person on Name Thyme, click the Application icon>Their Thyme. Click “Add New Memorial” on the Option pane. Click “Click Here” link to add a person on name thyme. Fill out the following field: Family Name, Country, Street Address, City, State, Zip. Then click “Save” button to save the name. A message will display that it is successfully updated.

### Managing Memorials Added

To MANAGE added memorials, click the Application icon>Their Thyme. Click “Manage Memorials” on the Option pane. List of memorials will be displayed with three options, View, Edit and Photo button. You can also Publish, Save as draft and delete the memorial.

### Deleting a Memorial

To DELETE a new memorial, click the Application icon>Their Thyme. Click “Manage Memorials” on the Option pane. List of memorials will be displayed. Select “Delete” from the dropdown list and click the “Update” button. A message will display that the memorial was successfully deleted.

### Editing Memorial Information

To edit memorial information, click the Application icon>Their Thyme. List of memorials will be displayed. Click “Edit Information” on the Option pane below the Statistic. After the changes made. Click “Post” to post the memorial or “Save as Draft” button to save the changes made.

### Sharing Memorial Link

To share a memorial link, click the Application icon>Their Thyme. Click “View Full Page” of the memorial. Click “Email” button on the “Share this memorial link” pane. A dialog box will appear. Select family member or enter an email address, click “Send” button. A message will display that the memorial has been successfully shared.

### TAKE ME TO:

### My Image Gallery (My Gallery):

To create a new album, click the “Create a new album” button. Fill out all the required fields indicated with an asterisk “*”.

Enter “Album Title” (*), noting that special characters are allowed, and that the same title on the user album is allowed.

Select “Image Type” (*) should be chosen from the three options. “Select” would be selected by default so that it would force the user to select one. For instance, Photo Image—file type such as jpg, jpeg, png, gif; Document Image—file type such as pdf, doc, docx, ppt, xls, xlsx, txt; or Photo and Document image—file type such as jpg, jpeg, gif, png, pdf, doc, docx, ppt, xls, xlsx, txt.

A description is optional.

A share level (*) in accordance with the principles of the present invention should be chosen from the options. “Immediate” may be selected by default. Immediate relates to nuclear/Immediate Family Members & those closest to you. Other share level articulated positions include very close—(1^{st} Degree of Closeness); Close—(2^{nd} Degree of Closeness); Fairly close—(3rd Degree of Closeness); Not so close—(4^{th} Degree of Closeness); and Public—anyone in the thyme vine network including non-paying accounts.

Another field to be filled in is groups, which may be, e.g., relatives, etc. When the fields have been completed, the “Create Album” button should be selected.

To ADD photos/images to the album, click “Add Photos/Images to the album” button. Select a Gallery album, and upload Images. Note: as many as, e.g., 10 images at a time may be uploaded. The size of the images may be limited if desired, e.g., to 2 Mb per image. Alternatively, if storage space in the network is a concern, the size of uploaded images may be compressed to be of no more than a maximum size (e.g., 2 Mb). The uploaded images may additionally or alternatively be converted to a desirable format within the shared network. Click “Upload Photos” button. Note: the user can also edit their album by “Edit” button.

### Edit/Update Album

To Edit/update album, click the album then click “Edit” button to proceed on updating album. Fill out all the required fields indicated with an asterisk “*”. Enter “Album Title” (*), noting that special characters are allowed, and that the same title on the user album may be allowed. Select “Image Type” (*) should be chosen from the three options. “Select” will be selected by default so that it would force the user to select one, e.g., Photo Image—file type such as jpg, jpeg, png, gif; Document Image—file type such as pdf, doc, docx, ppt, xls, xlsx, txt; Photo and Document image—file type such as jpg, jpeg, gif, png, pdf, doc, docx, ppt, xls, xlsx, txt. (Alternatively, the shared network may sense a compatible file format for upload thereby eliminating or automating the need for the user to select a file type. Description may be optional. Share Level (*) should be chosen from the options. “Immediate” will be selected by default. Immediate—nuclear/Immediate Family Members & those closest to you. Very close—(1^{st} Degree of Closeness). Close—(2^{nd} Degree of Closeness). Fairly close—(3^{rd} Degree of Closeness). Not so close—(4^{th} Degree of Closeness). Public—anyone in the thyme vine network including non-paying accounts. Groups—relatives and groups. Click “Update Album” button.

To go back to gallery home, click “Back to Gallery Home” under Option.

To delete album, check the album then click “Delete” button below. Note: multiple albums may be deleted by ticking the box.

The album may be viewed by “Image type”, e.g., all; by photo Image—file type such as jpg, jpeg, png, gif; by document Image—file type such as pdf, doc, docx, ppt, xls, xlsx, txt; or by photo and document image—file type such as jpg, jpeg, gif, png, pdf, doc, docx, ppt, xls, xlsx, txt.

### My Profile>Profile Info

Personal Information. Fill out all the required fields indicated with an asterisk “*”: Enter First Name (*); Middle name (optional); Enter Last Name (*); Name Extension (optional); Nickname (optional); Date of Birth field entered in the following format: (Format: Month/Day/Year)(*); Gender (*) should be chosen from the two options. The option “Please select” will be selected by default. Address (including street address (optional); city optional; country (*); and Zip code (optional), though if user lives in the United States entry of their State may be required.) Contact information can include phone number and/or mobile number. To upload documents, click “Browse” button (optional). To delete documents, click on the appropriate check box to delete. Multiple documents may be deleted by ticking the appropriate box(es). When the form is completed, click the “Save” button.

### My Groups>Create a New Group

Enter group name then click “Create” button. Ideally special characters are not allowed (e.g. “!”, “@”, “,”, “ ”, “:”), and group name should be unique and not existing. Groups may also be edited, e.g., a group name, after which the “Save” button is clicked. The group members may also be edited, and groups/group member(s) may be deleted by clicking the appropriate trash icon or similar. Sort by: should be chosen from the two options. The option “Select Members” will be selected by default.

### All—All Family Members

Share level—The Option “Select” will be selected by default, e.g., Immediate—nuclear/Immediate Family Members & those closest to you; Very close—(1^{st} Degree of Closeness); Close—(2^{nd} Degree of Closeness); Fairly close—(3^{rd} Degree of Closeness); or Not so close—(4^{th} Degree of Closeness).

### My Messages

A user can send a message by clicking a “Send a message” button. To: (select receiver) (ideally Last name and First Name only). A subject may be entered, and/or a message may be entered. Preferably a file(s) can also be attached by selection of an “Attach a file” button. When the composed message is complete, it may be sent by clicking an appropriate “Send” button.

An inbox of messages may be viewed, with provision to mark all inbox messages. Marked messages may be marked as “Read” by clicking a “Read” button; or “Unread” by clicking an “Unread” button. A message may be viewed by clicking a “View Message” button; deleted by clicking a “Delete” button to delete the viewed message. Sent messages may be viewed by clicking a “Sent” button. Deleted messages may also be viewed, as can be trashed messages. A “Restore” button may be implemented to return the selected message(s). A “Delete permanently” button may be implemented to remove the selected message(s) (or all messages in a given category) permanently from the trash.

### FAMILY CALENDAR

A “Show” button may be implemented to show an appropriate calendar panel; and a “Hide” button may be implemented to hide the calendar panel. A “View Full Calendar” button enables viewing of the full calendar.

The viewed Family Calendar may be sorted, e.g., by year (e.g., 4 digit year); by month (January to December). When done selecting year and month, click the “Search” button.

Months in the Family Calendar may also be viewed with a “Next Month” button; a “Previous Month” button, and a “Today” button to view the current date.

An event may be added to the Family Calendar by clicking an appropriate “Add Event” button. To add an event, all required fields indicated with an asterisk “*” are filled out: Event (*); Event Details (*); Font name; Font size; text color; bold; Italic; Underline; numbered list; bulleted list; decrease indent; increase indent; text alignment: align left/center/align right; link/unlink; image; maximize; start date (*)—current date default; and end date (*)—current date is the default.) Note: the entry should be rejected if the start date is later than the end date. Optionally the event may be entered as recurring each year. An event message may be sent. Share Level (*) should be chosen from the options, with “Immediate” being selected by default. For instance, the share level may be set as immediate; very close; close; fairly close, not so close; or public.

A “Post to Vine” button will be post on the user's vine. The “Post to your personal calendar” button will be posted only on the user's Family Calendar.

To go back to the main page, click “Go Back to Main page” button to return on the Thyme Vine main page.

Click “Yearly View Calendar” button to view yearly events.

### PENDING PROJECTS

In this module, the user will see all of their unpublished posts or posts that are saved as drafts. Pending Projects is found on “My Thyme” above Recent Activities. The user will see the complete list of their pending projects by: clicking an arrow facing downwards; or hide the list by clicking the arrow facing upwards.

### UPDATE POST

The user can edit posts on the list just by clicking an appropriate button: To change the name or title of the post—click to update and the user interface will automatically redirect to the page were they can update their post and publish it on their ThymeVine.

### RECENT ACTIVITIES

In this module, the user will see the list of all the recent activities they made on their ThymeVine. Recent Activities is found on “My Thyme” below Pending Projects. By default the title or name of a post is the only detail displayed on the list. Content may be viewed by clicking an appropriate button (Expand), or be hidden or revert back to a default setting just by clicking appropriate button (Hide).

### VIEW POST IN FULL DETAILS

The user can view full details of a certain post just by clicking the appropriate button (View post), and the user interface will automatically redirect to the page where they can view it in full details.

### LEAVE A COMMENT ON POST

The user can leave a comment on a certain post under Recent Activities by clicking the appropriate button to type a comment, type the comment, and then click a Submit button.

### VIEW MORE POSTS

To view more of the activities posted on a user's ThymeVine: click the appropriate button to view more posts, and the user interface page automatically redirects to a page where they view all of the posts on their ThymeVine.

### Family Thyme

This is where a user may manage their family tree, privacy settings, and connection to family members. They may view and manage their family members and the persons they are connected to, by share levels. They may also see all of their pending and sent requests, or may connect to a member in this section.

### Search By

This search filter makes it easier to find a family member or a person that a user is connected with. Rather than going through all the list of names, they may just simply enter the first name or last name of a family member into the text box, and click a “Go” button. A list of all names that matched with the keyword will be displayed. Preferably a user may only search their family members and persons that they are connected with.

| | |
|---|---|
| ‘Search By’ textbox | To search a family member or a person, input the |
| | first name or last name on the ‘Seatch By’ text box. |
| Go button | Click this button to view the sorted results. |

### Relationships

Access to a user's vine may vary depending on the share level set by the user. Family member's share level can vary from, e.g., Immediate; very close; close; fairly close; and not so close. A user may change a family member's share level from time to time by going to: Family Thyme, then to relationships. To use this function, select the name(s) of the family member(s), then choose a share level from the drop down list, then click the edit button. A pop-up message will then appear, notifying that the changes have been successfully made.

| | |
|---|---|
| List of connections | These are the names of your family members or |
| | connections. To select a family member you wish |
| | to modify, tick the check box beside the name. |
| ‘Share level’ | A family member's share level may be changed |
| dropdown list | into immediate, very close, close, fairly close, or |
| | not so close. |
| Edit button | Click this button to commit the changes made. |

### Family Thyme Options Menu

Connected members, Vine, Sent requests, and Pending Invitations can be viewed using this menu. This is also where a Personal Family Tree can be built, wherein you can add, edit, or delete family members to your family tree. User may also view connections by Share level, and also to connect to a member. This option menu includes the following tabs and can be found on the right-side of the page: Personal Family Tree Builder; View connected members; View by Share level; View My Vine; View Sent requests; View Pending Invitations; and Connect to a member.

### View Connected Members

A user may view a list of their Personal Family Tree members, and other connections by clicking this option. The list of names found under the ‘Personal Family Tree’ table are the names of the persons that have been connected to their family tree, or the ones that the users have added to their family tree.

On the other hand, the list of names found under ‘Other connections’ table are the names of the persons they are connected to. A user may also delete a connection in this feature.

### Deleting a Connection

A user can delete a connection from a member, or permanently delete a member from connections. To delete a connection from a member: click ‘View connected members’ tab, and then click the ‘x’ button beside the name of the member they wish to delete.

### View by Share Level

A user may view family members, and connections according to their Share level: immediate; very close; close; fairly close; and not so close. Members are displayed by groups according to Share level, wherein a user may also edit their Share level by clicking ‘Edit Level’.

### Manage Relationship Level

The Share level of a member can be changed using this feature. To manage relationship levels: go to Family Thyme, click the ‘View by Share Level’ tab, and click ‘Edit Level’.

### View My Vine

This is where a user may search with options, and view the posts posted by Personal Family members. There is also the ‘Family Group & Sort Options’ to easily sort the posts made by a Personal Family member which can be sorted by: share level; by Members per Modules; Members or Modules; or by Year.

### Search Options

This makes it easier to search for a specific post by simply inputting the poster name, post content, or title. A user may easily find a post made days, weeks, or years ago by using this feature.

| | |
|---|---|
| Search options textbox | This is where the user inputs the poster name, |
| | post content, or title to search. |
| Search button | Click this button to show the results for search |
| | options |

### Filter Options

This option is another feature under Search Options, wherein a user may filter post results by Name, or by App (All Modules, Journal Thyme, Top Lists, Wish Lists, Their Thyme, Calendar Entry, or Gallery).

| | |
|---|---|
| Show filter options | To expand the filter options: Filter by Name, and |
| | Filter by App |
| Filter by Name | To filter the results by name |
| Filter by App | To filter the results by app: by All Modules, Journal |
| | Thyme, Top Lists, Wish Lists, Their Thyme, |
| | Calendar Entry, or Gallery. |

### View Sent Request

This is where a user can view pending requests, and previously accepted invitations. All pending requests are logged in this list, as wells as the accepted invitations. The user has an option to resend a pending request, or to cancel the request. Logs of accepted invitations can also be removed by the user.

### Resending a Pending Request

A pending request can be resent to a member. To resend a pending request: click the request that you wish to resend; select the options ‘resend’; and click the ‘update’ button.

### Canceling a Pending Request

A pending request to a member can be cancelled. To cancel a pending request: click the request that you wish to cancel; select the options ‘cancel’: and click the ‘update’ button.

### Removing Accepted Invitations

All accepted invitations are logged so that the user can keep track of recent activities. The user also has an option to remove an accepted invitation. To delete an accepted invitation: click the accepted invitation that you wish to remove; select the options ‘remove’: and click the ‘update’ button.

| | |
|---|---|
| ‘Pending Request’ List | These are the list of requests that are pending to |
| | be confirmed. |
| ‘Accepted Invitations’ | These are the list of invitations accepted recently |
| List | and previously. |
| Options | A Pending Request has an option to be resend or |
| | cancelled, while accepted invitations can be |
| | removed. |
| Update button | To commit the action made. |

### FAMILY THYME

| | |
|---|---|
| View Pending | Lets you view pending request from a user who |
| Invitations | wants to invite you as family member. |
| Notification of | Notifications can be view on messages, shows |
| Pending Invitations | you number of family invite request. |
| List of Invitations | A table that display list of names that send you a |
| | family request. |
| Relationship Status | Lets you select the relationship with the sender. |
| Share Level | Lets you select the level of closeness to the |
| | sender. |
| Accept button | A button that lets you approve family invitation |
| | request. |
| Decline button | A button that lets you reject family invitation |
| | request |
| Connect to member | Lets you send an invitation request to a member. |
| Required fields | When adding a member fields should not leave as |
| | blank, like personal information and vine |
| | information or choosing the relationship status. |
| Submit button | A button that lets you send the request. |

### Viewing Pending Invitations

Pending Invitations can be view in three ways. First, a notification is sent and can be viewed in messages. Second, a number of pending requests are automatically shown on the first page of Family Thyme. Third, in Family Thyme, a “View Pending Invitation” link on the option pane may be clicked to list family invite request(s).

### Accepting Family Invite Request

To accept a family invite request, click pending invitations to display a table showing a list of all requests. Click “View” on the right side of the Name. The name of the sender will be shown, as well as how the user is related to the sender. A relationship status and level of closeness is selected, and the “Accept” button is clicked to display a message that the user is successfully connected.

### Sending Family Invitation

Connecting to a member starts with sending a family invite request. Go to Family Thyme>Connect to Member. Fill out the following fields: First Name; Last Name; Email Address; and Relationship Status. Then choose a level of closeness, and click the “Submit” button. A message will be displayed that you have successfully sent the invitation.

### My Vine

| | |
|---|---|
| Search Option | Lets you search for poster name, post |
| | content or title. |
| Search button | A button that lets you search your entered |
| | keyword. |
| Filter Options | Displayed results can be filtered by Name |
| | and Application. |
| Familt Group & Sort Option | Lets you sort family group in different |
| | options. |
| Choose Family Option | Lets you select a family to displayed on |
| | family tree, it can be your personal family |
| | or family that you've added. |
| Share level | Lets you sort by level of closeness |
| Sort Option | There is three options in sorting, these are: |
| | Members per Modules, Member or |
| | Modules. |
| Year | A button that lets you reject family |
| | invitation request |
| Set Button | A button that lets you sort your selected |
| | options |

### Searching a Poster Name, Post Content or Title

Search options lets a user search for poster name, post content or title. Displayed results can be filtered. To search, go to My Vine, type a keyword and click the “Search” button. Results will be displayed.

### Filtering Displayed Result

Results can be filtered by Name and Application. When results are displayed, click the “Show Filter Option”. If a user wants the results to be filtered by name only, a name of a member is entered, and the “Search” button is clicked. If a user wants the results to be filtered by application only, select an application: Journal thyme; Top List; Wish List; Their Thyme; Calendar Entry and Gallery. Click the “Search” button.

### Family Group and Search Options

It's a sort engine, wherein you have the options to sort family group by the following: Year; Choose a Family (Personal family or family that you've added); Share Level (Level of closeness); or Sort by Member per Modules, Member or Modules. (If Member is set, a family tree will be displayed showing the name of the members and their posts. If Modules is set, a number of posts in a specific application will be displayed. If Member per Modules is set, the name of the member and how many posts they have in a specific application is displayed.) Then click the “Set” button.

### Get Image Function

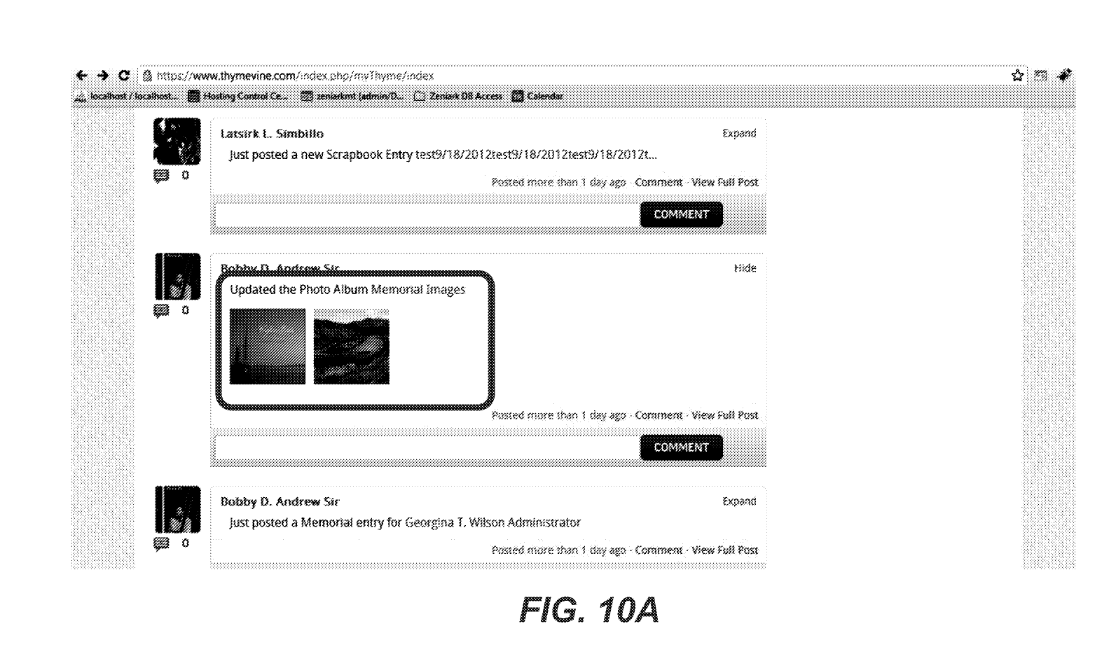

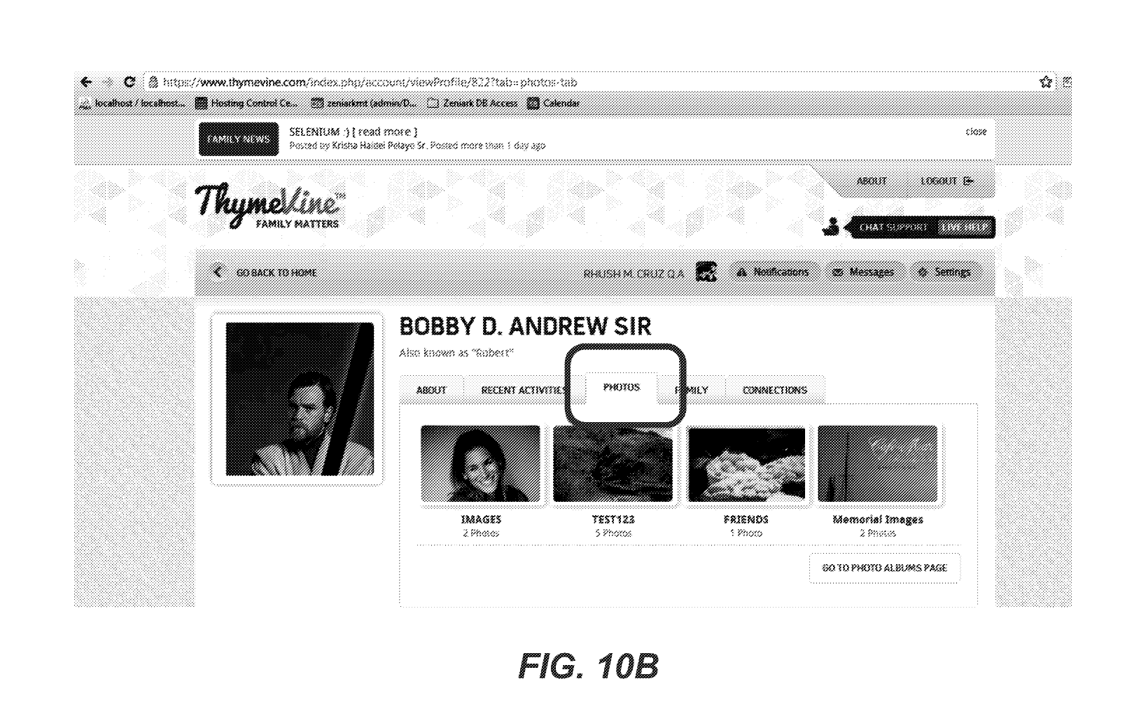

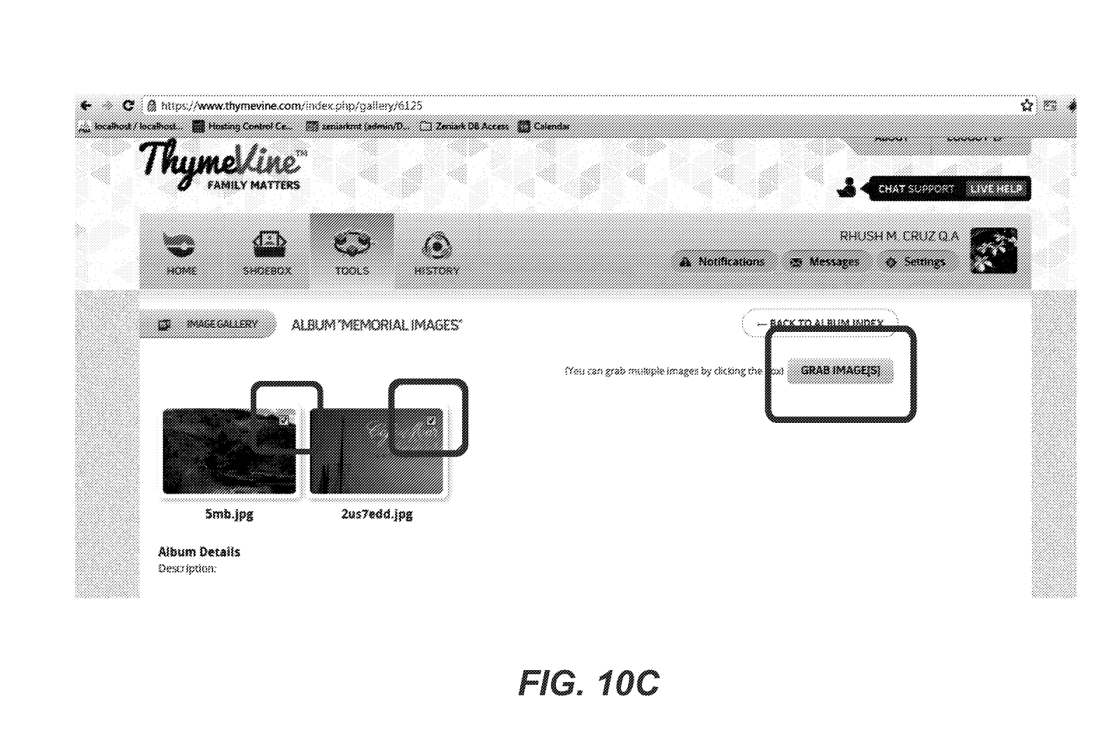

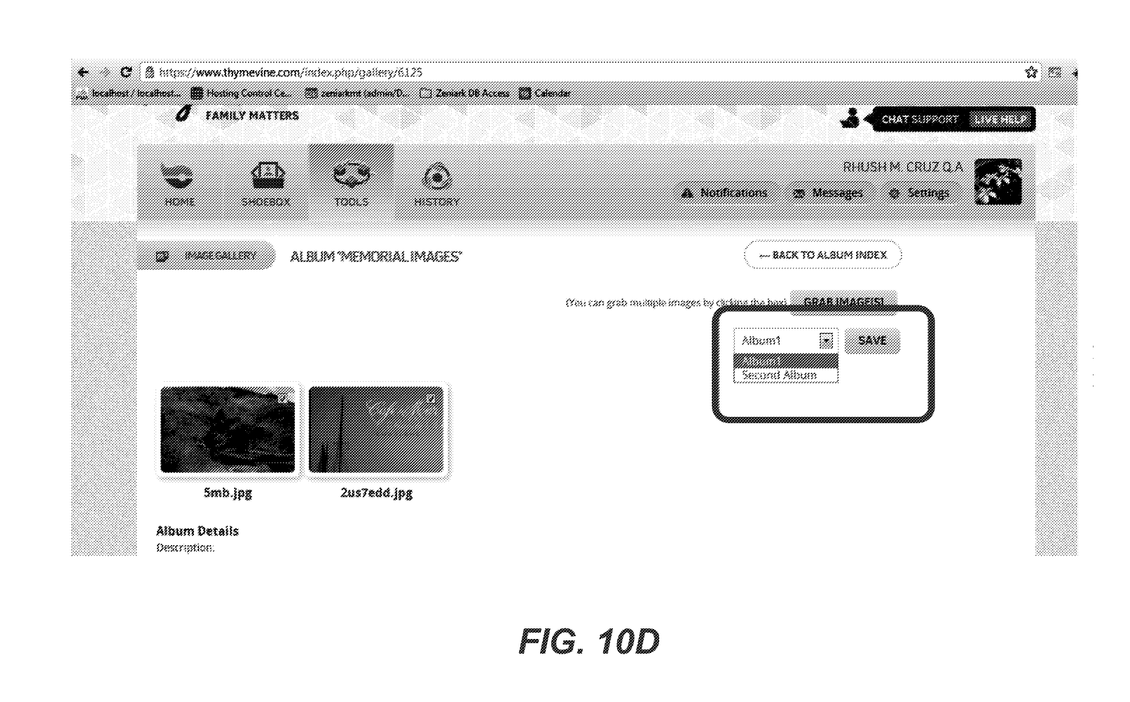

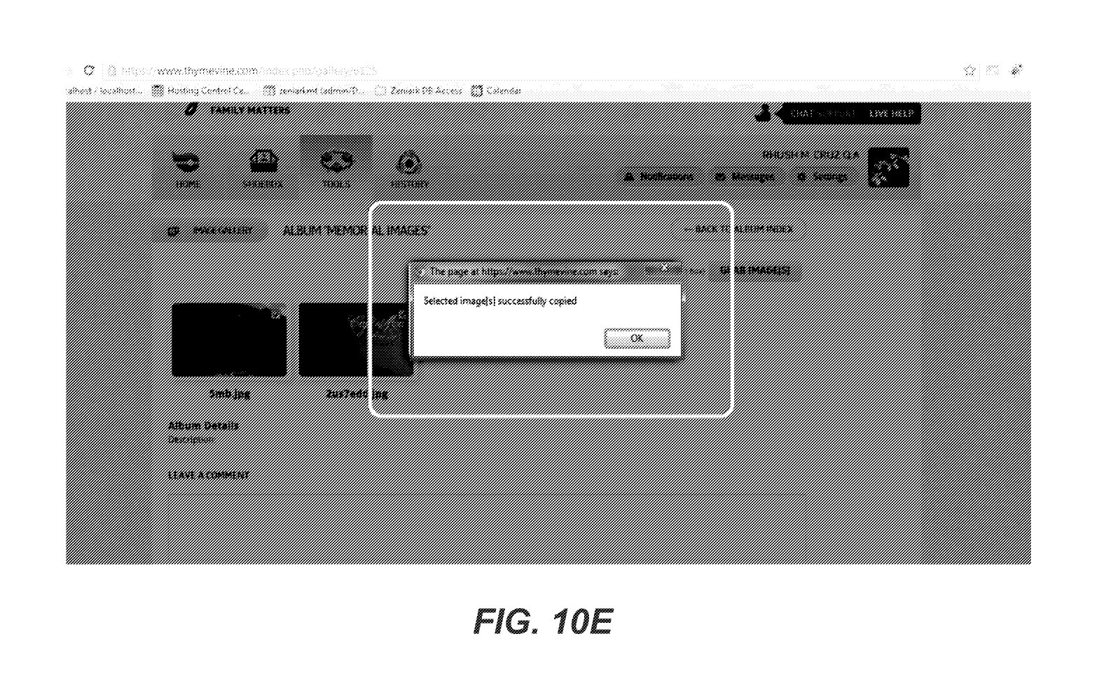

FIGS. 10A to 10E show an exemplary user interface for a GetImage feature, in accordance with the principles of the present invention.

In particular, a Get Image (Grab Image) function in accordance with the principles of the present invention enables a user's device to grab an image or images from a photo gallery or album associated with a connected member. The user can ‘grab’ images from the photo gallery or album associated with the connected member, e.g., from the connected member's wireless device such as a Smartphone, etc., if it is shown on the home page, or go directIt to the profile of the connected member.

As shown in FIG. 10A, it the desired image or images (or other type file) is shown on the home page via thumbnail or other descriptive icon, the name of the album may be clicked.

In FIG. 10B, the user can go directly to the profile of the connected member. They do this by clicking the cursor on a “Photos” or similar tab, then the photo albums of the connected member will be displayed to the transferring user. They then click on the name of the desired album that the user is ‘getting’.

In FIG. 10C, the user is redirected to the photo album. The user selects the checkbox of the images that they want to grab or put into their own gallery. The user's device then has its cursor click a “Grab Image(s)” or similar button.

In FIG. 10D, upon clicking the “Grab Image(s)” or similar button, a list of existing albums of the user where they want to save the image(s) is displayed.

In FIG. 10E, a message is displayed indicating if the image(s) were successfully copied. The user selects an “OK” button to clear the message window.

Below explains how an image or images are “grabbed” from a user's Connected Family member's Gallery.

### Homepage>go to Settings>View all Connections

Click and Chose the profile Name of connected member with an existing ThymeVine Account.

From Member's Profile navigation tab, choose and click “Gallery” tab, existing album(s) of connected member will be displayed.

Chose and Click from any of the existing album of your Connected Family Member(s), Photos added on the selected album will be displayed.

Tick the checkbox of the image(s) you want to grab, or to copy on your Gallery.

Click the “Grab Image[s]” button. after clicking the “Grab Image[s]” button, it will display the list of existing album of the connected member. Preferably multiple images may be grabbed on the current page by selecting a suitable box. Checked images from the first and second page preferably can't be grabbed at the same time. Images are preferably only grabbed one page at a time, because once a user devices moves to the next displayed page, images that were marked will be removed.

Select an album, and click “Save” button. If a user device just selects from an existing album and clicks a suitable save button, a message confirming that the image(s) was successfully copied will be displayed.

Click “Ok” button.

Go to Gallery page to View the album of the images being grabbed.

There is also an option to “add a new album” for the image(s).

Select the “Add New Album” from the dropdown list of existing album(s).

Click “Save” button, User will be redirected to “Create New album page”.

Fill in the required fields.

Assign “Share Setting”. Importantly images or other files can be grabbed only from those who have Share permissions set to the user's device, and vice versa. In this important way the Grab It function is primarily related to Share Level.

Click on “Share” button to share it with the connected member's who are included from the Share Level assigned.

Posted Activity can now be viewed on “Recent Activities” on Homepage.

There is a quick way that a user can grab images from other connected members.

### Homepage>Recent Activities

From the posted entry (e.g posted entry from Gallery) shown on the home page's Recent Activity, choose and click the name of the album. The user will then be redirected to the album's Image(s).

Tick the checkbox of the image(s) you want to grab, or to copy on your Gallery.

Click the “Grab Image[s]” button.

After clicking the “Grab Image[s]” button, it will display the list of existing album of the connected member. You can grab multiple images on the current page by clicking the box. Checked images from the first and second page can't be grabbed at the same time. Images can only be grabbed one page at a time, because once the user goes to the next page, images that have been marked will be removed.

Select an album, and click “Save” button. If a user just selected from an existing album and clicked save, a message confirming that the image(s) was successfully copied will be displayed.

Click “Ok” button.

Go to Gallery page to View the album of the images being grabbed.

There is also an option to “add a new album” for the image(s).

Select the “Add New Album” from the dropdown list of existing album(s).

Click “Save” button, User will be redirected to “Create New album page”.

Fill in the required fields.

Assign “Share Setting”.

Click on “Share” button to share it with the connected member's who are included from the Share Level assigned.

Posted Activity can now be viewed on “Recent Activities” on Homepage. If a user created a new album and it was successfully created, it will redirect to the album, and will display the grabbed images.

Below are various use case scenarios for a ThymeVine share level network in accordance with the principles of the present invention.

### 1.) Use Case Name: Share Level Access

### Actors:

1. Account User (Has an existing account. Can set the Level of Access for a connected member)
2. Another user (Access to other user's details/post is limited. Access/Share level may vary from immediate, Very close, Close, Fairly Close, Not so Close, and to public)
3. System/ThymeVine (Set limits to the connected member's access of the account user's details/vine)

### Trigger:

Account user wants to post a Journal entry.

### Precondition:

User has Finished the journal entry

### Post-conditions:

The entry will be placed in the system/list of journal entries

The account user can view the journal entry

The account user may choose the Share level of the entry

### Normal Flow:

1. Account user will Log in, then go to Applications>Journal Thyme.
2. The System will present some categories and sub topics for each category.
3. Account user will select a category and a subtopic to write about.
4. The System will present a form for the journal entry.
5. Account user will fill in the required fields in the form.
6. Account user will set the Share level access of the journal entry.
7. The System will get the Share level of the journal entry.
8. Account user will click the publish button.
9. Other user will try to display the journal entry
10. The System will compare the share level access of the user with the share level of the journal entry.
11. The System will display the journal entry to user if share level matched.

### Alternative Flow:

7A1. If account user wants to modify the Share level access of the journal entry, to keep the journal entry as private as possible.
1. User will determine that journal entries can be edited
2. User will determine which share level access he will change the journal entry into.
3. User will go to Manage Journal entries
4. System will display the list of journal entries
5. User will choose the entry, and commit the action edit
6. System will display the inputted details of the entry
7. User will modify the share level access, from lowest share level access, to the highest share level access
8. System will save the changes made and modify the share level access of the entry
11A1: If the other user's share level access did not match with the Share level access of the journal entry, then the other user can not view the entry.
1. The other user's share level access should be changed to match the share level access required for the journal entry.
2. Account user will determine that he can modify other user's share level access to his details
3. Account user will determine which share level access will alow the other user to access the journal entry
4. Account user will go to Family Thyme
5. The system will display the connected user to account user
6. Account user will select a user, and the new share level.
7. System will save the changes and modify the share level access of the user.
8. The other user will try to display the journal entry again.
9. The System will compare the share level access—matched!
10. The other user can display the journal entry.

### 2.) Use Case Name: Share Level Access—Wish List

### Actors:

1. Account User (Has an existing account. Can create wish list and select share level access.)
2. Another user (User that is connected to account user. Can view post from a connected member based on the different share level: Immediate, Very close, Close, Fairly Close, Not so Close, and to public)
3. System/ThymeVine (Processes posts and limits the access of the connected member.)

### Trigger:

Account user wants to share or post the wish list created.

### Precondition:

Account User has added the list to be post and selected level access on sharing.

### Post-conditions:

The wish list created will be placed in the system.

The account user will have a displayed list of created entries.

The account user may edit the Share level of the entry.

### Normal Flow:

1. Account user will Log in, then go to Applications>Wish List.
2. The System will present options for the wish list.
3. Account user will create a new wish list entry.
4. The System will present a form for the wish list entry.
5. Account user will fill in the required fields of the form.
6. Account user will add list of wish.
7. Account user will set the Share level access of the entry.
8. Account user will click the publish button.
9. The System will get the Share level of the entry.
10. The System will compare the level of sharing based on the selected level from the list.
11. The System will post the created wish list to the other user if share level access matched.
12. Other user will view the posted wish list.
13. The System will display list the created wish list to the account user with different options.
14. The account user will view and verify the wish list and its access share level.
15. The account user will go back to the main page of Wish List.

### Alternative Flow:

7A1. The account user can modify the created entry. This alternative flow also applies if the user want to change the share level access of the entry.
1. User will verify the list created.
2. User will edit the form.
3. User will change the share level access.
4. User will click the publish button.
5. System will save the changes made by the user.
6. The use case returns to step9 and continues.

### 3.) Use Case Name: Share Level Access—Their Thyme

### Actors:

Account User (Has an existing account. Can create add memorial plan and select share level access.)

Another user (User that is connected to account user. Can view memorial added from a connected member based on the different share level: Immediate, Very close, Close, Fairly Close, Not so Close, and to public)

System/ThymeVine (Processes added memorial plans and limits the access of a connected member.)

### Trigger:

Account user wants to create a memorial plan.

### Precondition:

Account User has added the list to be post and selected level access on sharing.

### Post-conditions:

The memorial plan added will be placed in the system.

The account user can view the memorial plan added.

The account user may edit memorial plan and the Share level of the entry.

### Normal Flow:

1. Account user will Log in, then go to Applications>Their Thyme.
2. The System will present options for the Their Thyme.
3. Account user will add a new memorial plan.
4. The System will present a form for the memorial plan.
5. Account user will fill in the required and optional fields of the form.
6. Account user will add an image for the entry.
7. Account user will set the Share level access of the entry.
8. Account user will click the Post button.
9. The System will get the Access Share level of the entry.
10. The System will compare the level of sharing based on the selected level from the memorial plan.
11. The System will post the added memorial plan to the other user if share level access matched.
12. Other user will view the posted memorial plan.
13. The System will display list of created memorial plan to the account user with different options (Dedicate e-Flowers, View Gallery, Submit a Photo, Light a Candle, Leave a Testimonial and Edit Information).
14. The account user will view and verify information of the memorial plan and its access share level.
15. The account user will go back to the main page of Their Thyme.

### Alternative Flow:

A1. The account user can modify the added memorial plan. This alternative flow also applies if the user want to change the share level access of the memorial plan.
1. User will view the full page of the memorial plan.
2. User will verify the memorial plan added.
3. User will edit the form and other information about the memorial.
4. User will change the share level access.
5. User will click the Post button.
6. System will save the changes made by the user.
7. The use case returns to step2 and continues.

### 4.) Use Case Name: Share Level Access—My Vine: Sort Options

### Actors:

1. Account User (Has an existing account. Can use the sort engine and sort by access share level.)
2. Sort Option (Arrange family group based on the selected options from the account user)
3. System/ThymeVine (Processes the options selected and displays the result.)

### Trigger:

Account user wants to sort the family group.

### Precondition:

Account User has selected the options to be sort.

### Post-conditions:

The selected options will be process and sort.

The account user can view the result.

The account user may select another options and sort it again.

### Normal Flow:

1. Account user will Log in, then go to My Vine.
2. The System will present Seacrh Option and Sort Option interface.
3. Search Option was set to All Share level access by default and a family tree graph.
4. Search Option will present a list of dropdown options.
5. Account user will select from the dropdown list (Choose Family, Sort by, Year).
6. Account user will set the Share level access of the entry.
7. Account user will click the Set button.
8. The System will get the selected options from the dropdown list.
9. The System will get the set share level.
10. The System will present a family tree if it is sort by member or a list of activities in an application if it is sort by module.
11. The System will present a result based on selected level of sharing of the user.
12. The Account user will view the displayed result from the Search Option.

### Alternative Flow:

6A1. The account user can change the set access share level. Account user can view different post based on selected options and the set access share level.
1. User will determined the different access share level.
2. User will select from the share level dropdown list.
3. The use cases returns to step 7 and continues

### 5.) Use Case Name: Share Level Access-Lesson Thyme

### Brief Description

This Use Case describes how the Share level of an entry connects with the Share level of Family member.

### Actors:

### 1. Account User

2. Family member (connected to Account user)
3. ThymeVine users (not connected to Account user)

### 4. System (ThymeVine)

### Preconditions:

Account user should create an entry.

Account user should publish his/her entry.

### Basic Flow of Events:

1. The use case begins when the Account user starts to create an entry.
2. The Account user will go to Applications>Lesson Thyme>Create new Lesson Thyme Entry.
3. The System will show a categories to choose with.
4. The Account User will choose a category and click write about this.
5. The System will show the form for lesson thyme.
6. The Account user will fill the fields and set the share level.
7. The Account user will click Post.
8. The System will post the entry on Recent Activities.
9. Family Member can view the posted entry as long as the set share level entry fit in with the set family member share level.
10. ThymeVine users cannot view the entry as long as the share level is not set as Public.

### 11. End of Use Case.

### Alternative Flows

If the Account user missed a required field on the form.

1. The System will prompt an error message.
2. The use case resumes at Step 6.

If the account user wants to post the entry with a selected member only.

1. The Account user should select Group on the share level of an entry.
2. The System will show the field for selecting a family member or group.
3. The Account user will select a family member or an entire group.
4. The use case resumes at Step 6.

### Special Requirements

The System must post the entry on Recent Activities.

Unauthorized family members cannot view the posted entry.

### Preconditions

The user must have a ThymeVine account.

The user must log in.

### Post Conditions

Successfully created an entry.

### 6.) Use Case Name: Share Level Access-they Said it

### Brief Description

This Use Case describes how the Share level of an entry connects with the Share level of Family member.

### Actors

Account User

Family member (connected to Account user)

ThymeVine users (not connected to Account user)

System (ThymeVine)

### Preconditions

Account user should create an entry.

Account user should publish his/her entry.

### Basic Flow of Events

1. The use case begins when the Account user starts to create an entry.
2. The Account user will go to Applications>They Said it!>Create new They Said it! Entry.
3. The System will show the form for the They Said it! Entry.
4. The Account user will fill the fields and set the share level of the entry.
5. The Account user will click the Post button.
6. The System will post the entry on Recent Activities.
7. Family Member can view the posted entry as long as the set share level entry fit in with the set family member share level.
8. ThymeVine users cannot view the entry as long as the share level is not set as Public.

### 9. End of Use Case.

### Alternative Flows

If the Account user missed a required field on the form.
1. The System will prompt an error message.
2. The use case resumes at Step 4.

If the Account user did not publish the entry and save it as draft.
1. The Account user will modify the entry on Pending projects.
2. The use case resumes at Step 5.

If the account user wants to post the entry with a selected member only.
1. The Account user should select Group on the share level of an entry.
2. The System will show the field for selecting a family member or group.
3. The Account user will select a family member or an entire group.
4. The use case resumes at Step 5.

### Special Requirements

The System must post the entry on Recent Activities.

Unauthorized family members cannot view the posted entry.

### Preconditions

The user must have a ThymeVine account.

The user must log in.

### Post Conditions

Successfully created an entry.

### 7.) Use Case Name: Share Level Access-Scrapbooking

### Brief Description

This Use Case describes how the Share level of an entry connects with the Share level of Family member.

### Actors

Account User

Family member (connected to Account user)

ThymeVine users

System (ThymeVine)

### Preconditions

Account user should create an entry.

Account user should publish his/her entry.

### Basic Flow of Events

1. The use case begins when the Account user starts to create an entry.
2. The Account user will go to Applications>Scrapbooking>Create new Scrapbook Entry.
3. The System will show the form for the Scrapbook Entry.
4. The Account user will enter the Title, Scrapbook date and Description.
5. The Account user will click Next.
6. The System will proceed on next step which is theme selection.
7. The Account user will choose his/her desired theme for the scrapbook.
8. The Account user will click Next.
9. The System will show the summary made by Account user.
10. The Account User will click Start Scrapbook.
11. The Account User will begin to design his/her scrapbook and set the share level.
12. The Account User will click Save.
13. The System will post the entry on Recent Activities.
14. Family Member can view the posted entry as long as the set share level entry fit in with the set family member share level.
15. ThymeVine users cannot view the entry as long as the share level is not set as Public.

### 16. End of Use Case.

### Alternative Flows

If the Account user missed a required field on the form.
1. The System will prompt an error message.
2. The use case resumes at Step 4.

If the account user wants to post the entry with a selected member only.
1. The Account user should select Group on the share level of an entry.
2. The System will show the field for selecting a family member or group.
3. The Account user will select a family member or an entire group.
4. The use case resumes at Step 11.

If the account user cancel the procedure.
1. The use case ends with a failure condition.

### Special Requirements

The System must post the entry on Recent Activities.

Unauthorized family members cannot view the posted entry.

### Preconditions

The user must have a ThymeVine account.

The user must log in.

### Post Conditions

Successfully created an entry.

### 8.) Use Case Name: Share Level Access—Contact Thyme (Account User And Family Members Only) Actors:

1. Account User (Has an existing account. Access to other user's contact/profile information if family member.)
2. Other users (Access to your contact/profile information—if family member.)
3. System/ThymeVine (Set limits to a user's access of contact information.)

### Triggers:

1. Account user wants to view other user's contact/profile information.
2. Other user wants to view other account user's contact/profile information.

### Precondition:

Users needs to be connected firts—same family.

### Post-conditions:

1. The account user can view other user's contact/profile information—if set as family member/connected with each other.
2. The contact/profile information of other user will be accessible to account user—if set as family member/connected with each other.

### Normal Flow:

1. Account user will Log in, then go to Applications>Contact Thyme.
2. The System will display account user's overview of contact information.
3. Account user will select VIEW PROFILE button to view his contact/profile information in full details.
4. Account user will select EDIT PROFILE button to update his contact/profile information.
5. Account user will select CONTACT LIST link button to view the list of other user's contact/profile information—if family member/connected with each other.
6. Account user will click a certain family member's name to view his contact/profile information.

### Alternative Flow:

If account user wants to view other user's contact/profile information but not on his list of family member.
1. Account user will connect to other user/add as his family member.

### 9.) Use Case Name: Share Level Access—Name Thyme (Account User Only)

### Actors:

1. Account User (Has an existing account. Access to family members' name on name thyme.)
2. Other users (Family members' name added by account user on name thyme—with or without Thymevine account.)
3. System/ThymeVine (Save account user's family members name on name thyme.)

### Trigger:

Account user wants to add name on his name thyme.

### Precondition:

User has added name on his name thyme.

### Post-conditions:

The entry will be saved on the system/list of family members' names on Name Thyme.

The account user can view the name thyme entry.

### Normal Flow:

1. Account user will Log in, then go to Applications>Name Thyme.
2. The System will display the list of family member's name.
3. Account user will add name on his name thyme, click ADD NAME.
4. The System will display a form that will allow account user to manage his personal family tree.
5. Account user will add name, click ADD RELATIVE.
6. The System will display a form for name/relative entry.
7. Account user will fill in the required fields in the form.
8. Account user will click the SUBMIT button.

### 10.) Use Case Name: Share Level Access—Thyme Capsule (Account User And Family Members Selected by Account User for Each Thyme Capsule Entry)

### Actors:

1. Account User (Has an existing account. Can set the Level of Access for a connected member.)
2. Other users (Access to other user's thyme capsule. Access/Share level may vary from account user's settings upon creating thyme capsule—YOU or account user can select on the list of his family members/groups.)
3. System/ThymeVine (Set limits provided by account user.)

### Trigger:

Account user wants to create a thyme capsule entry.

### Precondition:

User has Finished the thyme capsule entry.

### Post-conditions:

1. The entry will be placed in the system/list of thyme capsule entries.
2. The account user can view the journal entry.
3. The account user may choose the Share level of the entry.

### Normal Flow:

1. Account user will Log in, then go to Applications>Thyme capsule.
2. The System will display account user's list of thyme capsule entries.
3. Account user will select CREATE NEW CAPSULE ENTRY button.
4. The System will display a form for the thyme capsule entry.
5. Account user will fill in the required fields in the form.
6. Account user will set the Share level access of the thyme capsule entry/account user will choose among his family members or groups who the thyme capsule is for.
7. Account user will click the POST button.
8. The System will display the thyme capsule entry to other users set/selected by account user.

### Alternative Flow:

If account user wants to modify the Share level access of the thyme capsule entry.
1. Account user will determine that thyme capsule entries can be edited.
2. Account user will go to MANAGE CAPSULE ENTRIES.
3. System will display the list of thyme capsule entries.
4. Account user will choose the entry, and commit the action EDIT.
5. System will display the inputted details of the entry.
6. Account user will modify the share level access from what is desired.
7. System will save the changes made and modify the share level access of the thyme capsule entry.
11.) Use Case Name-Personal Family Tree Builder-Link an account/connect an account.

### Actors:

1. ThymeVine User (Has an existing account. Valid Credit Card/can add personal family tree to connect)
2. Guest Account (Has an existing account. Invalid ThymeVine Subscription/No Valid Credit card, access to the thymevine user's details/for viewing purposes only)
3. ThymeVine system (sets limits for 30 Free day Trial/Valid Credit card, No Valid Credit card/viewing only)

### Trigger:

ThymeVine User wants to add personal family tree to connect.

### Precondition:

ThymeVine User done adding personal family tree to connect.

### Post-conditions:

1. The added family member will be placed in the thymevine system/personal family tree.
2. The ThymeVine User can view the profile of the added member.
3. The ThymeVine User can update the member information of the added member.
4. Thy ThymeVine User can invite the added member to ThymeVine.
5. The ThymeVine User can create ThymeVine Account of the added member.
6. The ThymeVine User can post content (proxy) of the added member.
7. The ThymeVine User can administrate posts of the added member.

### Normal Flow:

1. ThymeVine User will Log in, then go to Family Admin Options>Personal Family Tree.
2. The ThymeVine System will show the personal family tree.
3. ThymeVine User will set family tree for selected member.
4. The ThymeVine System will show the personal family tree added members.
5. ThymeVine User will link/connect to the added members account.
6. ThymeVine User will click the “Connect” button.
7. The ThymeVine System will link/connect the account to the added members and ThymeVine user.

### Alternative Flow:

8A1. If ThymeVine User wants to link/connect an account to the added members in a different way.
1. ThymeVine User will go to Family Thyme>Options: Personal Family Tree.
2. ThymeVine User will Log in, then go to Family Admin Options>Personal Family Tree.
3. The ThymeVine System will show the personal family tree.
4. ThymeVine User will set family tree for selected member.
5. The ThymeVine System will show the personal family tree added members.
6. ThymeVine User will link/connect to the added members account.
7. ThymeVine User will click the “Connect” button.
8. The ThymeVine System will link/connect the account to the added members and ThymeVine user.

### 12.) Use Case Name: Share Level Access-Edit Family News

### Actors:

1. ThymeVine User1 (Has an existing account. Can set share level access for connected member)
2. ThymeVine User2 (Has an existing account. Can access family news/depends on share level from all family members, and selected relatives)
3. ThymeVine System (set limits to the family news who can access)

### Trigger:

ThymeVine user1 wants to post a family news.

### Precondition:

ThymeVine User1 done posting family news.

### Post-condition:

1. The family news will be placed on the system/list of family news ticker.
2. The ThymeVine User1 can view the posted family news.
3. The ThymeVine User1 can update and choose the share level access of posted family news.
4. The ThymeVine User1 can delete the posted family news.

### Normal Flow:

1. ThymeVine User1 will Log in, then go to Family Admin Options>Edit Family News.
2. ThymeVine User1 will fill out all the required fields(*) to news about.
3. ThymeVine User1 will select who can access the news.
4. The ThymeVine System will get the access level/who can view the news.
5. ThymeVine User1 will click “Create” button.
6. ThymeVine User2 will try to view the news.
7. The ThymeVine System will matching up the share level access with thymevine user.
8. The ThymeVine System will display the news to thymevine user if share level is matched.

### Alternative Flow:

9A1. If ThymeVine User2 share level access did not match with share level access of the news, then the ThymeVine User2 cannot view the entry.
1. The ThymeVine User1 must changed the level of the ThymeVine User2 to view the news.
2. The ThymeVine User1 will go to Family Thyme to set share level of ThymeVine User2.
3. The ThymeVine User1 will click “View share level” button.
4. The ThymeVine System will redirects to the manage relationship level.
5. The ThymeVine User1 will edit the level of ThymeVine User2.
6. The ThymeVine System accepts the changes of relationship level.
7A1. If ThymeVine User1 wants to change the share level access of the family news, to keep the news as confidential.
1. ThymeVine User1 will update the news.
2. ThymeVine User1 will go to Manage Family Ticker.
3. ThymeVine User1 will click “Update” button.
4. The ThymeVine System will redirects to the page to update the news.
5. The ThymeVine User1 will change the share level access.
6. The ThymeVine User1 will click “Save” button.
7. The ThymeVine System will save the updated share level access of the news.
8A1. If ThymeVine User1 wants to delete the news, so no one can view the news.
1. User will delete the news.
2. User will go to Manage Family Ticker.
3. User will click “Delete” button.
4. ThymeVine System will delete the news.

### 13.) Use Case Name: Share Level Access-Image Gallery

### Actors:

1. ThymeVine User1 (Has an existing account. Can set share level access for connected member)
2. ThymeVine User2 (Has an existing account. Can access depends on share level from Immediate, Very close, Close, Fairly close, Not so close, Public, and Groups)
3. ThymeVine System (set limits to the album who can access)

### Trigger:

ThymeVine user wants to create a new album and select share level who can view the album.

### Precondition:

ThymeVine User done creating a new album.

### Post-condition:

1. The album will be placed on the system/My Gallery.
2. The ThymeVine User can view the album.
3. The ThymeVine User can add photos or Images.
4. The ThymeVine User can edit and choose the share level access of album.
5. The ThymeVine User can delete the album.

### Normal Flow:

1. ThymeVine User will Log in, then go to Take me to . . . >My Image Gallery.
2. ThymeVine User will click “Create a New album” button.
3. ThymeVine User will fill out all the required fields(*) to create album.
4. ThymeVine User will select who can access the album.
5. The ThymeVine System will get the access level/who can view the album.
6. ThymeVine User will click “Create Album” button.
7. ThymeVine User2 will try to view the album.
8. The ThymeVine System will matching up the share level access with thymevine user.
9. The ThymeVine System will display the album to thymevine user if share level is matched.

### Alternative Flow:

10A1. If ThymeVine User2 share level access did not match with share level access of the album, then the ThymeVine User2 cannot view the entry.
1. ThymeVine User1 must changed the level of the ThymeVine User2 to view the album.
2. The ThymeVine User1 will go to Family Thyme to set share level of ThymeVine User2.
3. The ThymeVine User1 will click “View share level” button.
4. The ThymeVine System will redirects to the manage relationship level.
5. The ThymeVine User1 will edit the level of ThymeVine User2.
6. The ThymeVine System accepts the changes of relationship level.
7A1. If ThymeVine User wants to change the share level access of the album, to keep the album as confidential.
1. ThymeVine User will edit the album.
2. ThymeVine User will click the album.
3. ThymeVine User will click “Edit” button.
4. The ThymeVine System will redirects to the page to update album.
5. The ThymeVine User will change the share level access.
6. The ThymeVine will click “Update Album” button.
7. The ThymeVine System will save the updated share level access of album.
8A1. If ThymeVine User wants to delete the album, so no one can view the album.
1. ThymeVine User will delete the album.
2. ThymeVine User will go to My Gallery.
3. ThymeVine will check the album, and click “Delete” button.
4. ThymeVine System will delete the album.

### 14.) Use Case Name: Share Level Access-My Groups

### Actors:

1. ThymeVine User1 (Has an existing account. Can create groups)
2. ThymeVine User2 (Has an existing account. Can access group post)
3. ThymeVine System (set limits to the groups)

### Trigger:

ThymeVine user1 wants to create groups.

### Precondition:

ThymeVine User1 done creating groups

### Post-conditions:

1. The Group will be added on the system/list of Groups.
2. The ThymeVine User1 can view the group members.
3. The ThymeVine User1 can edit group name.
4. The ThymeVine User1 can delete group/group member.

### Normal Flow:

1. ThymeVine User1 will Log in, then go to Take me to . . . >My Groups.
2. The ThymeVine System will redirects when creating groups.
3. The ThymeVine User1 will enter Group name and click “Create” button.
4. The ThymeVine User will drag the member to the group.
5. The ThymeVine System will add the member to the group.

### Alternative Flow:

6A1. If ThymeVine User2 share level access did not match with the group selected, then the ThymeVine User2 cannot view the post.
1. The ThymeVine User1 must add the ThymeVine User2 to the group.
2. The ThymeVine User1 will drag the member to the group.
3. The ThymeVine System will add the member to the group.
4A1. If ThymeVine User1 wants to delete the groups/group member, so the group cannot view the post.
1. ThymeVine User1 will delete the group/members group.
2. ThymeVine will click “Delete” button.
3. ThymeVine System will delete the groups.

FIGS. 10A to 10E show a grab images, or grab it, feature of shared networking, in accordance with the principles of the present invention.

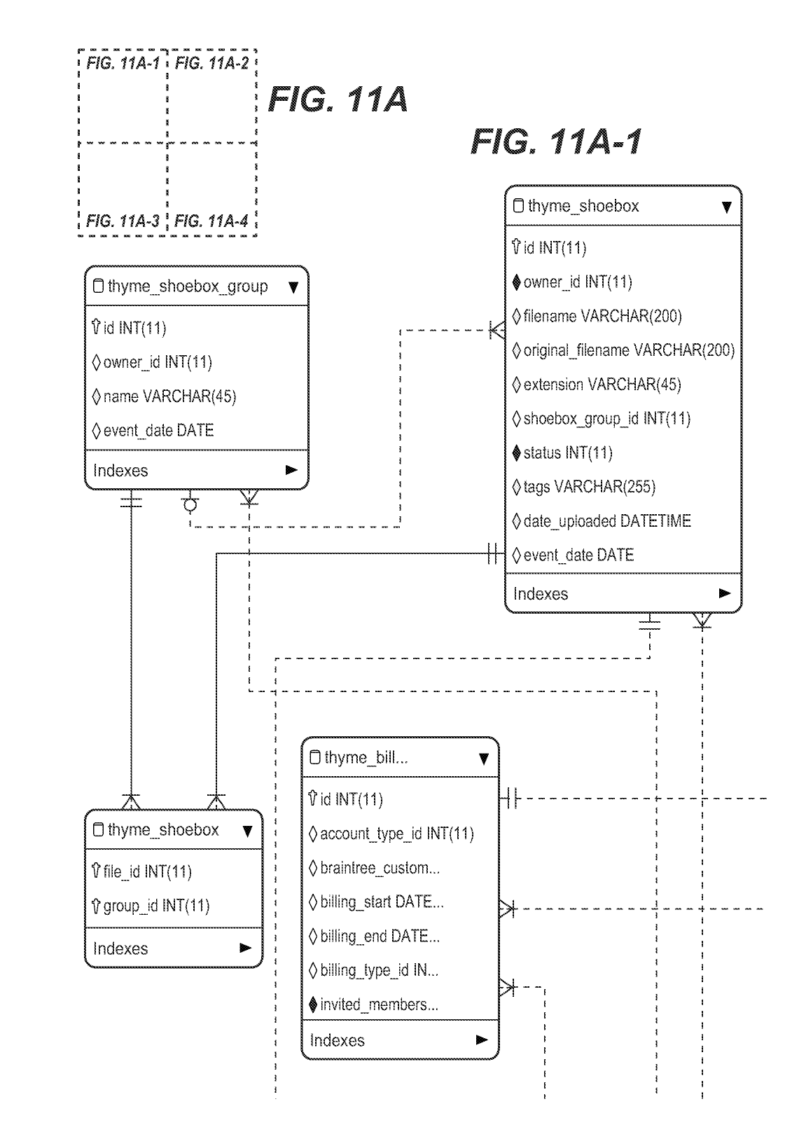

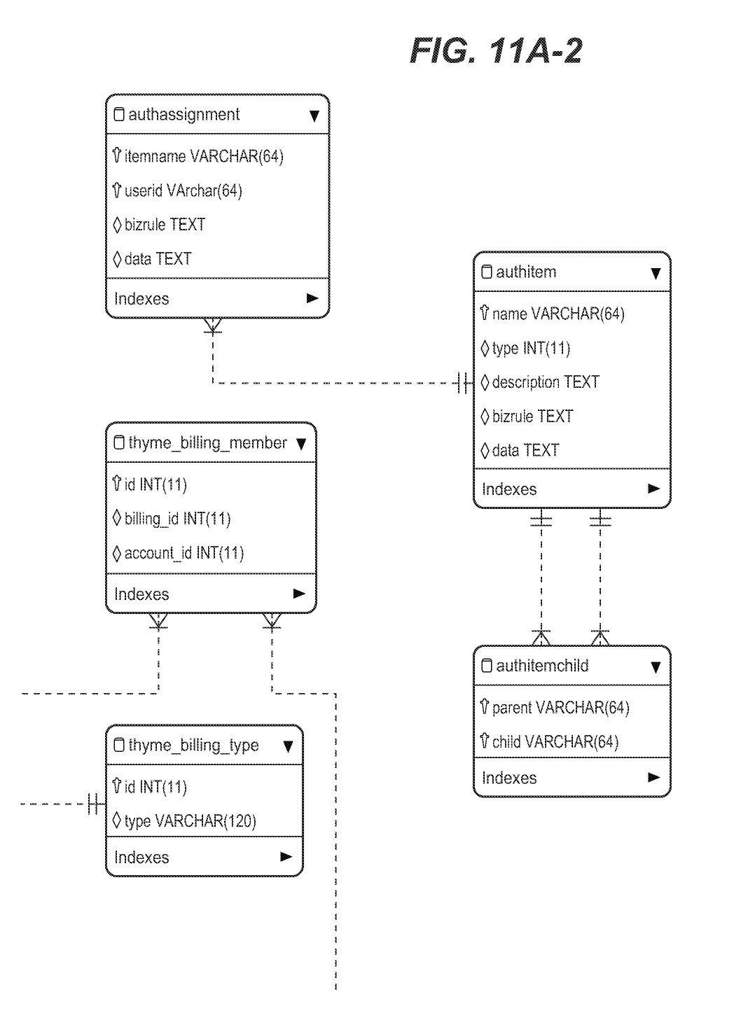

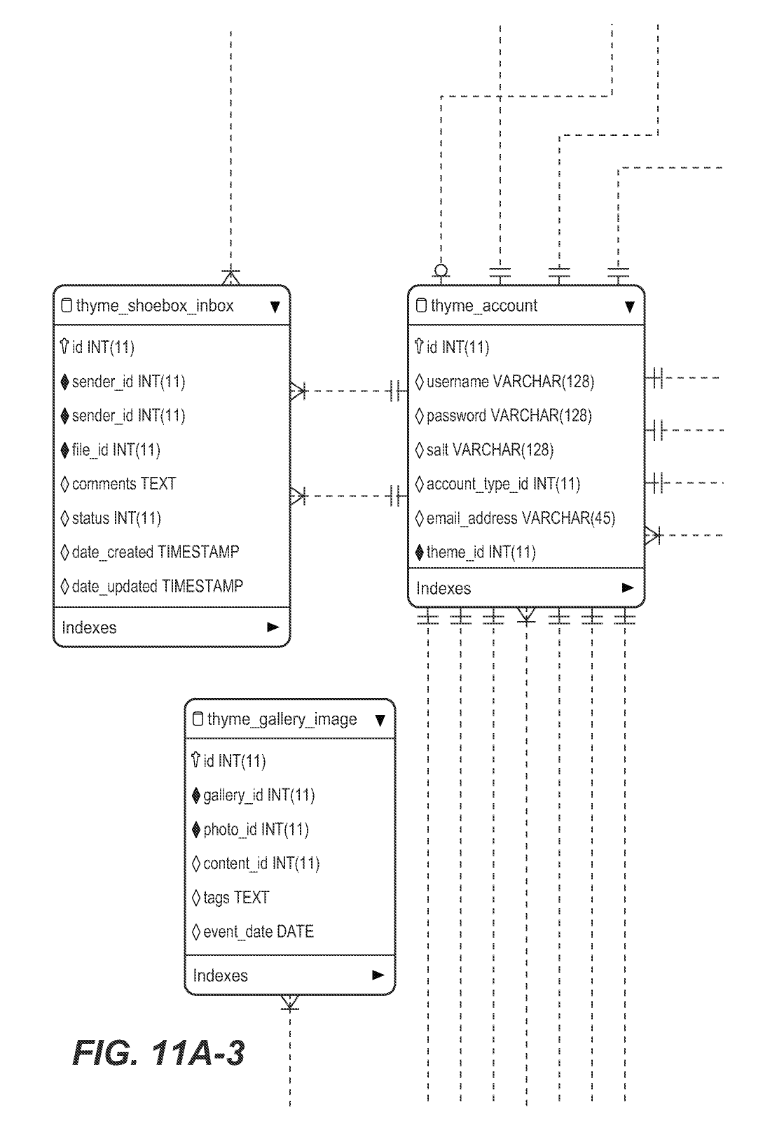

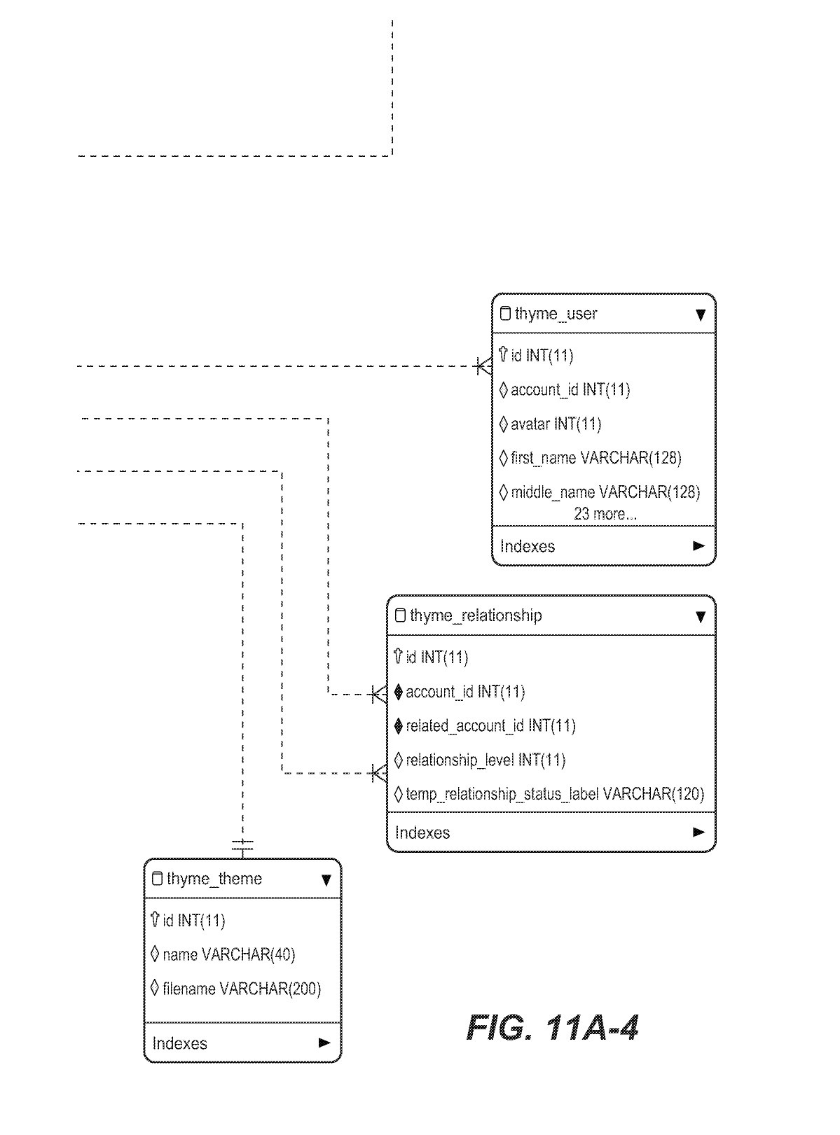

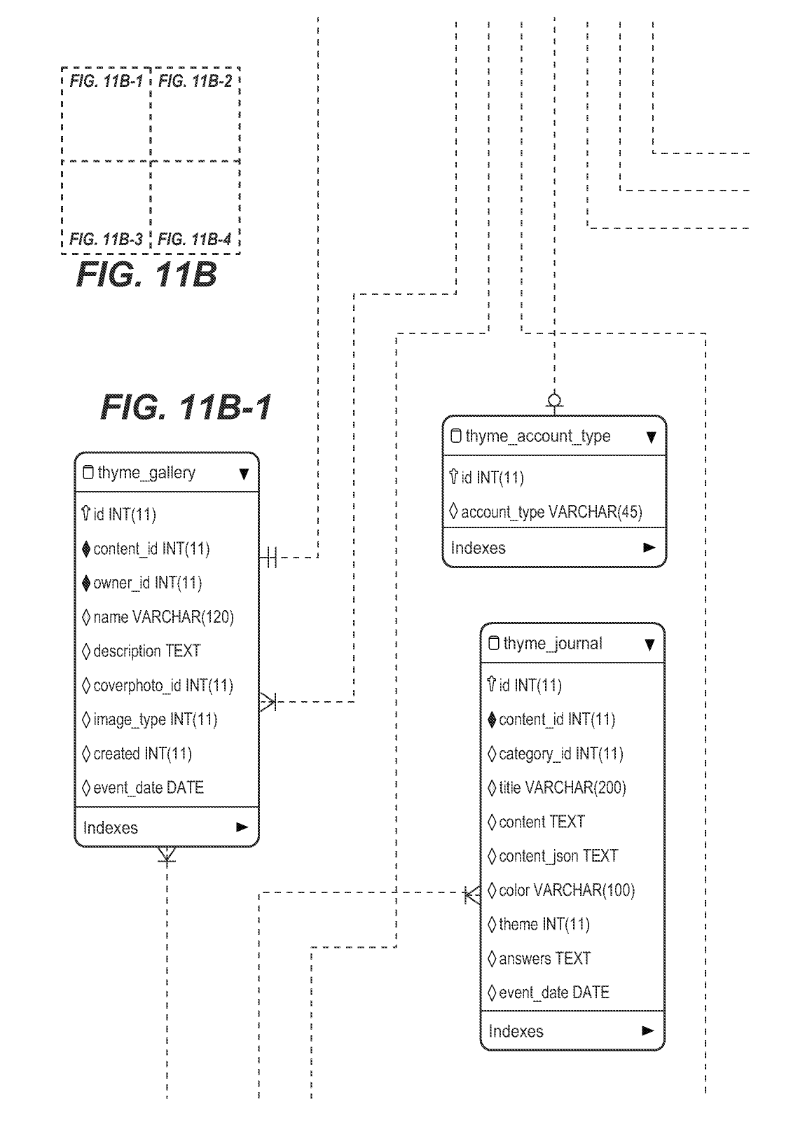

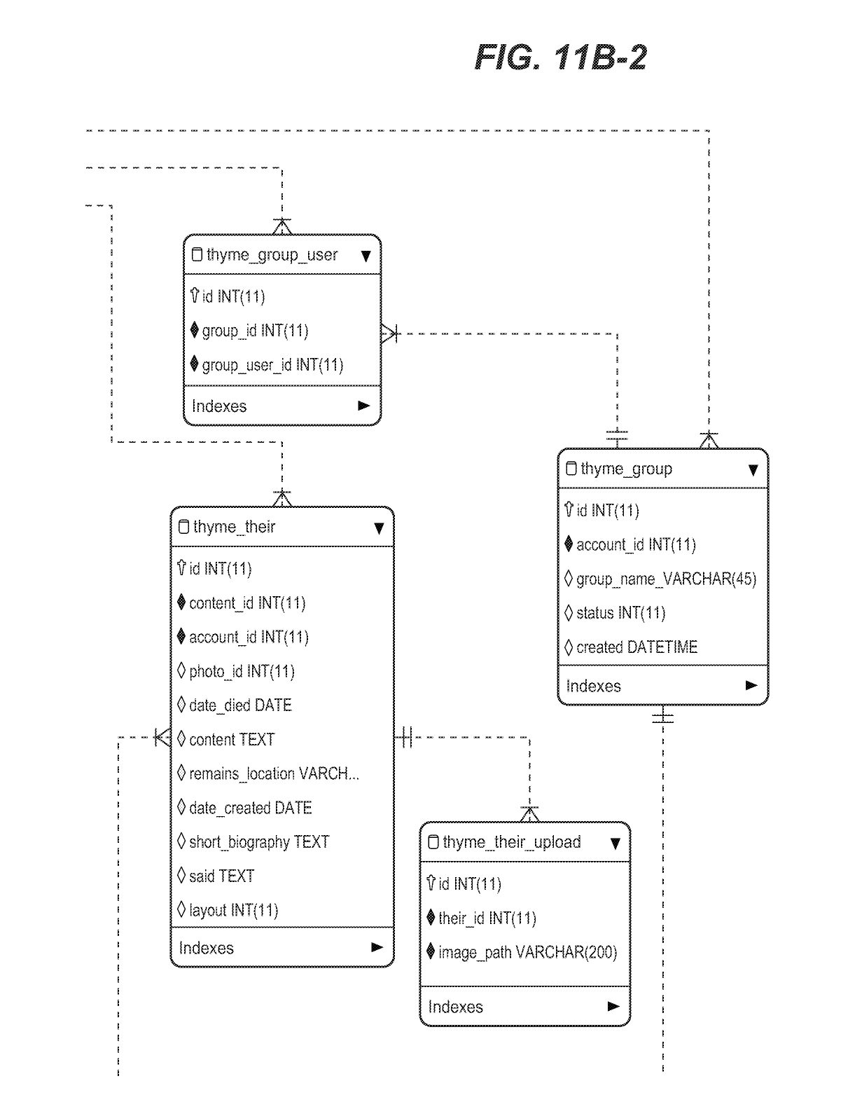

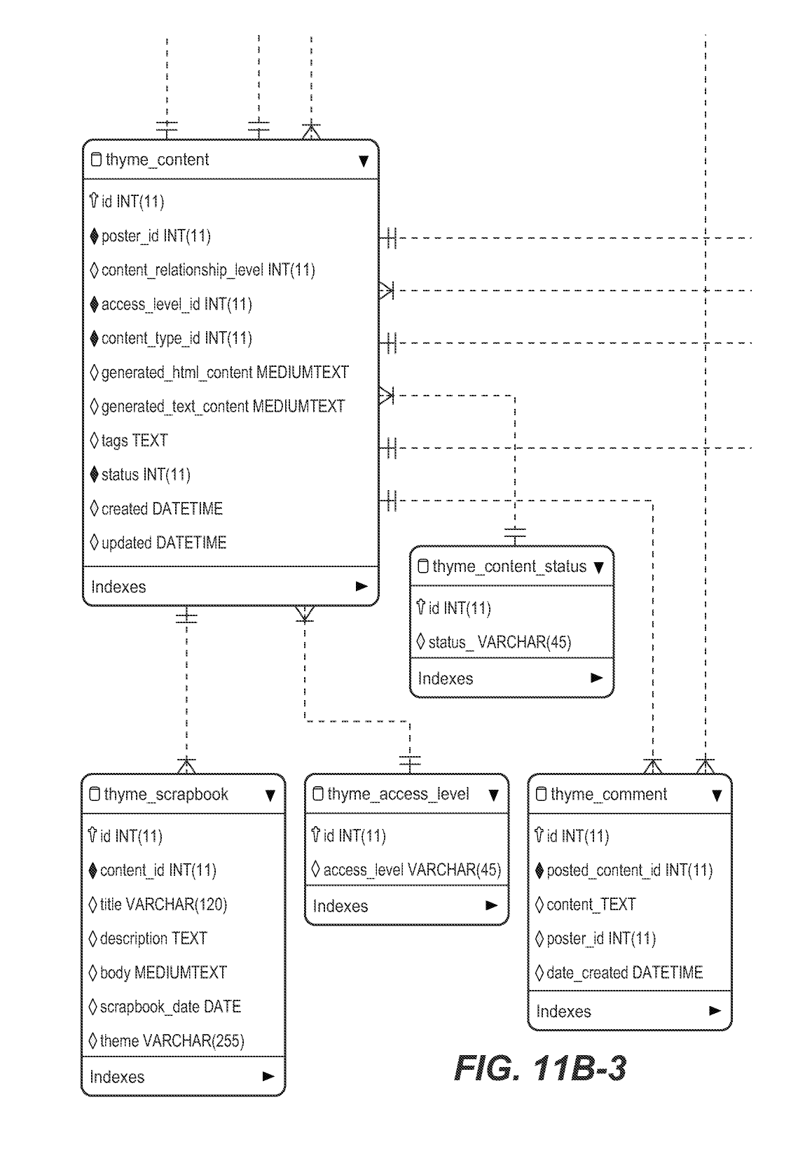

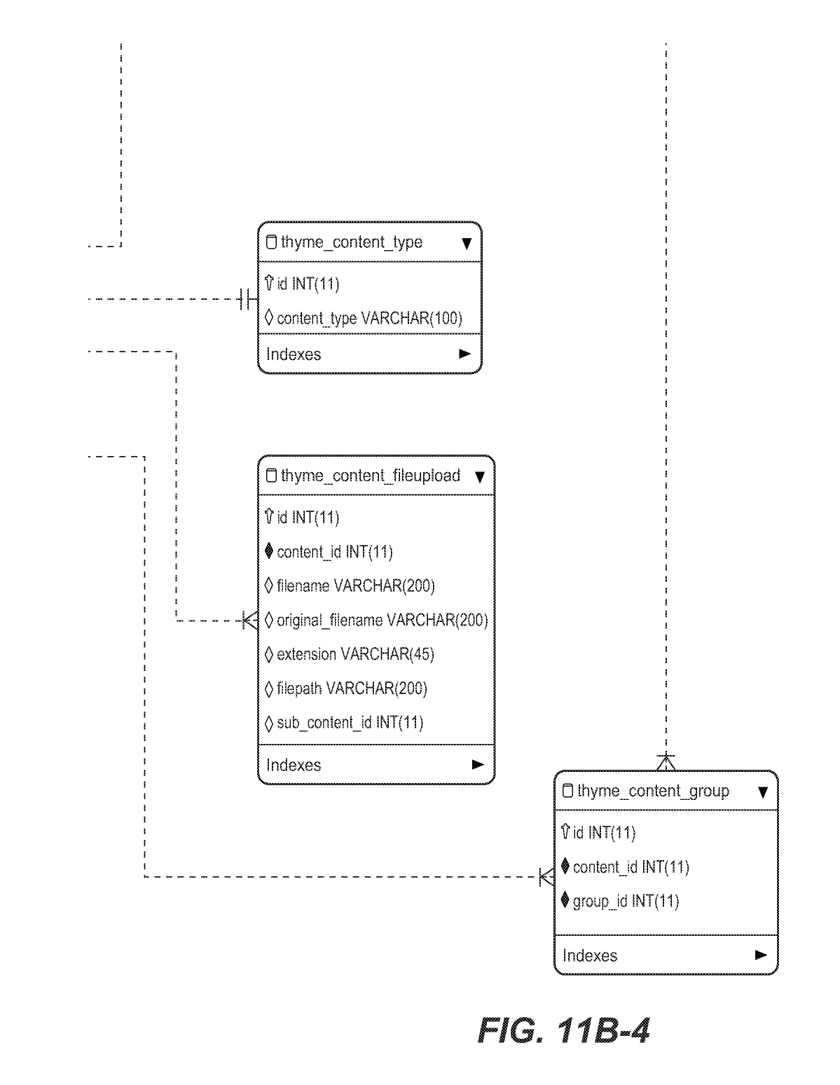

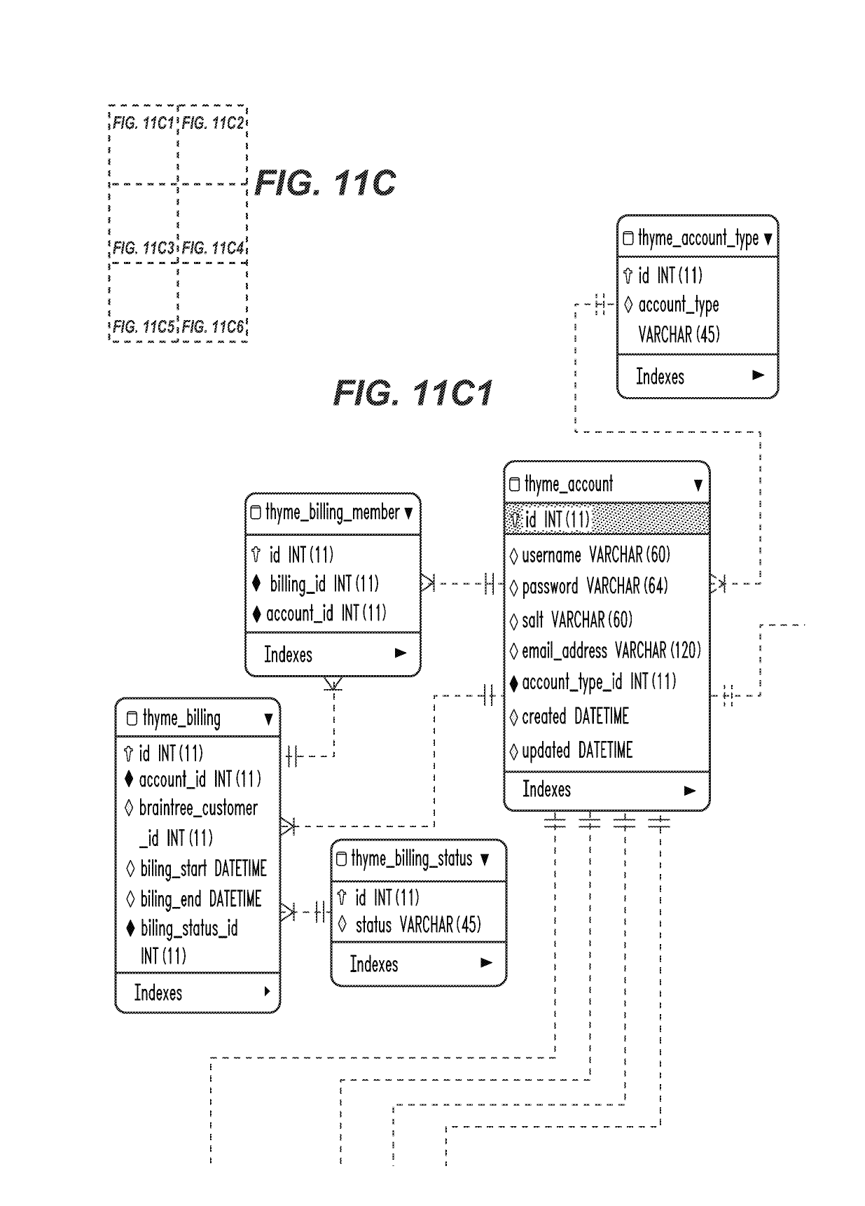

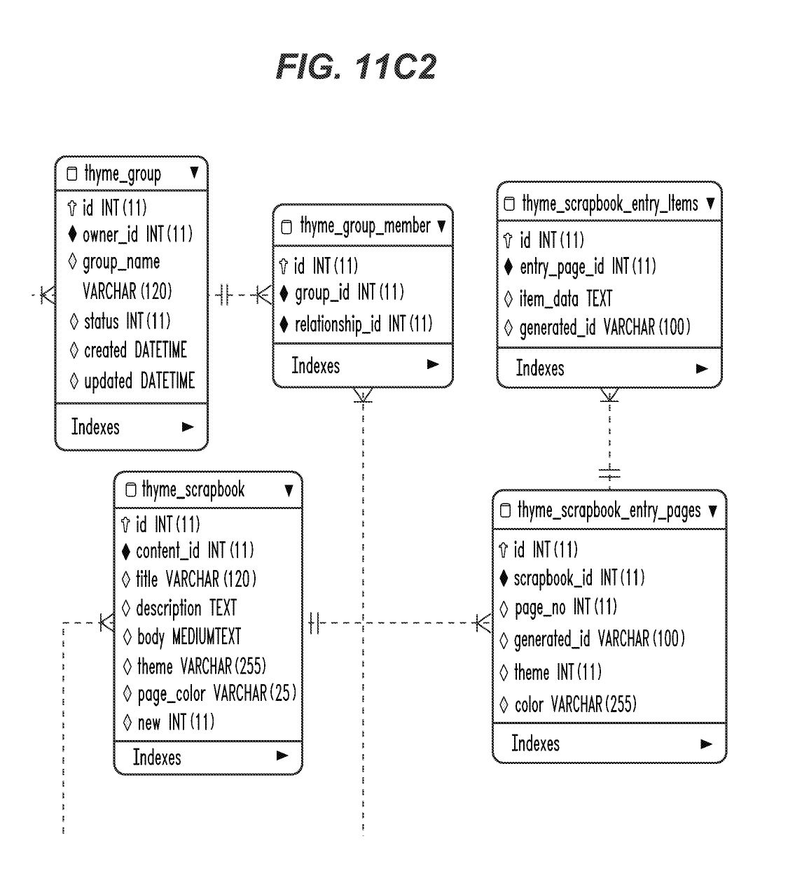

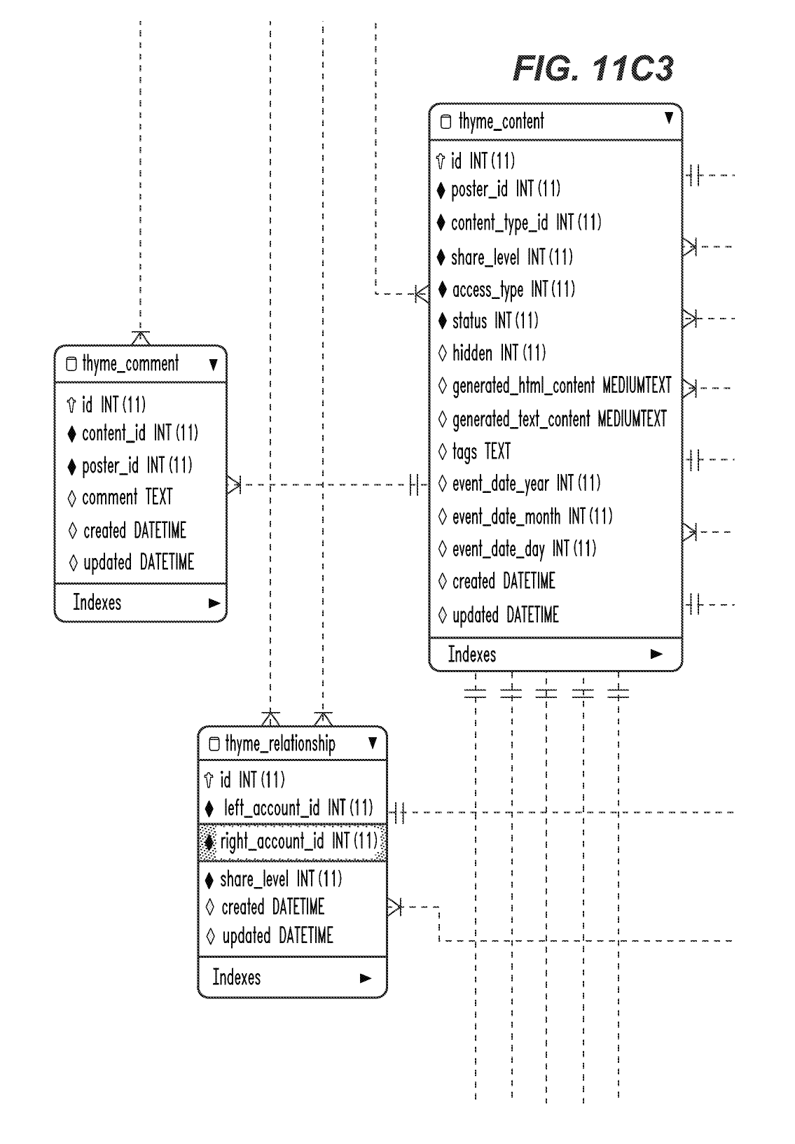

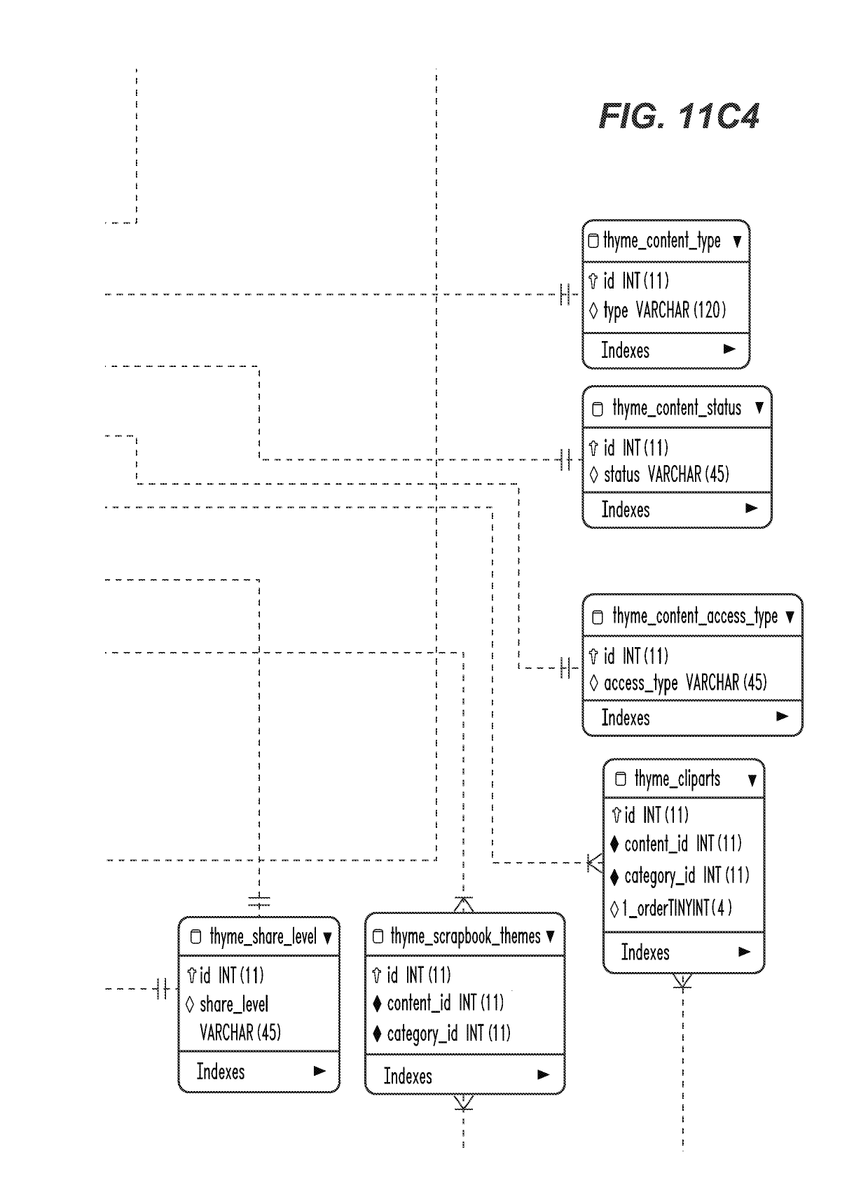

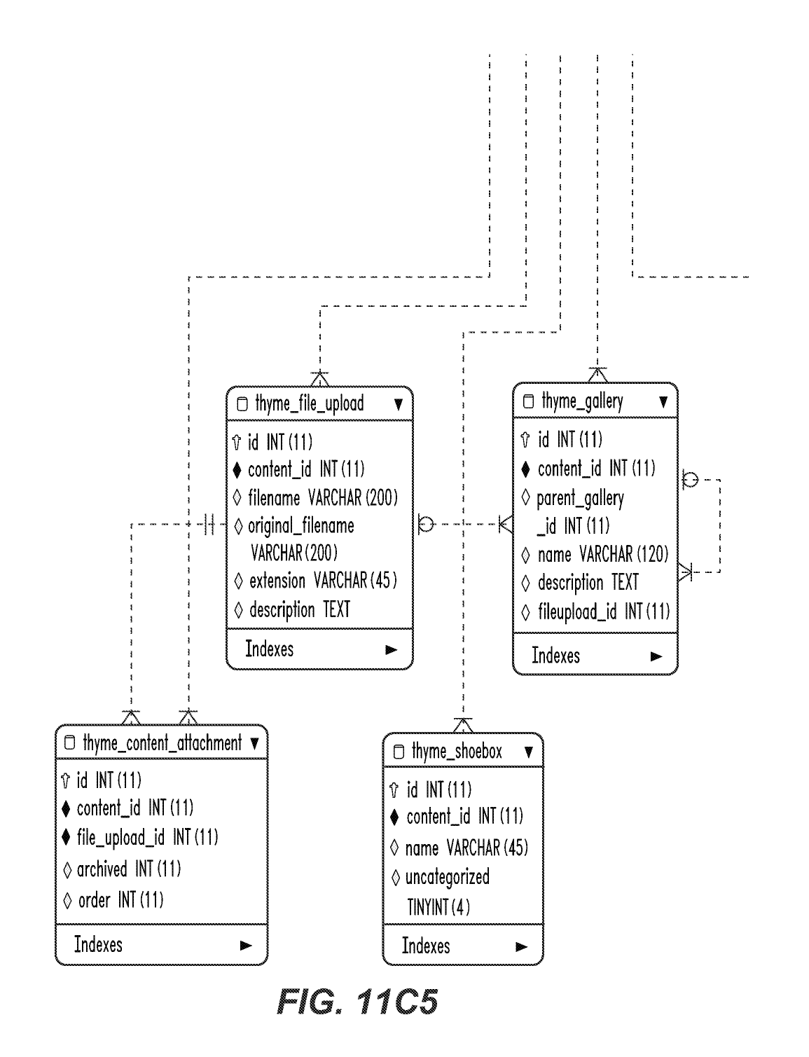

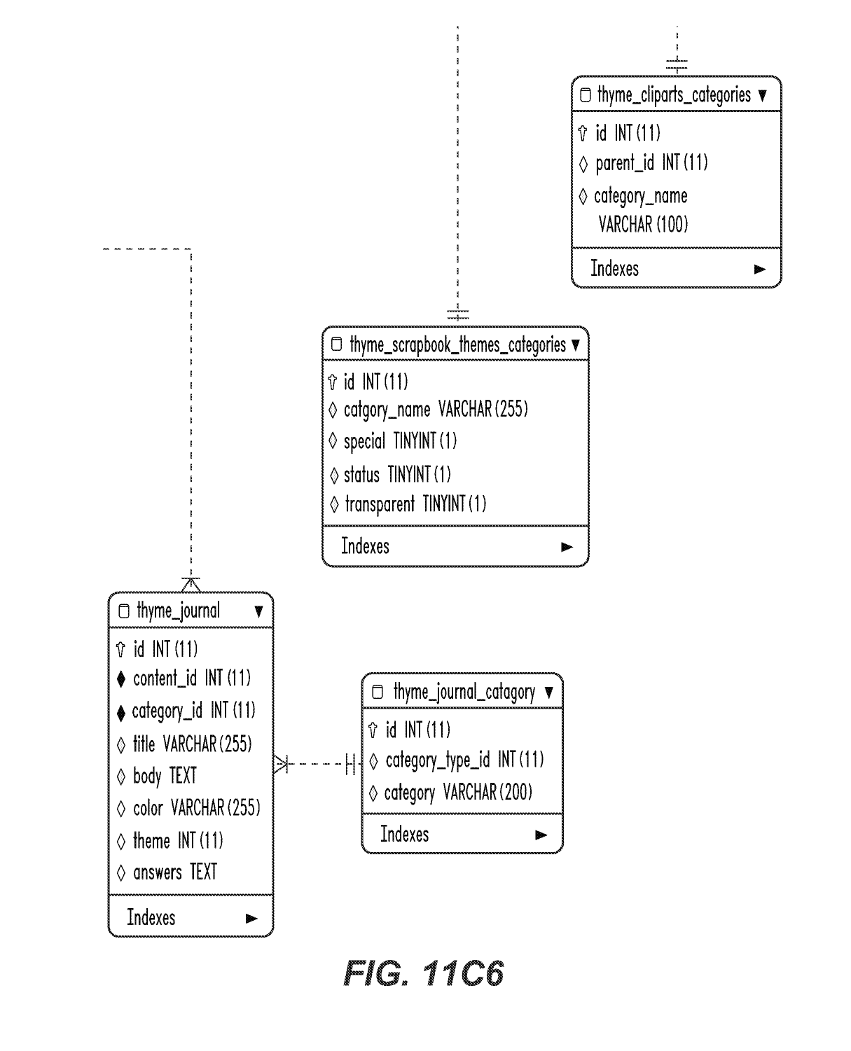

FIGS. 11A and 11B show the architectural structure of an exemplary embodiment of a scrapbook networking feature, in accordance with the principles of the present invention.

In particular, as detailed in FIGS. 11A and 11B, the scrapbooking feature in accordance with the principles of the present invention provides the ability for a plurality of users to create a unique scrapbook that captures their family's, or other associated group's, history.

Scrapbook can be created, viewed, and managed using this menu. Options menu includes the following tabs:

a Add a new entry

Drafts and Entries

Shared Entries
These tabs can be found on the right-side of the page.
   Add a new entry

A scrapbook entry may compose of:

Scrapbook Title

Background Template/Theme

Grabbing content and images from other tools

Scrapbook tools

| | |
|---|---|
| Share level | Varies from Immediate, Very close, Close, Fairly close, |
| | Not so close, and Public. |
| Group | An entry may also be shared to the affiliated Group. |

Share Settings (Options: by Share level/by Groups)

Event Date(Optional)

Description(Optional)

### Add a New Entry

### Steps:

In step 1, on home page click Add a new Entry

Expected Output Page will be redirected to the create entry page of the module.
Note: Fill out all the required fields indicated with an asterisk “*”

In step 2, enter Scrapbook Title

In step 3, choose a background template/theme then click ‘Proceed to Scrapbook’ button

Expected Output The front page of your scrapbook will be displayed
Note: When you click ‘Cancel’ button your entry will not be saved
Expected Output: Page will be redirected to the home page of the scrapbook

In step 4, edit your Scrapbook entry by ‘Grabbing content and images from other tools’ or use ‘Scrapbook tools’

Other tools:
NOTE: Added pages with module contents and images are automatically save once placed on the scrapbook

Gallery

Click ‘Gallery’ icon
Select Album from Gallery
Drag and Drop the images

Story Thyme

Click ‘Story Thyme’ icon
Drag and Drop story thyme content

Calendar

Click ‘Calendar’ icon

### Select Month/Day/Year

### Note: Default Month/Day/Year

Click the desired date

Private Shoebox

Click ‘Private Shoebox’ icon
Browse files/Browse Albums (enables to browse image from files or albums)
Drag and Drop the images

Clip Arts

Click ‘Clip Art’ icon
Click album from the categories
Drag and Drop the images
Scrapbook Image tools: Rotate Image; Bring to front; Bring to back; Delete/Remove Image; Resize Image.

### Scrapbook Tools:

NOTE: Added pages with module contents and images are automatically save once placed on the scrapbook

Edit Scrapbook Information

Click ‘Edit Scrapbook Information’ icon
Edit scrapbook ‘Title’
Then click ‘Apply’ button
Note: When you click ‘Cancel’ button, ‘Edit Scrapbook Information’ box will be closed.

Add new Page

Click ‘Add new Page’ icon
Expected Output Another page will be added.

Insert Note

Click ‘Insert Note’ icon
Enter Note text on the text field
Then click ‘Apply’ button
Note: When you click ‘Cancel’ button, ‘Insert Note’ box will be closed

Insert Text

Click ‘Insert Text’ icon
Enter Custom text on the text field
Then click ‘Apply’ button
Note: When you click ‘Cancel’ button, ‘Insert Text’ box will be closed

Change Theme

Click ‘Change Theme’ icon
Select background Theme
Then click ‘Apply’ button

Delete Page

Click ‘Delete Page’ icon
Expected Output Pop up message shows ‘Remove this page’?
Select ‘Yes’ button
Expected Output The page will be deleted
If ‘No’ button
Expected Output: Pop up message will be closed
Scrapbook Image tools: Rotate Image; Bring to front; Bring to back; Delete/Remove Image; Resize Image.

1. Choose from the options by Share level/by Groups

Share level

Slide the gray box to adjust your share level
Select a setting based on the privacy and sensitivity of your entry's content
Family members with an equal and closer Share Level status are able to view this entry
Note: ‘Immediate’ is the default level

Immediate—nuclear/Immediate Family Members & those closest to you

Very close—(1^{st} Degree of Closeness)

Close—(2^{nd} Degree of Closeness)

Fairly close—(3^{rd} Degree of Closeness)

Not so close—(4^{th} Degree of Closeness)

Public—anyone in the thyme vine network including non-paying accounts.

Groups

You may type a group to search

### Notify People via E-Mail

Check the checkbox to send scrapbook entry to your connected relatives or family members via E-mail
Who can see this Post?
Click ‘Who can see this post?’ button to view the list of the people who can view the post

### Cancel

Click ‘Cancel’ button
Expected Output Pop up message shows ‘Do you want to Cancel this Scrapbook entry?’
Select ‘Yes’ button
Expected Output Page will be redirected to the Shared entries or Index page
If ‘No’ button
Expected Output Pop up message will be closed

### Share Scrapbook

Click ‘Share Scrapbook’ button
Expected Output Pop up message shows ‘Are you ready to Share this Scrapbook entry’?
Select ‘Yes’ button
Expected Output: Page will be redirected when editing Event Date and adding

### Description

If ‘No’ button
Expected Output Pop up message will be closed

2. Sets ‘Event Date’

Note: Present date is the default value
Enter a ‘description’ on your Scrapbook entry

3. Click ‘SAVE’ button

Expected Output: The entry will be posted on the Recent Activity

### Save as Draft

Click ‘Save as draft’ button
Expected Output: Pop up message shows ‘Are you ready to save this Scrapbook entry as draft’?
Select ‘Yes’ button
Expected Output Page will be redirected when editing Event Date and adding

### Description

If ‘No’ button
Expected Output Pop up message will be closed

### Draft & Entries

Draft entries may compose of:

Search

Update status of an entry (Select an Option: Share, Draft, Delete)

Draft Entries/Published Entries (Share Post, Edit, View, Delete)

Search

Enter the title of the entry
Click ‘GO’ button

Update status of an entry

### Select An Option:

Share(can be multiple)
Click the checkbox of a scrapbook entry
Choose ‘Share’ on drop down list
Then click ‘Update’ button
Expected Output Entry will be change to Share status and posted on the Recent

### Activity

Draft (can be multiple)
Click the checkbox of a scrapbook entry
Choose ‘Draft’ on drop down list
Then click ‘Update’ button
Expected Output: Entry will be change to Draft status and accessible on manage entries
Delete (can be multiple)
Click the checkbox of a scrapbook entry
Choose ‘Delete’ on drop down list
Then click ‘Update’ button
Expected Output Entry will be deleted

Draft Entries/Published Entries

### Share Post

Note: ‘Share Post’ button will show if the share level is set to Public
Click ‘Share Post’ button
Expected Output Pop up message shows, ‘Enter in the email addresses of the people you wish to share this post with. Separate multiple email addresses with commas’
Enter Email address that you wish to share the post
Click ‘Share’ button
Click ‘X’ icon to close the share post box

### Edit

Click ‘Edit’ button of an entry you desired to update
Expected Output Page will be redirected on update entry

### View

Click ‘View’ button of an entry you desired to view

Expected Output: Page will be redirected on the full post

### Delete

Click ‘Delete’ button of an entry you desired to view
Expected Output Pop up shows, ‘Delete this scrapbook?’
Select ‘Yes’ button
Expected Output The entry will be deleted
If ‘Cancel’ button
Expected Output: Pop up message will be closed

### Shared Entries

Shared entries may compose of:

Sort by: by Post Date/by Event Date

Posted: By You/By Others

Shared Entries (Edit, Print, Leave a comment, View Full Post)

Sort by:

### Post Date

Select ‘Post Date’ on drop down list
Click ‘Sort’ button
Note: Entries will be sorted based on the latest post date

### Event Date

Select ‘Event Date’ on drop down list
Click ‘Sort’ button
Note: Entries will be sorted based on the latest event date

Posted:

### By You

Click ‘Posted by you’ button
Expected Output Page will be redirected on your personal shared entries

### By Others

Click ‘Posted by others’ button
Expected Output Page will be redirected on the

Shared Entries

### Edit

Click ‘Edit’ button of an entry you desired to update
Expected Output: Page will be redirected on update entry

### Print

Click ‘Print’ button of an entry
Expected Output Will open a new page that will show the print preview
Leave a comment
Note: User may leave comments on posted journal entries.
Enter comment on the text field
Click ‘Comment’ button
Expected Output Comment will be posted

### Edit

Click ‘Edit’ comment link
Edit your comment
Click ‘Save’ link
Expected Output Comment will be updated
Click ‘Cancel’ link
Expected Output Edit box will be closed

Delete

Click ‘Delete’ comment link

Expected Output Pop up shows, ‘Are you sure you want to remove your comment here?’
Select ‘OK’ button
Expected Output The comment will be deleted
If ‘Cancel’ button
Expected Output Pop up message will be closed

### View Full Post

Click ‘View Full post’ link
Expected Output Page redirected on view full post of an entry
Click ‘Share this on Facebook’ link
Expected Output Scrapbook entry will be posted on your Facebook account
Click ‘Share this on Twitter’ link
Expected Output: Scrapbook entry will be posted on your Twitter account

Return to Scrapbook Index

Click ‘Return to Scrapbook Index’ button
Expected Output Page will be redirected to the Shared Entries or Index page.

### SCRAPBOOK

Scrapbook is a unique memorable scrapbook that allows you to build and share captures memorable family events. FIG. 11C shows the architectural structure of another exemplary embodiment of a scrapbook networking feature, in accordance with the principles of the present invention.

A billing administrator has the ability to use Scrapbook Tools and share on his/her family and connected member. A billing member has the ability to use Scrapbook Tools and share on his/her family and connected member.

### ADD/UPDATE A NEW ENTRY

COVER TITLE
Description:
   Cover title for the entire scrapbook. (see modify title)
Validation:
   a Cover title is required field.
Steps:
   Step 1: Click ‘Add a new Entry’ button.
   Step 2: Enter Cover Title.
Specifications
   Pop up textbox show when entering cover title.
   Cover title selection background color (Vertical Stripe Gray).
   Default size of Cover Title text: 48.

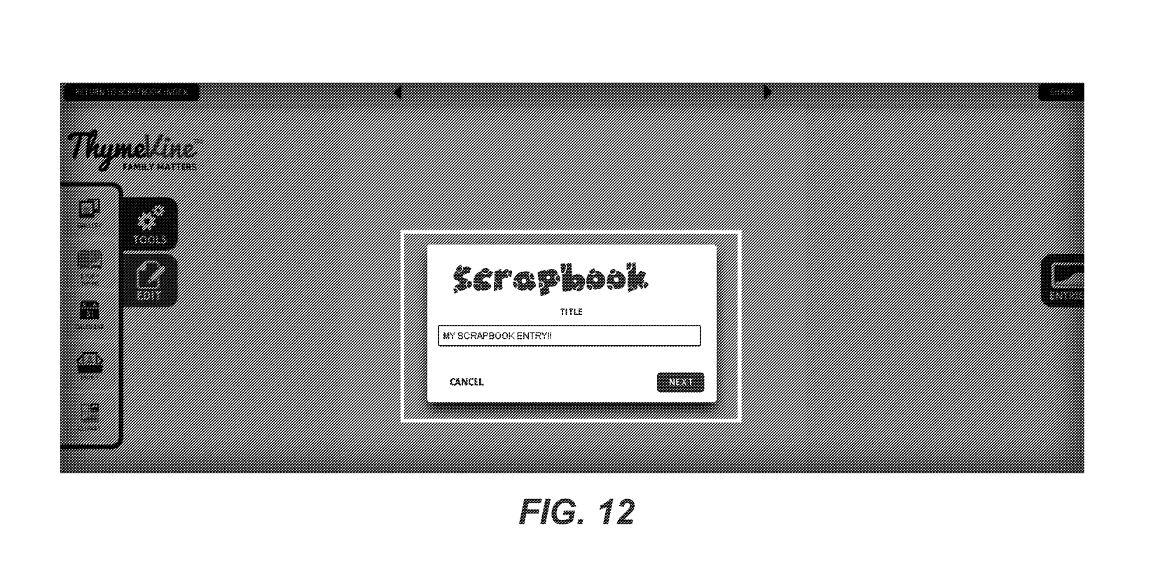

FIG. 12 shows an exemplary graphical user interface for a scrapbooking cover title, in accordance with the principles of the present invention.

### CUSTOMIZATION FOR BACKGROUND

Description:
Customize for background of the scrapbook (Background Colors, Themes, or Borders).

Validation:
Not required field. (Default color: Blank/White)

Steps:
Step 1: Select any theme that you want to apply on scrapbook.
Step 2: Click ‘Next’ button.

Specifications:
Pop up box show when choosing background of the scrapbook.
Additional Background theme selection (Borders).
Applying Theme for cover and inside pages.

FIG. 13 shows an exemplary graphical user interface for customizing background of scrapbooking, in accordance with the principles of the present invention.

### ACCESS EDIT MENU OPTIONS

Description
Customize an item using edit menu options.

Validation:
User must double click the item.
User must click ‘APPLY’ button on any changes to take effect.

Steps:
Step 1: Double click the item to access edit menu options.

Specifications:
Footer action for edit menu options.
New Layout for edit menu options.

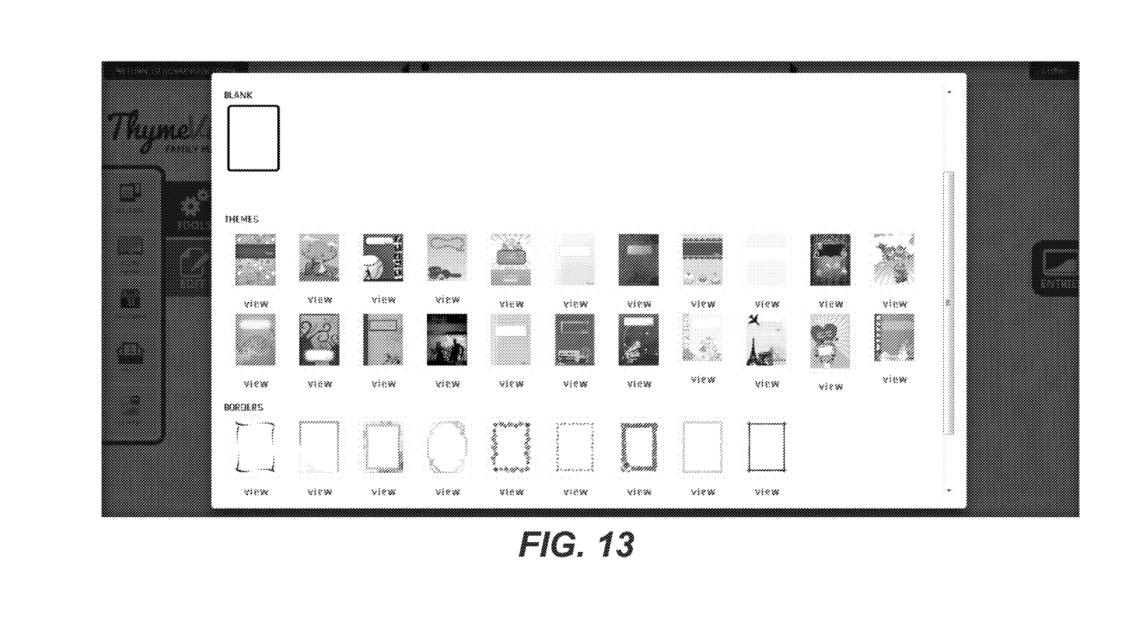

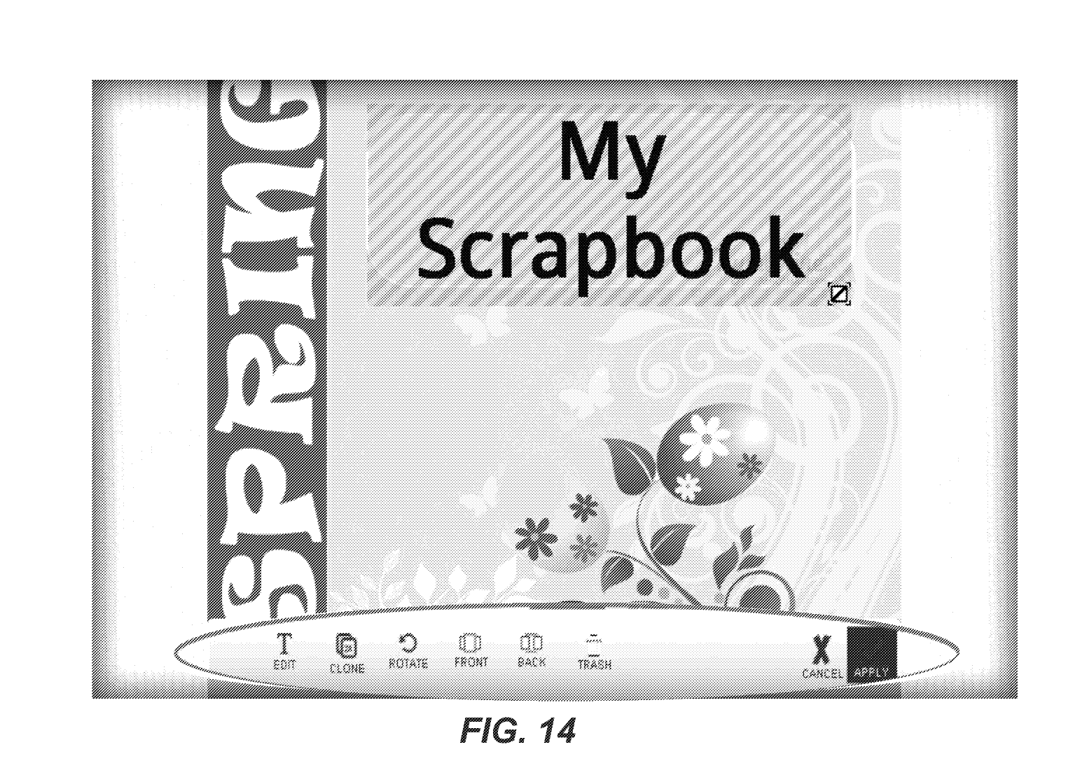

FIG. 14 shows an exemplary graphical user interface for edit menu options of scrapbooking, in accordance with the principles of the present invention.

### EDIT TOOLBAR

### 1. Text Title

Edit—customize text with font style and text color.

Clone—make multiple copies.

Rotate—rotating the text.

Resize—resize the text container.

Front/Back—bring the text to front or back.

Trash—deleting the text.

### 2. Add Note/Sticky Note

Edit—customize text with font style and text color.

Clone—make multiple copies.

Rotate—rotating the note.
Front/Back—bring the note to front or back.

Trash—deleting the note.

### 3. Add Text

Edit—customize text with font style and text color.

Clone—make multiple copies.

Rotate—rotating the text.

Resize—resize the text container.

Front/Back—bring the text to front or back.

Trash—deleting the text.

### TOOLS

### 1. Gallery Images

Clone—make multiple copies.

Rotate—rotating the image.

Resize—resize the image.

Front/Back—bring the image to front or back.

Trash deleting the image.

2. Story Thyme Entry (with Title, Posted Date, and Content)

Clone—make multiple copies.

Front/Back—bring the entry to front or back.

Trash—deleting the entry.

View full post

### 3. Calendar (Year, Month, and Day)

Clone—make multiple copies.

Front/Back—bring the calendar to front or back.

Trash—deleting the calendar.

### 4. Vault Images

Clone—make multiple copies.

Rotate—rotating the image.

Resize—resize the image.

Front/Back—bring the image to front or back.

Trash—deleting the image.

### 5. Clip Art

Clone—make multiple copies.

Rotate—rotating the clip art.

Resize—resize the clip art.

Front/Back—bring the clip art to front or back.

Trash—deleting the clip art.

### EDIT TOOLBAR

Description:
Customize created scrapbook entry by using edit toolbar (Re-Title, Add Page, Add Note, Add Text, Change Theme, Delete Page, Undo, and Redo).

Validation:
User must click ‘EDIT’ button to appear the different Toolbar.

Steps:
Step 1: Click ‘EDIT’ button (left side panel).

Specifications:
New vertical layout for Edit Toolbar (Re-Title, Add Page, Add Note, Add Text, Change Theme, Delete Page, Undo, Redo).

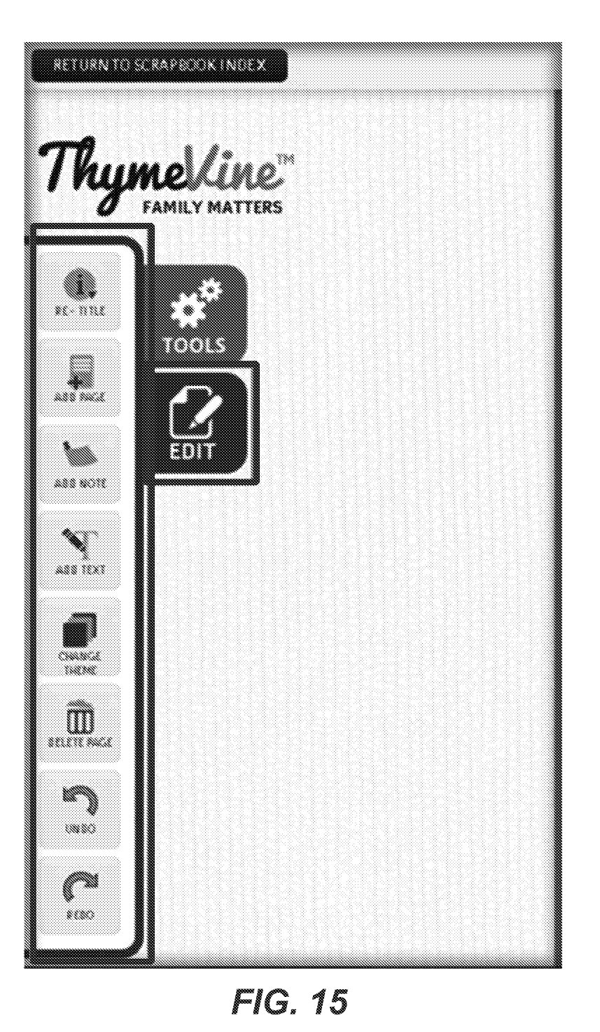

FIG. 15 shows an exemplary graphical user interface for an edit toolbar for scrapbooking, in accordance with the principles of the present invention.

### EDIT TOOLBAR ITEMS:

1. Add Page—User can add pages on the scrapbook.

Validation:
User must click ‘Add Page’ button.

Steps:
Step 1: Click ‘Add Page’ button (left side panel).

Specifications:
Added pages will automatically increment depends on the number of the users click (On the top>Page Navigation).
Added quick add page button (under Page Navigation)

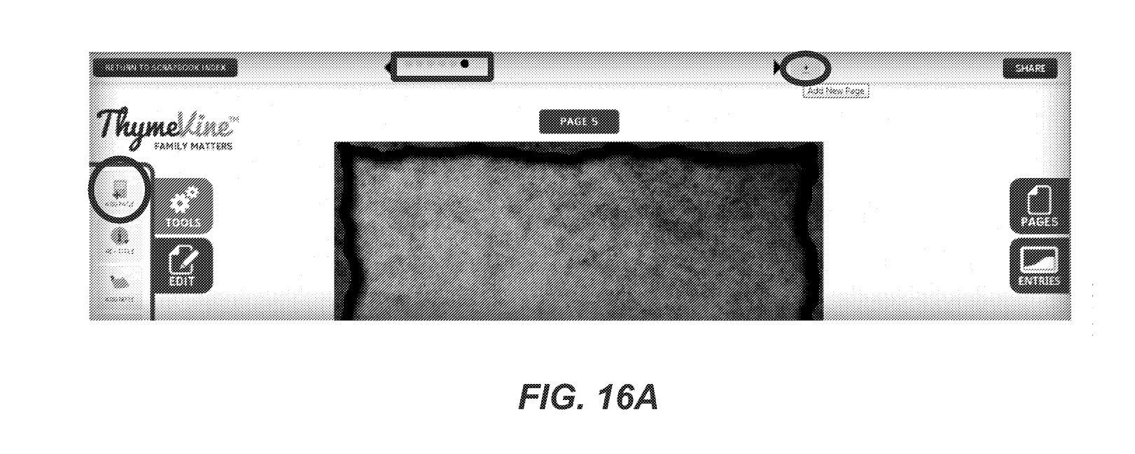

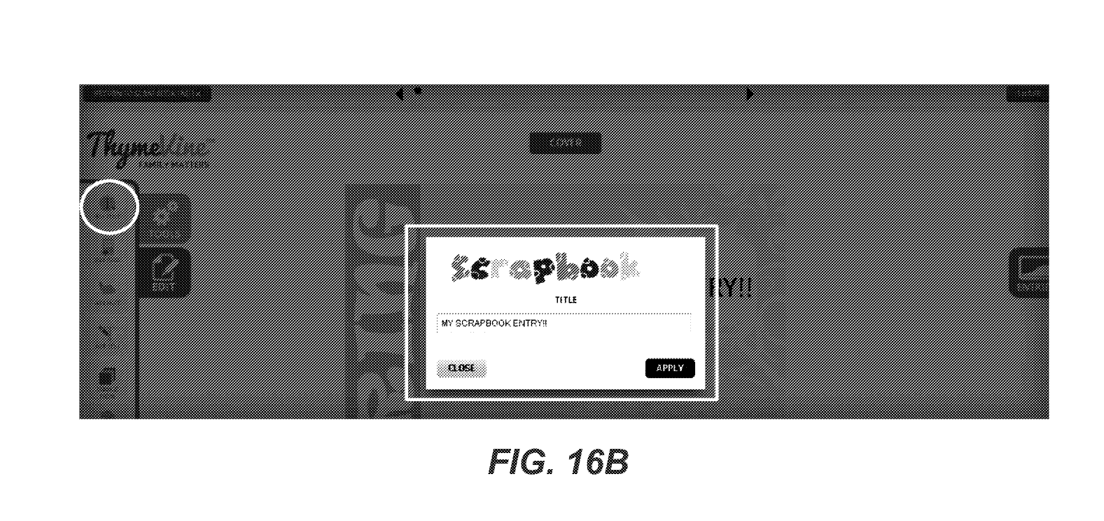

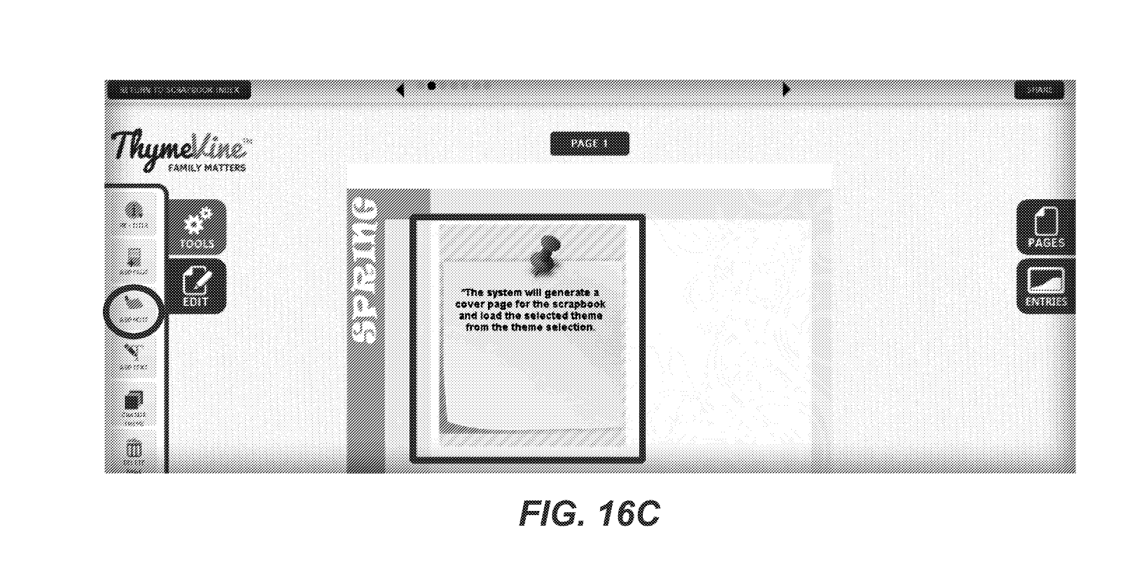

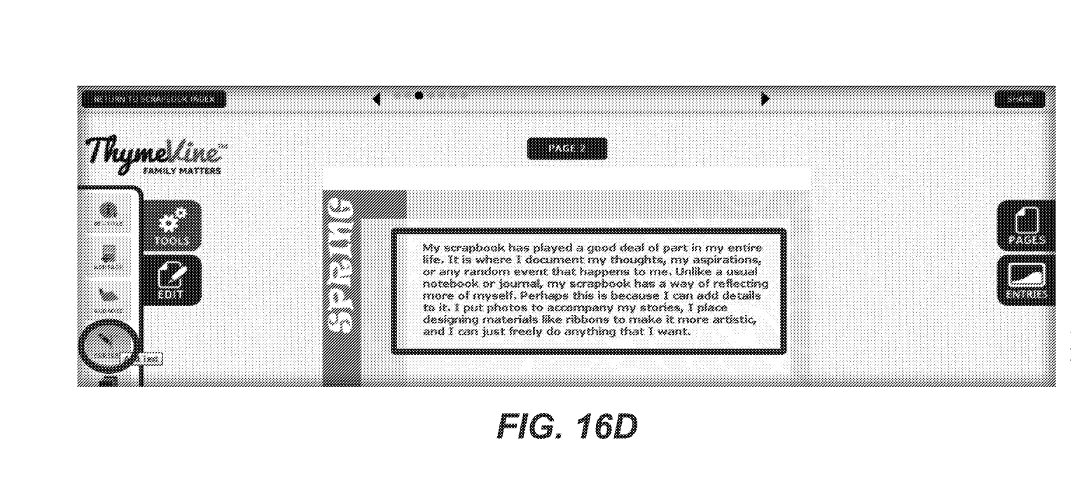

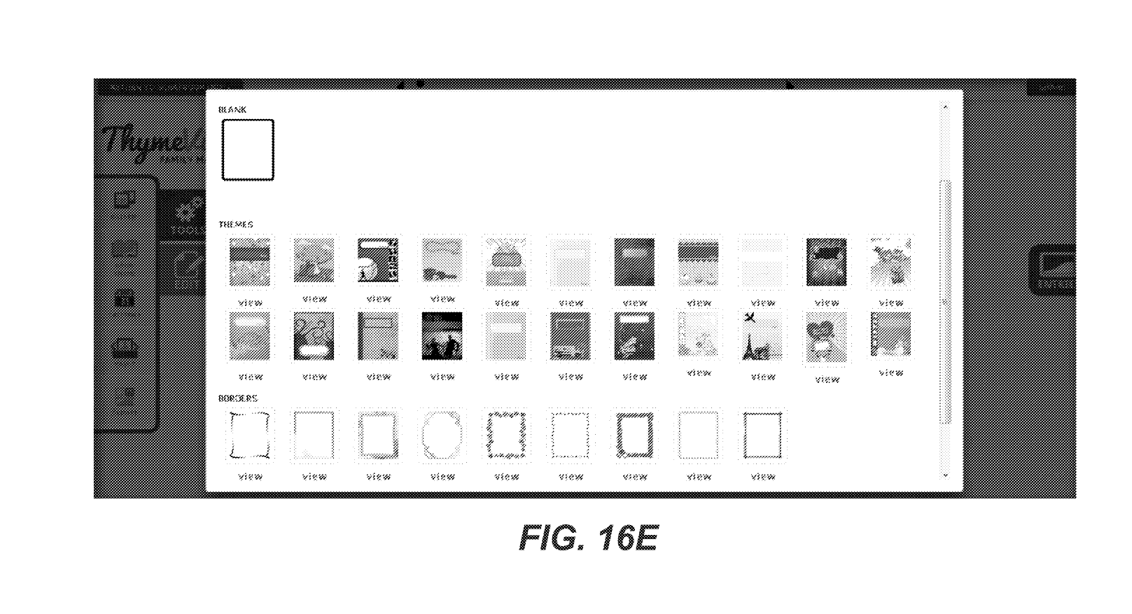

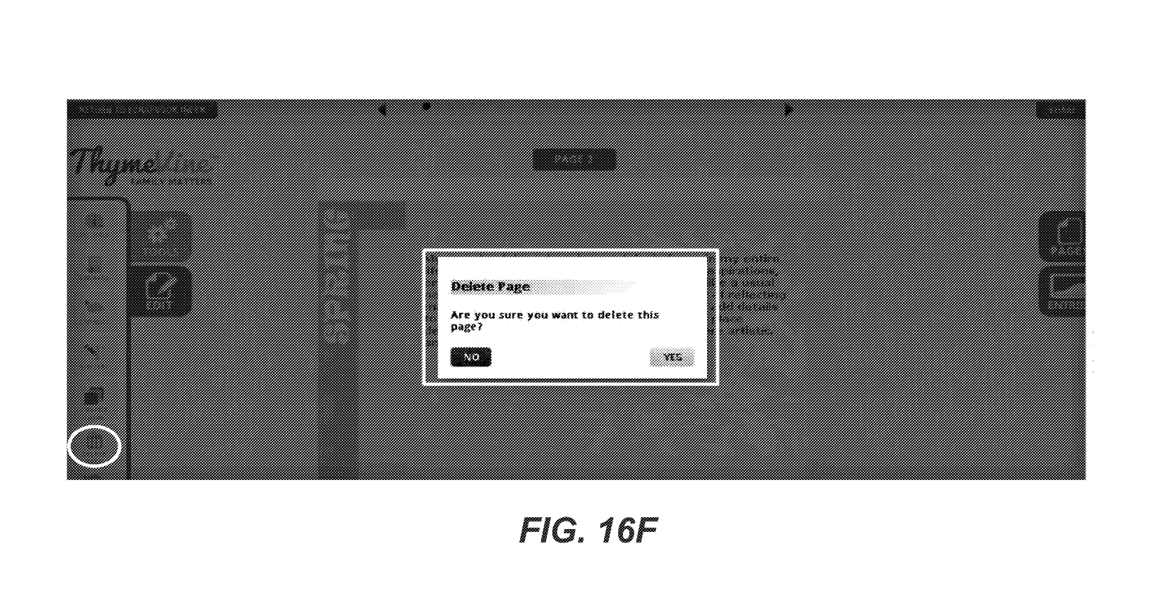

FIG. 16A shows an exemplary graphical user interface for adding a page feature of an edit toolbar of scrapbooking, in accordance with the principles of the present invention.

Re-Title—User can modify the cover title of the scrapbook.

Validation:
User must click ‘Re-title’ button.
You must click ‘APPLY’ button on any changes to take effect.

Steps:
Step 1: Click the ‘Re-Title’ button (left side panel).
Step 2: Update cover title.
Step 3: Click ‘APPLY’ button.

Specifications:
Pop up textbox show when entering cover title.
Cover title selection background color (Vertical Stripe Gray).
Default size of Cover Title text: 48.

FIG. 16B shows an exemplary graphical user interface for a re-title feature of an edit toolbar of scrapbooking, in accordance with the principles of the present invention.

Add Note—User can add note on the scrapbook page.

Validation:
User must click ‘Add Note’ button.
After enter text on the text box editor user must click ‘DONE’ button on any changes to take effect.

Steps:
Step 1: Click ‘Add Note’ button (left side panel).
Step 2: Add text on the text editor.
Step 3: Click ‘DONE’ button.

Specifications:
Note selection background color (Vertical Stripe Gray).
New Size of Sticky Note.
Default size of note text: 18.

FIG. 16C shows an exemplary graphical user interface for an add note feature of an edit toolbar of scrapbooking, in accordance with the principles of the present invention.

Add Text—User can add text on the scrapbook page.

Validation:
User must click ‘Add Text’ button.
After enter text on the text box editor user must click ‘DONE’ button on any changes to take effect.

Steps:
Step 1: Click ‘Add Text’ button (left side panel).
Step 2: Add text on the text editor.
Step 3: Click ‘DONE’ button.

Specifications:
Text selection background color (Vertical Stripe Gray).
Default size of text: 28.

FIG. 16D shows an exemplary graphical user interface for an add text feature of an edit toolbar of scrapbooking, in accordance with the principles of the present invention.

Change Theme—User can change the theme for the entire scrapbook and individual pages (Cover and Inside Pages).

Validation:
User must click ‘Change Theme’ button.
User must assigned theme.
User must click ‘APPLY TO SCRAPBOOK’ or ‘APPLY TO CURRENT PAGE’ to take effect.

Steps:
Step 1: Click ‘Change Theme’ button (left side panel).
Step 2: Select a theme to apply on scrapbook page.
Step 3: Click ‘APPLY TO SCRAPBOOK’ to apply theme on the entire scrapbook entry, or click ‘APPLY TO CURRENT PAGE’ to apply the theme on the current page only.

Specifications:
Pop up box shows when choosing changing background theme.
Additional Background theme selection (Borders).
New size of Theme selection window.

FIG. 16E shows an exemplary graphical user interface for a change theme feature of an edit toolbar of scrapbooking, in accordance with the principles of the present invention.

Delete Page—User can delete or remove page/pages on the scrapbook.

Validation:
User must click ‘Delete Page’ button.
User must click ‘YES’ button on the pop up message to delete the page.

Steps:
Step 1: Choose a page to delete.
Step 2: Click ‘Delete Page’ button.

Specifications:
New message content when deleting page/pages.

FIG. 16F shows an exemplary graphical user interface for a delete page feature of an edit toolbar of scrapbooking, in accordance with the principles of the present invention.

Undo—User can reload previous activity or modification depends on the item inside the current page of the scrapbook.

Validation:
User must click ‘Undo’ button,
   Note: Undo support these following activities:

Item reposition including set to front, back and rotate.

Item resize.

Item modification of content.

Item order.

Item trash

Clipboard is being cleared when user changed page.

Note: Undo does not support these following activities:

Change Scrapbook Theme for entire and individual page.

Page deletion.

Item drop on the scrapbook.

Item done.

Steps:
Step 1: Click ‘Undo’ button.

Specifications:
Added Undo button.
   Redo—User can bring back changes depends on the state from the point when undo is clicked.

Validation:
User must click ‘Redo’ button,
   Note: Undo support these following activities:

Item reposition including set to front, back and rotate.

Item resize.

Item modification of content.

Item order.

Item trash

Clipboard is being cleared when user changed page.

Note: Undo does not support these following activities:

Change Scrapbook Theme for entire and individual page.

Page deletion.

Item drop on the scrapbook.

Item clone.

Steps:
Step 1: Click ‘Redo’ button.

Specifications:
Added Redo button.

### TOOLS

Description:
Accessing different tools added to customize scrapbook.

Validation:
User must click ‘TOOLS’ button to appear the different TOOLS.

Steps:
Step 1: Click ‘TOOLS’ button (left side panel).

Specifications:
Vertical Layout of Edit Toolbar (Gallery, Story Thyme, Calendar, Vault, Clip Art).
Sliding window (right side panel).

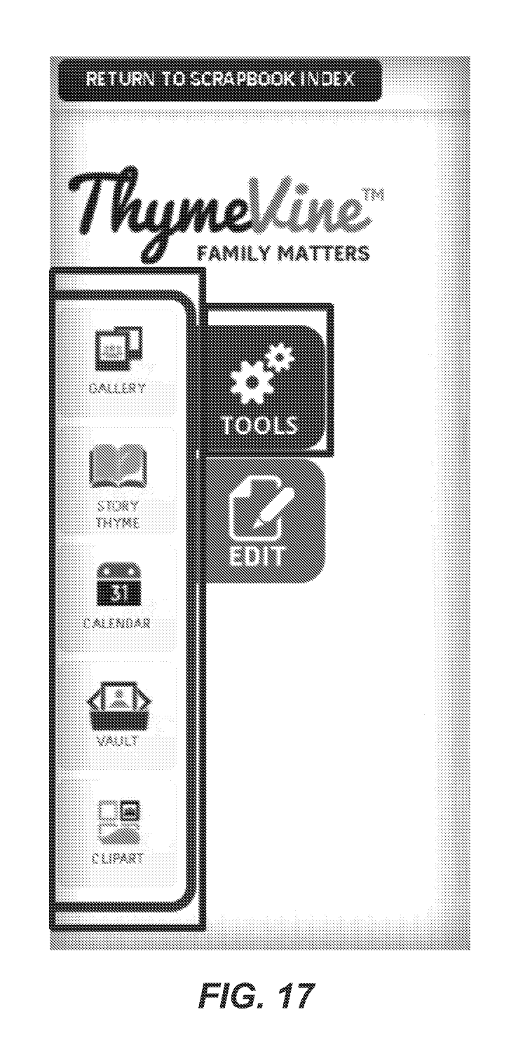

FIG. 17 shows an exemplary graphical user interface for tools for scrapbooking, in accordance with the principles of the present invention.

### TOOLS ITEMS:

Gallery—User can access his/her gallery albums.

Validation:
User must click ‘Gallery’ button to appear on the right side panel.
User must select an album.
User must drag and drop the gallery image to the scrapbook page.

Steps:
Step 1: Click the ‘Gallery’ button (left side panel).
Step 2: Select an album from the drop down list.
Step 3: Drag and drop the gallery image.

Specifications:
High quality gallery images.
Gallery Image selection background color (Vertical Stripe Gray).
Added SEARCH OPTIONS for easy searching.
   Note: Search options—filename, words/tags, description.

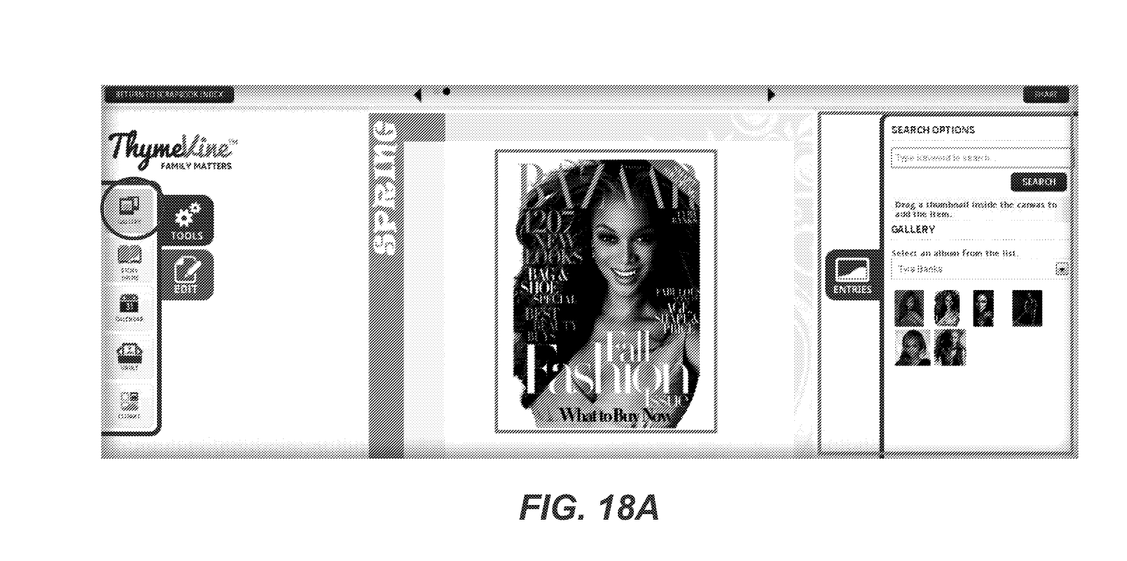

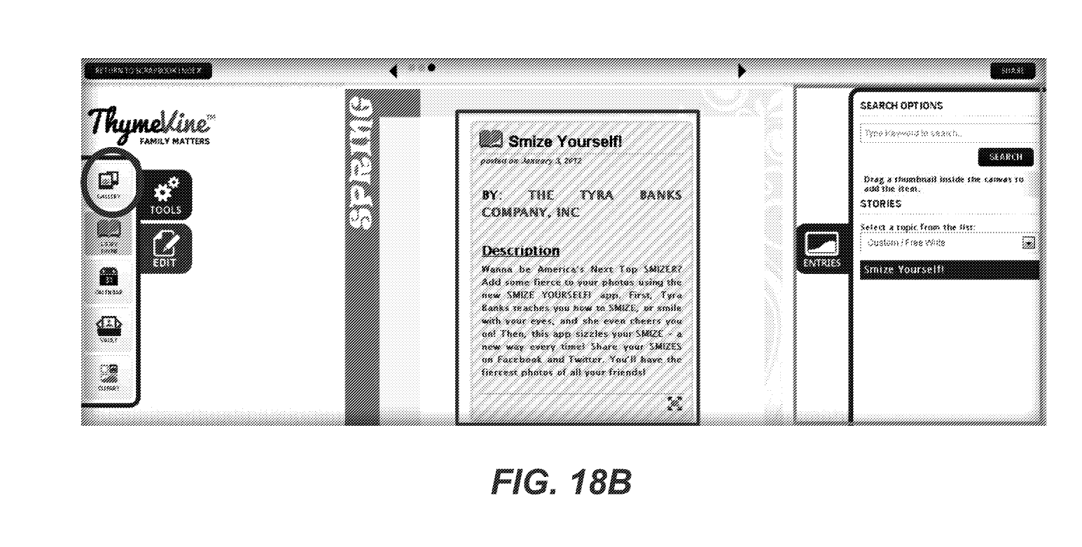

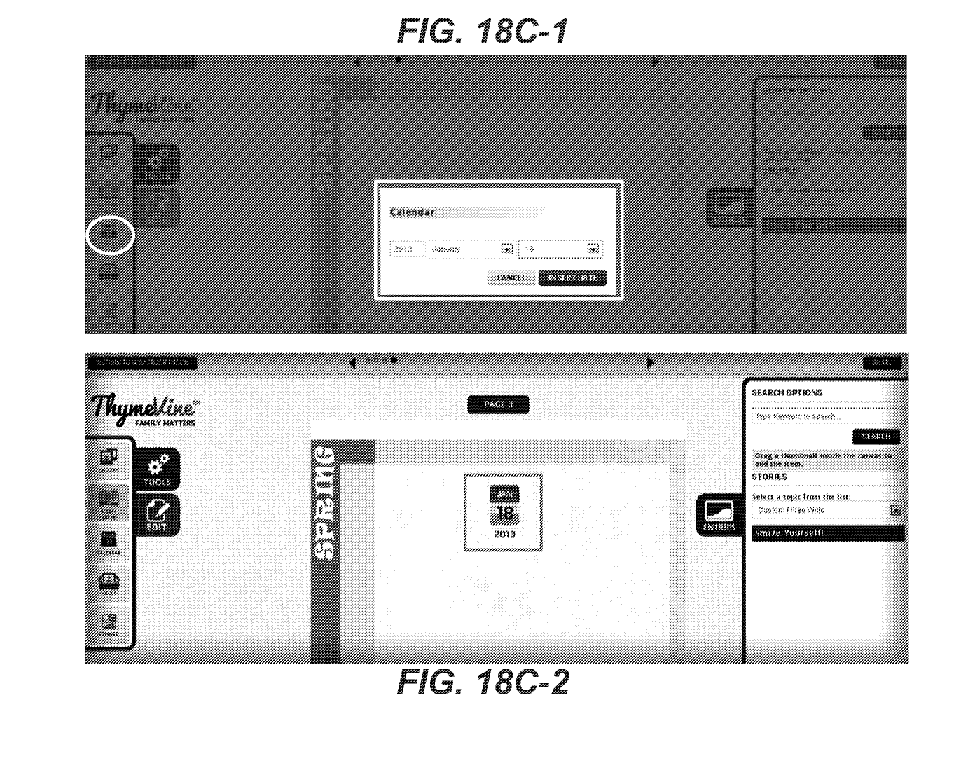

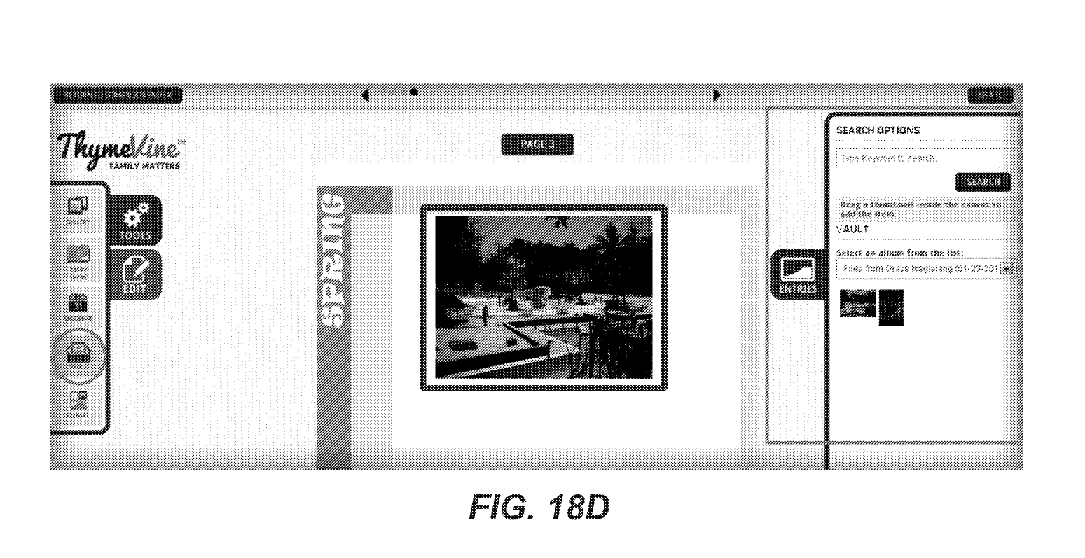

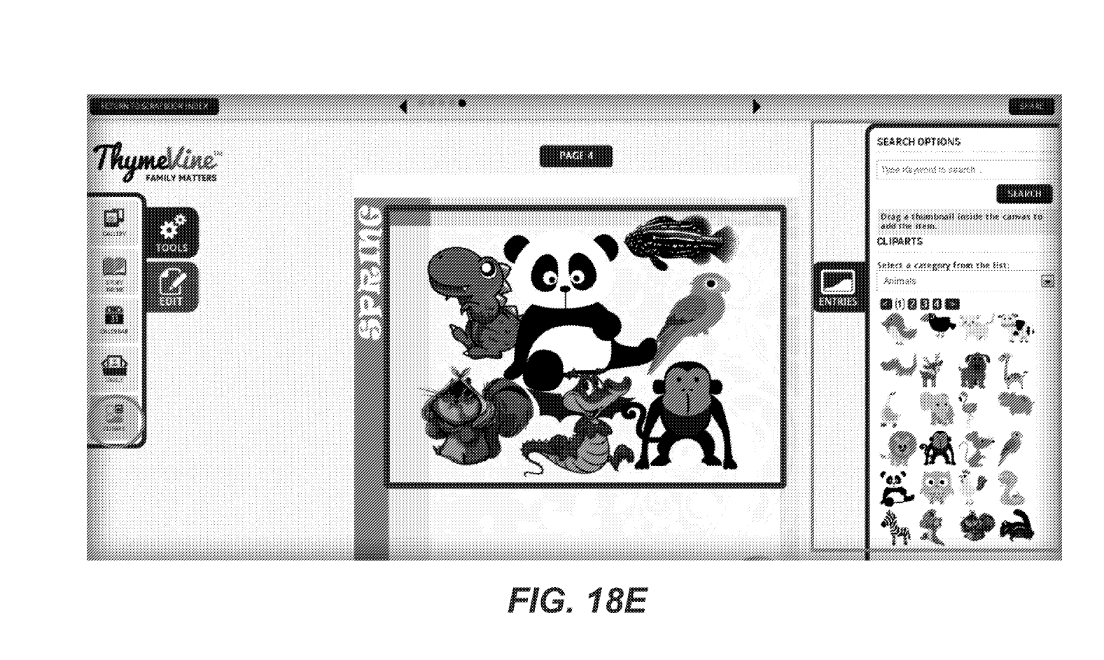

FIG. 18A shows an exemplary graphical user interface for a gallery feature of tools for scrapbooking, in accordance with the principles of the present invention.

Story Thyme—User can access his/her story thyme entry with title, posted date, and content.

Validation:
User must click ‘Story Thyme’ button to appear on the right side panel.
User must select a topic.
User must drag and drop the story thyme entry to the scrapbook page.

Steps:
Step 1: Click the ‘Story Thyme’ button (left side panel).
Step 2: Select a topic from the drop down list.
Step 3: Drag and drop the story thyme entry.

Specifications:
Entry selection background color (Vertical Stripe Gray).
New layout (One column).
Added SEARCH OPTIONS for easy searching.
   Note Search options—title only.

FIG. 18B shows an exemplary graphical user interface for a story thyme feature of tools for scrapbooking, in accordance with the principles of the present invention.

Calendar—User can add calendar depends on the user input (Year, Month, and Day).

Validation:
User must click ‘Calendar’ button.
Year must be in 4 characters.
Accept Year only.
Accept Year and Month.
Accept Year and Day.
User must click ‘INSERT DATE’ button to insert to the scrapbook.

Steps:
Step 1: Click the ‘Calendar’ button (left side panel).
Step 2: Enter ‘Year’, select ‘Month’, and ‘Day’.
Step 3: Click ‘INSERT DATE’ button.

Specifications:
Pop up box shows when inserting date.
New Layout for calendar.

FIGS. 18C-1 and 18C-2 show an exemplary graphical user interface for a calendar feature of tools for scrapbooking, in accordance with the principles of the present invention.

Vault—User can access his/her vault albums.

Validation:
User must click ‘Vault’ button to appear on the right side panel.
User must select an album.
User must drag and drop the vault image to the scrapbook page.

Steps:
Step 1: Click the ‘Vault’ button (left side panel).
Step 2: Select an album from the drop down list.
Step 3: Drag and drop the vault image.

Specifications:
High quality vault images.
Vault Image selection background color (Vertical Stripe Gray).
Added SEARCH OPTIONS for easy searching.
   Note Search options—filename, words/tags, description.

FIG. 18D shows an exemplary graphical user interface for a vault feature of tools for scrapbooking, in accordance with the principles of the present invention.

Clip Art—added clip art depends on the category.

Validation:
User must click ‘Clip Art’ button to appear on the right side panel.
User must select a category.
User must drag and drop the clip art to the scrapbook page.

Steps:
Step 1: Click the ‘clip Art’ button (left side panel).
Step 2: Select category from the drop down list.
Step 3: Drag and drop the clip art.

Specifications:
High quality clip art.
Clip Art selection background color (Vertical Stripe Gray).
Added SEARCH OPTIONS for easy searching.
   Note: Search options—filename, words/tags, description.

FIG. 18E shows an exemplary graphical user interface for a clip art feature of tools for scrapbooking, in accordance with the principles of the present invention.

### ARRANGE PAGE

Description:
To preview all scrapbook pages and to rearrange the order of pages.

Validation:
User must click ‘ARRANGE PAGE’ button.
User must drag and drop the page on the desired position.
User must click ‘APPLY’ button on any changes to take effect.

Steps:
Step 1: Click ‘ARRANGE PAGE’ button (left side panel).
Step 2: Drag and drop the page.
Step 3: Click ‘APPLY’ button.

Specifications:
Added feature—ARRANGE PAGE.
Pop up box shows upon clicking the button.
Rearrange order of pages.

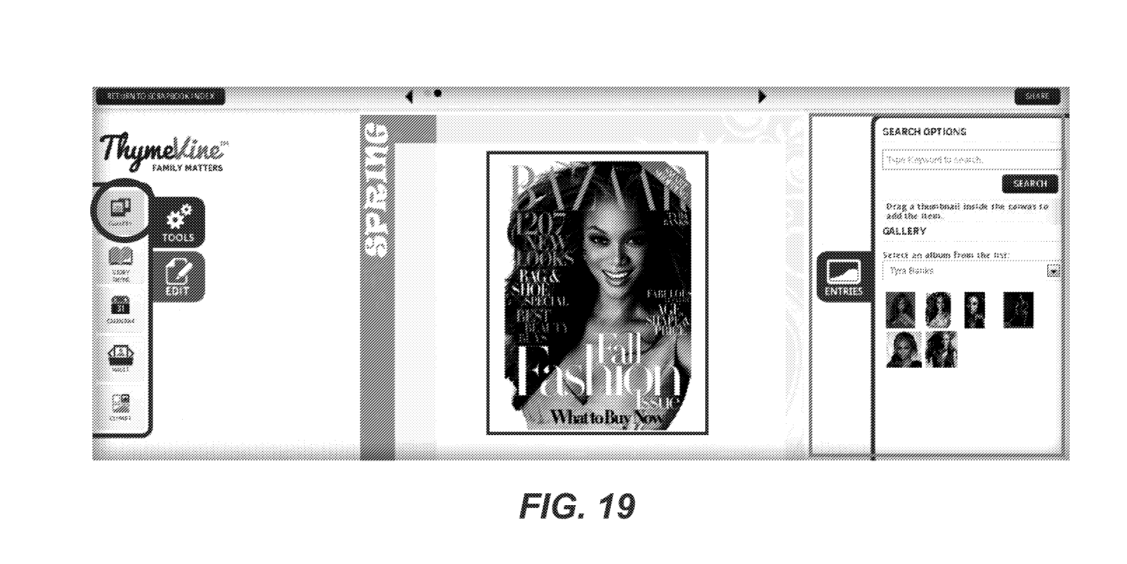

FIG. 19 shows an exemplary graphical user interface for arranging a page in scrapbooking, in accordance with the principles of the present invention.

### SCRAPBOOK AUTO SAVE

Description:
The scrapbook entry automatically is saving every lmin to prevent data lost.

Validation:
User must wait the auto save before leaving the page to prevent data lost.

Steps:
Step 1: Wait for the auto save.

Specifications:
Auto save will appear every after 1 minute.

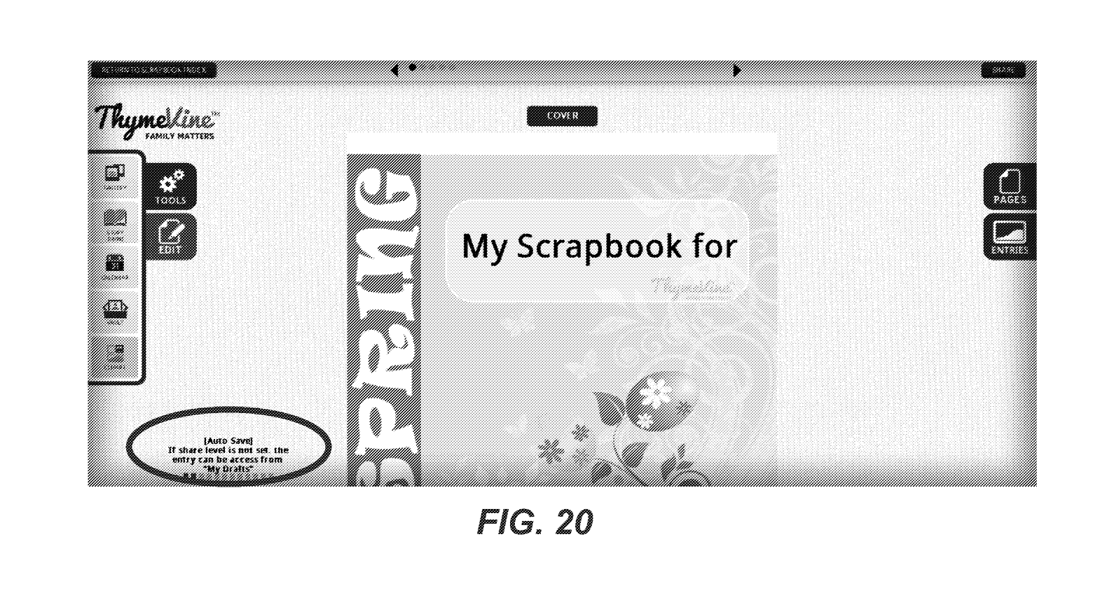

FIG. 20 shows an exemplary graphical user interface for auto saving a scrapbook, in accordance with the principles of the present invention.

### SHARE LEVEL SETTINGS

Description:
Share BY LEVELS or BY GROUPS used to set the privacy and sensitivity of your content.

Validation:
User must click ‘SHARE’ button.
Family members with an equal and closer Share Level status are able to view the scrapbook entry.
Private posts will only be visible to you.

Steps:
Step 1: Click ‘SHARE’ button (upper right corner).
Step 2: Slide the gray box to adjust your post's Share Level.
   Note: User can tick the Extended Share Levels box to show more share level options.
   Note: User can view the listed members depends on the Share Level by clicking ‘WHO CAN SEE THIS POST’ button.
   Note: User can also notify the people via Email.
Step 3: Click ‘SHARE’ button.
Step 4: Enter Event Date, and Description. (not required field)

Specifications:
Pop up box show share level settings.

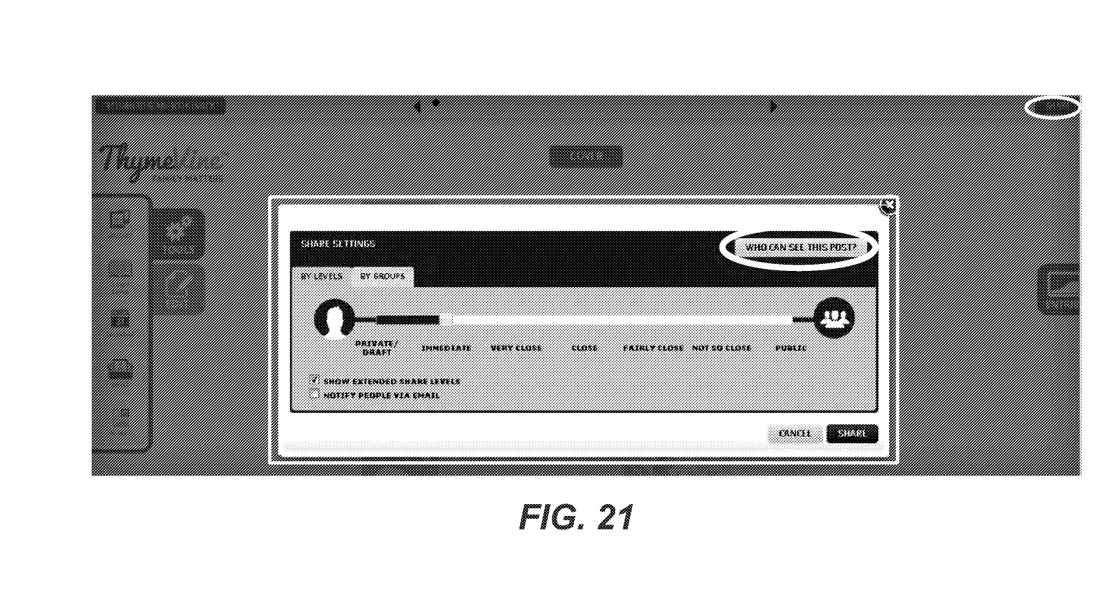

FIG. 21 shows an exemplary graphical user interface for share level settings of a scrapbook, in accordance with the principles of the present invention.

### VIEW FULL POST

Description:
User can view full posted entry.

Validation:
If the scrapbook entry is posted by others, user cannot download/print the scrapbook.

Steps:
Step 1: Click the title of the scrapbook.

Specifications:
Additional button ‘DOWNLOAD/PRINT’.
Added quick menu button: Add a New Entry, Update Entry, Delete Entry, Return to Family Entries.

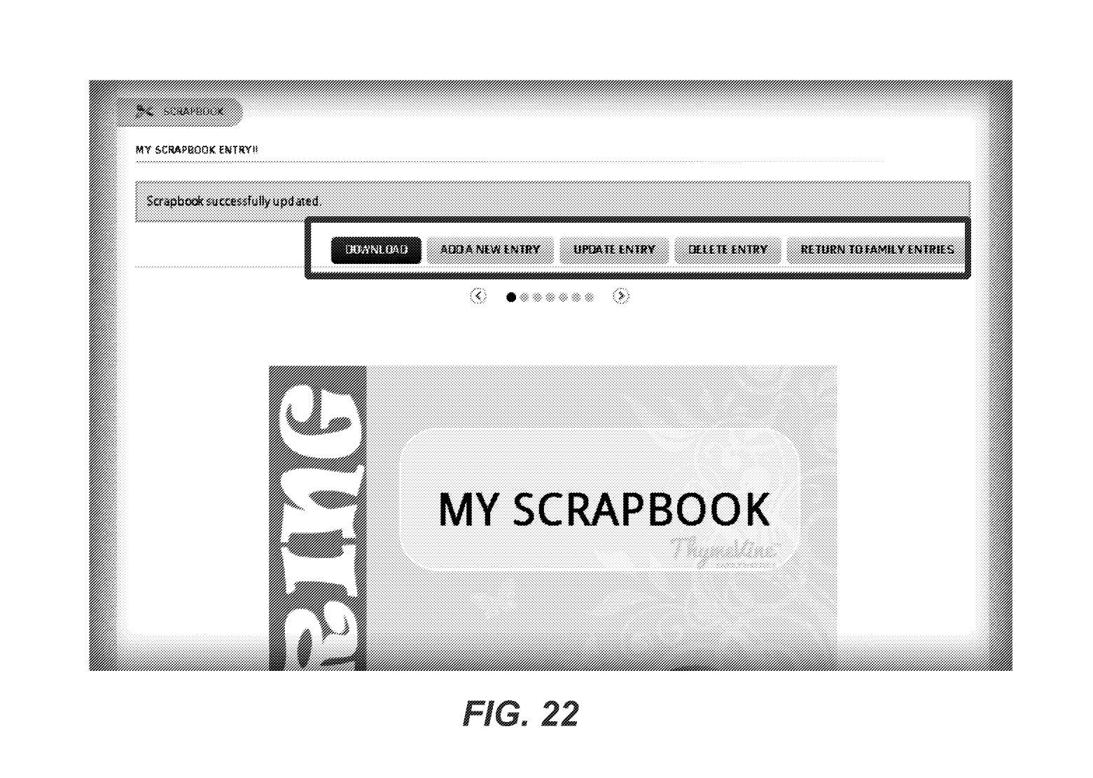

FIG. 22 shows an exemplary graphical user interface for viewing full post in scrapbooking, in accordance with the principles of the present invention.

The Table below shows the definition and functionality of each feature.

| | |
|---|---|
| Scrapbook | |
| Features | Actions |

ADD NEW ENTRY

| | |
|---|---|
| Scrapbook | Required to Input Title |
| Title pop-up | |
| Cancel button | User will be redirected to scrapbook index page |
| Next button | User will proceed to Theme selection after the title has |
| | been entered. |

THEME SELECTION

| | |
|---|---|
| Default Theme | No Background (default is White or blank theme) |
| | Optional: select a Background Color, Theme, Border |
| | *When selecting Themes or Border user can be able to |
| | preview the designs by clicking “view” link under each |
| | selection. |
| Next button | The system will generate a cover page for the scrapbook |
| | and load the selected theme from the theme selection. |
| Scrapbook | The scrapbook is saving automatically after every 1 min. |
| Auto Save | based on the current scrapbook setup and configuration. |
| | Note: if share level is not set, the entry can be accessed |
| | on “My Drafts” lists of Scrapbook index page. |

TOOLS

| | |
|---|---|
| Gallery (left | Dropdown list gallery Album with their album titles |
| side panel) | If user selects gallery album (from Entries), the album's |
| | images will appear below the dropdown list |
| | Drag a thumbnail inside the canvas to add the image. |
| Search Option | The keyword being search will be searched on the current |
| | Tool selected for the entries' container. Keyword is also |
| | equivalent to the file name of the image. |
| | (e.g image name: “elise.jpg”, use “elise” as the keyword. |
| Story Thyme | Entries Container will slide out. |
| Icon (left | *Dropdown list will be populated with the list of created |
| side panel) | Story Thyme topics. |
| | Upon User's selection on the dropdown, the entries under |
| | that topic will appear below the dropdown list. |
| Search Option | The keyword being search will be searched on the current |
| | Tool selected for the entry's container. Keyword search |
| | is equivalent to the Title of the created Story Thyme |
| | entry, either from Custom/Free Write or other topic |
| | selected and used by the user. |
| Calendar icon | A pop-up will appear |
| (left side panel) | *Pop-up contains a text input for the year, and dropdown |
| | list for Month and Day |
| | Note: |
| | //Each input are independent, user can input a calender |
| | item without Month and Day. |
| | //It validates the user if calendar is empty. |
| | //Search Option is not applicable on this Tool. |
| Vault icon | Its functionality is similar with the “Gallery” |
| (left side panel) | |
| Clipart | Entries Container will slide out |
| | Dropdown list will be populated with Clipart Categories |
| Search Option | The keyword being will searched on the current module |
| | selected for the entries container. |

TOOLBAR

| | |
|---|---|
| Edit | Text box editor will pop up to modify the Scrapbook title |
| (Scrapbook | |
| information) | |
| Re-Title | This is where user input/edit the Title of the Scrapbook |
| | entry. |
| Apply button | Changes will be saved. |
| Cancel button | Changes will not be applied. |
| Add Page | A new page will be generated for the scrapbook. |
| | Note: |
| | Upon creating a new entry, COVER page is the default |
| | page that will be displayed. |
| Insert/Add | Text editor will be displayed. Add text, once done, |
| Note ((sticky | yellow post it notes will be added on the canvas. |
| paper) image | Note: //Note content is limited it can only contain 300 |
| | characters |
| | Note: //Note character limit may not be accurate if the |
| | content is customized. |
| | Note: //Resize feature on note is not applicable. |
| Done Button | Added note to scrapbook |
| Close Button | Close the pop up |
| Add Text | Text editor will be displayed. Add Plain text on the |
| | canvas. |
| Change Theme | A pop-up will appear showing the available colors, |
| | themes and borders for scrapbook and pages. And user |
| | can change themes, or borders. |
| | Note: |
| | //User can only select one color for the page or |
| | scrapbook. |
| | Note: |
| | //User can only select one Theme or border for the |
| | scrapbook or scrapbook page. |
| Apply to | After user has changed the theme, this button allows the |
| Scrapbook | selection will be applied on the entire scrapbook pages. |
| button | |
| Apply to | The selections will be applied to the current page loaded. |
| Current Page | |
| button | |
| Close | Close the pop up. |
| Delete Page | A pop-up will appear to confirm the page deletion. And |
| | the current page will be deleted. |
| | It will not delete the entire entry. |
| Undo | Reload the previous activity or modification from the |
| | item inside the current page of scrapbook |
| | Note: |
| | Every time the page change, the undo ques is being |
| | cleared for System optimization. |
| | Note: |
| | //Undo does not support these following activities: |
| | Change Scrapbook theme |
| | Change Page theme |
| | Change Scrapbook background color |
| | Change Page background color |
| | Page deletion |
| | Item Drop |
| | Clone images |
| Redo | Load the que'd item from the point the undo is clicked |
| | Note: |
| | //Every time the page change, the redo ques is being |
| | cleared for system optimization. |
| | Note: |
| | //Redo does not support these following activities: |
| | Change Scrapbook theme |
| | Change Page theme |
| | Change Scrapbook background color |
| | Change Page background color |
| | Page deletion |
| Node Pages | A circular icon which can be seen at the top part of the |
| | page, inside the navigation between next and previous |
| | icon. |
| | When User's pointer hovered on the page node, a tool tip |
| | will appear indicating the page of the node. |
| Next | Load the next page based on the current selection. |
| Previous | Load the previous page based on the current selection. |

OPTIONS MENU - these options will show up by double clicking
the Image, Note, Text, and Clipart added on a specific page.
Options can be found at the bottom part of an entry page.

| | |
|---|---|
| EDIT | Text editor will pop-up only if the selected item is from |
| | “Added Text” or ‘Added Note” |
| CLONE | Creates a copy/duplicate a selected Photos, Clipart, Text, |
| | Note, etc. |
| ROTATE | Rotates a selected item from the canvas, turns it around a |
| | fixed point that you designate by using the slider. |
| FRONT/BACK | Set an item either to front or to the back of the Tools, |
| | Text, and Note inserted, |
| TRASH | The item will be deleted from the canvas. |
| APPLY | Save changes to a selected item. |
| CANCEL | No changes will be applied. |

While the invention has been described with reference to the exemplary embodiments thereof, those skilled in the art will be able to make various modifications to the described embodiments of the invention without departing from the true spirit and scope of the invention.

What is claimed is:

1. A method of implementing a share level network, comprising:
accepting a closeness rating assigned via said posting device for each of a plurality of social network user devices to which said posting device has a respective pre-defined relationship;
accepting a post from said posting device;
accepting an assigned share level with said post; and
sharing said post from said posting device with only those of said plurality of social network user devices that have a closeness rating at or above said assigned share level.

2. The method of implementing a share level network according to claim 1, wherein:
said share level is any one of six possible discrete share levels.

3. The method of implementing a share level network according to claim 2, wherein said six possible discrete share levels comprise:
immediate representing an immediate relationship between said posting device and a respective social network user device;
very close representing a very close relationship between said posting device and a respective social network user device;
close representing a close relationship between said posting device and a respective social network user device;
fairly close representing a fairly close relationship between said posting device and a respective social network user device;
not so close representing a not-so-close relationship between said posting device and a respective social network user device; and
public.

4. The method of implementing a share level network according to claim 1, wherein:
said share level is any one of at least six possible discrete share levels.

5. The method of implementing a share level network according to claim 1, wherein said share level comprises:
an integer.

6. The method of implementing a share level network according to claim 1, wherein:
there are a virtually infinite number of share levels between immediate and public which may be defined by said posting device for any given post.

7. The method of implementing a share level network according to claim 6, wherein said share level comprises:
a fractional real number.

8. The method of implementing a share level network according to claim 1, wherein said post comprises:
a photo.

9. The method of implementing a share level network according to claim 1, wherein said post comprises:
a video.

10. The method of implementing a share level network according to claim 1, wherein said post comprises:
a document.

11. The method of implementing a share level network according to claim 1, wherein:
said closeness rating of any of said plurality of social network user devices can be changed at any time by said user device.

12. The method of implementing a share level network according to claim 1, wherein:
said share level of said post is not disclosed to any of said plurality of social network user devices.

13. The method of implementing a share level network according to claim 1, wherein:
said closeness rating assigned by said user device to said plurality of social network user devices is not disclosed to said plurality of social network devices.

14. A share level network, comprising:
means for accepting a closeness rating assigned via said posting device for each of a plurality of social network user devices to which said posting device has a respective pre-defined relationship;
means for accepting a post from said posting device;
means for accepting an assigned share level with said post; and
means for sharing said post from said posting device with only those of said plurality of social network user devices that have a closeness rating at or above said assigned share level.

15. The share level network according to claim 14, wherein:
said share level is any one of six possible discrete share levels.

16. The share level network according to claim 15, wherein said six possible discrete share levels comprise:
immediate representing an immediate relationship between said posting device and a respective social network user device;
very close representing a very close relationship between said posting device and a respective social network user device;
close representing a close relationship between said posting device and a respective social network user device;
fairly close representing a fairly close relationship between said posting device and a respective social network user device;
not so close representing a not-so-close relationship between said posting device and a respective social network user device; and
public.

17. The share level network according to claim 14, wherein:
said share level is any one of at least six possible discrete share levels.

18. The share level network according to claim 14, wherein said share level comprises:
an integer.

19. The share level network according to claim 14, wherein:
there are a virtually infinite number of share levels between immediate and public which may be defined by said posting device for any given post.

20. The share level network according to claim 19, wherein said share level comprises:
a fractional real number.

21. The share level network according to claim 14, wherein said post comprises:
a photo.

22. The share level network according to claim 14, wherein said post comprises:
a video.

23. The share level network according to claim 14, wherein said post comprises:
a document.

24. The method of implementing a share level network according to claim 14, wherein:
said closeness rating of any of said plurality of social network user devices can be changed at any time by said user device.

25. The method of implementing a share level network according to claim 14, wherein:
said share level of said post is not disclosed to any of said plurality of social network user devices.

26. The method of implementing a share level network according to claim 14, wherein:
said closeness rating assigned by said user device to said plurality of social network user devices is not disclosed to said plurality of social network devices.
